(19) United States
(12) Patent Application Publication
(10) Pub. No.: US 2015/0268476 A1
(43) Pub. Date: Sep. 24, 2015

(54) IMAGE DISPLAY DEVICE AND IMAGE DISPLAY METHOD

(71) Applicant: KABUSHIKI KAISHA TOSHIBA, Tokyo (JP)

(72) Inventors: Ryosuke Nonaka, Yokohama (JP); Masahiro Baba, Yokohama (JP)

(21) Appl. No.: 14/642,925

(22) Filed: Mar. 10, 2015

(30) Foreign Application Priority Data
Mar. 18, 2014 (JP) 2014-055598
Aug. 29, 2014 (JP) 2014-176562

(51) Int. Cl. G02B 27/01; G06T 7/60; G06T 7/00; G06T 3/40

(52) U.S. Cl. CPC G02B 27/0179; G06T 3/40; G06T 7/60; G06T 7/003; G02B 27/0172; G02B 2027/0178; G02B 2027/0185; G06T 2207/20228

(57) ABSTRACT

According to one embodiment, an image display device includes an image converter, a display unit including pixels provided on a first surface, and a first lens unit including lenses. The image converter acquires a first image, and drives second image from the first image. The pixels emit light corresponding to the second image. The emitted light is incident on the lenses. The first surface includes a first display region and a second display region. The pixels include first pixels and second pixels. The first pixels are provided inside the first display region and emit light corresponding to a first portion of the first image. The second pixels are provided inside the second display region and emit light corresponding to the first portion. A position of the first pixels inside the first display region is different from a position of the second pixels inside the second display region.

### CROSS-REFERENCE TO RELATED APPLICATIONS

This application is based upon and claims the benefit of priority from Japanese Patent Application No. 2014-055598, filed on Mar. 18, 2014; and Japanese Patent Application No. 2014-176562, filed on Aug. 29, 2014; the entire contents of which are incorporated herein by reference.

### FIELD

Embodiments described herein relate generally to an image display device and an image display method.

### BACKGROUND

For example, there is an image display device that includes a lens array and a display panel. For example, an image display device has been proposed in which display regions of the display panel are respectively associated with the lenses of the lens array. In such an image display device, there are cases where the positions of the images viewed through the lenses are viewed as being deviated. A high-quality display is desirable in which the deviation of the positions of the images viewed through the lenses is small.

### BRIEF DESCRIPTION OF THE DRAWINGS

FIG. 1 is a schematic view illustrating an image display device according to a first embodiment;

FIG. 2A and FIG. 2B are schematic views illustrating the operation of the image display device according to the first embodiment;

FIG. 3 is a schematic view illustrating the operation of the image display device according to the first embodiment;

FIG. 4A to FIG. 4C are schematic views illustrating the image display device according to the first embodiment;

FIG. 5 is a schematic view illustrating the image display device according to the first embodiment;

FIG. 6 is a schematic view illustrating the image display device according to the first embodiment;

FIG. 7A and FIG. 7B are schematic views illustrating the image display device according to the first embodiment;

FIG. 8A and FIG. 8B are schematic views illustrating the image display device according to the first embodiment;

FIG. 9 is a schematic view illustrating the image display device according to the first embodiment;

FIG. 10 is a schematic view illustrating the image display device according to the first embodiment;

FIG. 11 is a schematic view illustrating the image display device according to the first embodiment;

FIG. 12A and FIG. 12B are schematic views illustrating the operation of the image display device according to the first embodiment;

FIG. 13A and FIG. 13B are schematic views illustrating the operation of the image display device according to the first embodiment;

FIG. 14 is a schematic view illustrating the image display device according to the second embodiment;

FIG. 15 is a schematic view illustrating the image display device according to the second embodiment;

FIG. 16 is a schematic view illustrating the image display device according to the second embodiment;

FIG. 17 is a schematic view illustrating the image display device according to the third embodiment;

FIG. 18A and FIG. 18B are schematic cross-sectional views illustrating the image display device according to the third embodiment;

FIG. 19 is a schematic view illustrating the image display device according to the fourth embodiment;

FIG. 20A and FIG. 20B are schematic cross-sectional views illustrating the image display device according to the fourth embodiment;

FIG. 21 is a schematic view illustrating the image display device according to the fourth embodiment;

FIG. 22A and FIG. 22B are schematic views illustrating the image display device according to the fourth embodiment;

FIG. 23 is a schematic view illustrating an image display device according to a fifth embodiment;

FIG. 24A and FIG. 24B are schematic cross-sectional views illustrating the image display device according to the fifth embodiment;

FIG. 25 is a schematic view illustrating an image display device according to a sixth embodiment;

FIG. 26 is a schematic view illustrating an image display device according to a seventh embodiment;

FIG. 27 is a schematic cross-sectional view illustrating an image display device according to an eighth embodiment;

FIG. 28 is a schematic plan view illustrating a portion of the display unit according to the embodiment;

FIG. 29A and FIG. 29B are schematic views illustrating the operation of the image display device;

FIG. 30 is a schematic view illustrating the image display device according to the embodiment;

FIG. 31 is a schematic view illustrating the image display device according to the embodiment;

FIG. 32 is a schematic view illustrating an image display device according to a ninth embodiment;

FIG. 33A to FIG. 33C are schematic views illustrating portions of other image display devices according to the ninth embodiment;

FIG. 34 is a schematic view illustrating portions of other image display devices according to the ninth embodiment.

FIG. 35 is a schematic view illustrating the image display device according to the ninth embodiment.

FIG. 36 is a perspective plan view illustrating the portion of the image display device according to the ninth embodiment.

FIG. 37 is a schematic view illustrating the image display device according to the ninth embodiment;

FIG. 38 is a schematic view illustrating the image display device according to the ninth embodiment;

FIG. 39 is a schematic view illustrating the operation of the image display device according to the ninth embodiment; and

FIG. 40A and FIG. 40B are schematic views illustrating the operation of the image display device according to the embodiment.

### DETAILED DESCRIPTION

According to one embodiment, an image display device includes an image converter, a display unit, and a first lens unit. The image converter acquires first information and derives second information by converting the first information. The first information relates to a first image. The second information relates to a second image. The display unit includes a first surface. The first surface includes a plurality of pixels. The pixels emit light corresponding to the second image based on the second information. The first lens unit includes a plurality of lenses provided on a second surface. At least a portion of the light emitted from the pixels is incident on each of the lenses. The first surface includes a first display region, and a second display region different from the first display region. The pixels include a plurality of first pixels and a plurality of second pixels. The first pixels are provided inside the first display region and emit light corresponding to a first portion of the first image. The second pixels are provided inside the second display region and emit light corresponding to the first portion. A position of the first pixels inside the first display region is different from a position of the second pixels inside the second display region.

According to one embodiment, an image display method is disclosed. The method includes acquiring first information relating to a first image. The method includes deriving second information relating to a second image by converting the first information. The method includes emitting light corresponding to the second image based on the second information from a plurality of pixels provided on a first surface. The method includes displaying the second image via a plurality of lenses provided on a second surface. At least a portion of the light emitted from the pixels is incident on the lenses. The first surface includes a first display region, and a second display region different from the first display region. The pixels include a plurality of first pixels and a plurality of second pixels. The first pixels are provided inside the first display region and emit light corresponding to a first portion of the first image. The second pixels are provided inside the second display region and emit light corresponding to the first portion. A position of the first pixels inside the first display region is different from a position of the second pixels inside the second display region.

Various embodiments will be described hereinafter with reference to the accompanying drawings.

The drawings are schematic or conceptual; and the relationships between the thicknesses and widths of portions, the proportions of sizes between portions, etc., are not necessarily the same as the actual values thereof. Further, the dimensions and/or the proportions may be illustrated differently between the drawings, even in the case where the same portion is illustrated.

In the drawings and the specification of the application, components similar to those described in regard to a drawing thereinabove are marked with like reference numerals, and a detailed description is omitted as appropriate.

### First Embodiment

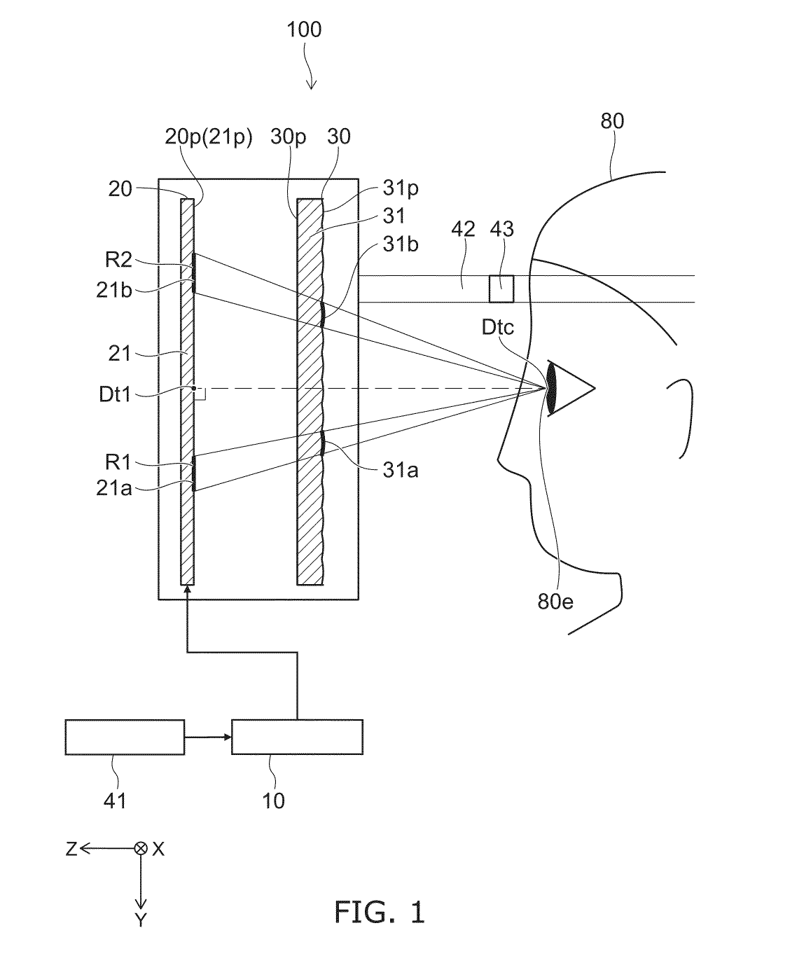

FIG. 1 is a schematic view illustrating an image display device according to a first embodiment.

As shown in FIG. 1, the image display device 100 according to the embodiment includes an image converter 10, a display unit 20, and a lens unit 30 (a first lens unit 30). In the example, the image display device 100 further includes an image input unit 41, a holder 42, and an imaging unit 43.

Information of an input image I1 (a first image) is input to the image input unit 41. The image converter 10 acquires first information relating to the input image I1 from the image input unit 41. The image converter 10 derives second information relating to a display image I2 (a second image) by converting the first information relating to the input image I1. The display unit 20 displays the display image I2 calculated by the image converter 10.

For example, the lens unit 30 is disposed between the display unit 20 and a viewer 80 of the image display device 100.

The display unit 20 includes multiple pixels 21. The multiple pixels 21 are provided on a first surface 20p. For example, the multiple pixels 21 are arranged on the first surface 20p. The multiple pixels 21 emit light corresponding to the display image I2 based on the second information. The first surface 20p is, for example, a plane. The first surface 20p is, for example, a surface (a display surface 21p) where the image of the display unit 20 is displayed.

The lens unit 30 includes multiple lenses 31. The multiple lenses 31 are provided on a second surface 30p. For example, the multiple lenses 31 are arranged on the second surface 30p. At least a portion of the light emitted from the multiple pixels 21 included in the display unit 20 is incident on the multiple lenses 31. The second surface 30p is, for example, a plane.

The image display device 100 is, for example, a head mounted image display device. For example, the holder 42 holds the display unit 20, the lens unit 30, the imaging unit 43, the image converter 10, and the image input unit 41. For example, the holder 42 regulates the spatial arrangement between the display unit 20 and the eye of the viewer 80, the spatial arrangement between the lens unit 30 and the eye of the viewer 80, the spatial arrangement between the display unit 20 and the lens unit 30, and the spatial arrangement between the imaging unit 43 and the eye of the viewer 80. The configuration of the holder 42 is, for example, a configuration such as the frame of eyeglasses. The imaging unit 43 is described below.

For example, the viewer 80 can view the display image I2 displayed by the display unit 20 through the lens unit 30. Thereby, for example, the viewer 80 can view a virtual image of the display image I2 formed by the optical effect of the lens unit 30. For example, the virtual image is formed to be more distal than the display unit 20 as viewed by the viewer. In the case of the head mounted display device, the actual display unit can be smaller because the image is displayed as a virtual image.

For example, the distance between the lens and the display unit is set according to the focal length of the lens and the size of the display unit. In the case where an image having a wide angle of view is displayed, there are cases where the display device is undesirably large. In the embodiment, by using multiple lenses as in the lens unit 30, the distance between the display unit and the lens unit can be shorter; and the display device can be smaller.

A direction from the lens unit 30 toward the display unit 20 is taken as a Z-axis direction. One direction perpendicular to the Z-axis direction is taken as an X-axis direction. One direction perpendicular to the Z-axis direction and perpendicular to the X-axis direction is taken as a Y-axis direction.

For example, the first surface 20p is a plane parallel to the X-Y plane. For example, the second surface 30p is a plane parallel to the X-Y plane.

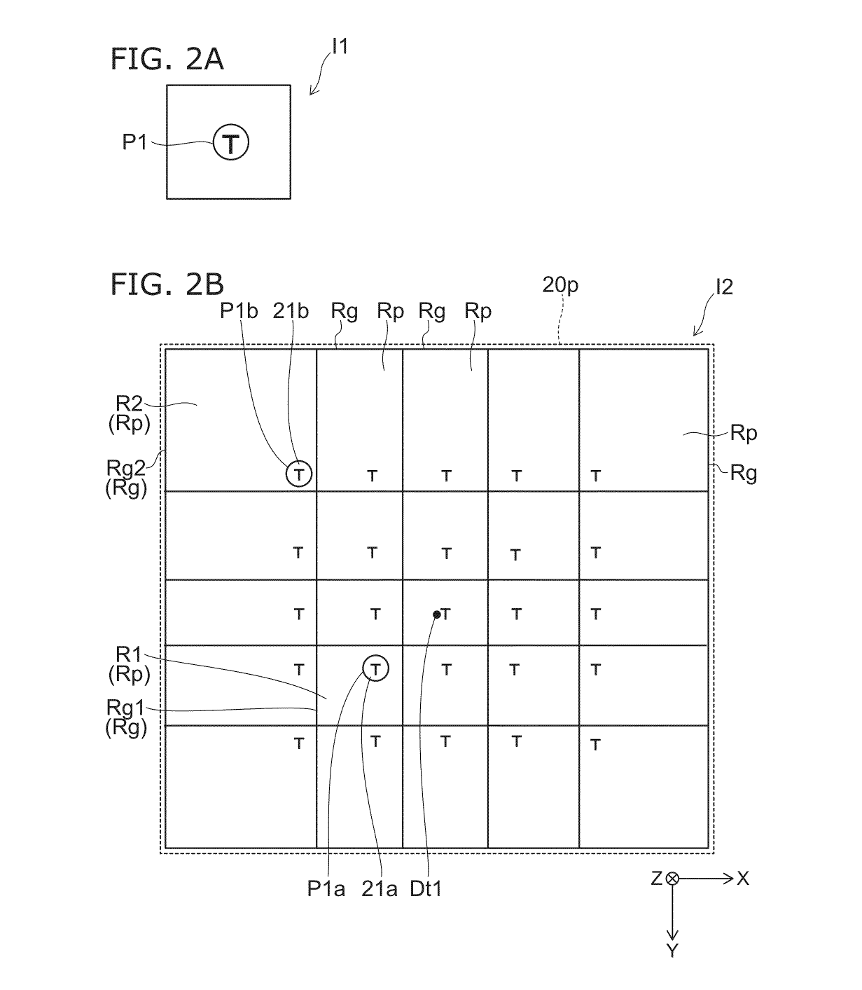

FIG. 2A and FIG. 2B are schematic views illustrating the operation of the image display device according to the first embodiment.

FIG. 2A shows the input image I1 acquired by the image converter 10.

FIG. 2B shows the state wherein the display image I2 is displayed by the display unit 20.

In the example as shown in FIG. 2A, the character “T” is included in the input image I1.

As shown in FIG. 2B, the display image I2 includes images (regional images Rg) which are the display image I2 subdivided into multiple regions.

The multiple regional images Rg include a first regional image Rg1 and a second regional image Rg2. Each of the multiple regional images Rg includes at least a portion of the graphical pattern of the input image I1. For example, an image that corresponds to a first portion P1 of the input image is included in each of the multiple regional images Rg.

The multiple pixels that are provided in the display unit 20 emit light corresponding to such a display image I2. In other words, the display unit 20 displays such a display image I2.

In the example, the first portion P1 is the portion of the input image that includes the character “T”.

The first regional image Rg1 includes an image P1a corresponding to the first portion P1 of the first image I1. In other words, in the example, the first regional image Rg1 includes an image including the character “T”.

The second regional image Rg2 includes an image P1b corresponding to the first portion P1 of the first image I1. In other words, in the example, the second regional image Rg2 includes an image including the character “T”.

In the display unit 20, the first surface 20p where the image is displayed includes multiple display regions Rp. In other words, for example, the first surface 20p includes a first display region R1 and a second display region R2. The second display region R2 is different from the first display region R1. One of the multiple regional images Rg is displayed in each of the multiple regions Rp. As described below, one display region Rp corresponds to one lens 31.

The first regional image Rg1 is displayed in the first display region R1. In other words, the multiple pixels that are disposed in the first display region R1 emit light corresponding to the first regional image Rg1.

For example, multiple first pixels 21a are provided inside the first display region R1. The multiple first pixels 21a emit light corresponding to the first portion P1.

The second regional image Rg2 is displayed in the second display region R2. In other words, the multiple pixels that are disposed in the second display region R2 emit light corresponding to the second regional image Rg2.

For example, multiple second pixels 21b are provided inside the second display region R2. The multiple second pixels 21b emit light corresponding to the first portion P1.

For example, the lens unit 30 includes a first lens 31a and a second lens 31b. For example, the viewer 80 views a virtual image of the first regional image Rg1 displayed in the first display region R1 through the first lens 31a. For example, the viewer 80 views a virtual image of the second regional image Rg2 displayed in the second display region R2 through the second lens 31b (referring to FIG. 1).

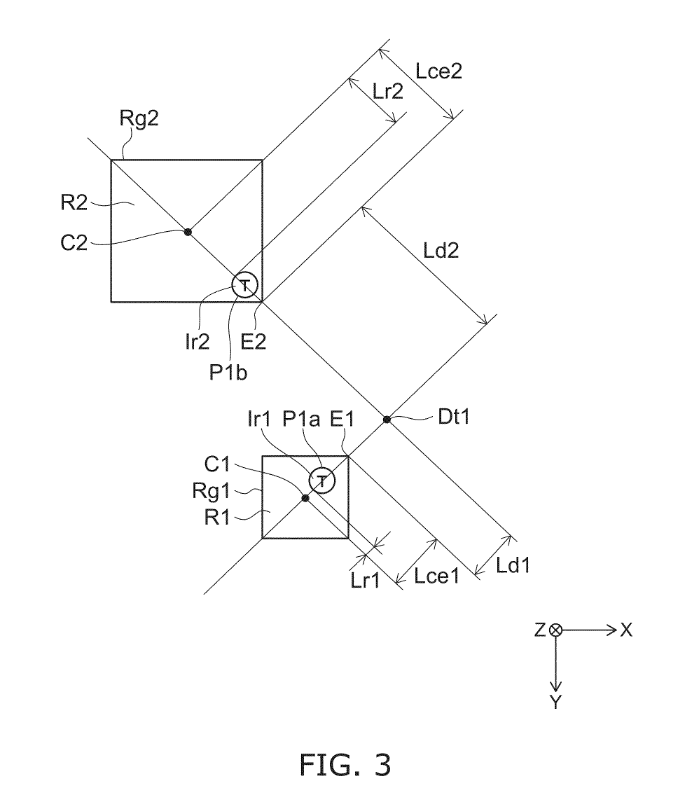

FIG. 3 is a schematic view illustrating the operation of the image display device according to the first embodiment.

FIG. 3 shows the state in which the display image I2 is displayed by the display unit 20. Only a portion of the display unit 20 and a portion of the display image I2 are displayed in FIG. 3 for easier viewing.

For example, the distance between the first display region R1 and a first point Dt1 on the first surface 20p is a first distance Ld1. The distance between the second display region R2 and the first point Dt1 is a second distance Ld2. The first distance Ld1 is shorter than the second distance Ld2. The surface area of the second display region R2 may be different from the surface area of the first display region R1. The first point Dt1 is, for example, a point at the center of the display unit 20.

For example, the light that is emitted from a portion (e.g., the first pixels 21a) of the multiple pixels 21 provided in the first display region R1 passes through the first lens 31a.

For example, the light that is emitted from a portion (e.g., the seconds pixel 21b) of the multiple pixels 21 provided in the second display region R2 passes through the second lens 31b.

For example, the first point Dt1 corresponds to the intersection between the first surface 20p and the line passing through an eyeball position 80e (an intersection Dtc) to be perpendicular to the first surface 20p. The eyeball position 80e is, for example, the eyeball rotation center of the eyeball of the viewer 80. The eyeball rotation center is, for example, the point around which the eyeball rotates when the viewer 80 modifies the line of sight. For example, the eyeball position 80e may be the position of the pupil of the viewer 80.

The position of the image P1a corresponding to the first portion P1 of the first regional image Rg1 is different from the position of the image P1b corresponding to the first portion P1 of the second regional image Rg2.

The position of the image P1b in the second regional image Rg2 is shifted further toward the first point Dt1 side than the position of the image P1a in the first regional image Rg1.

For example, the first display region R1 includes a first center C1, a first end portion E1, and a first image region Ir1. The first center C1 is the center of the first display region R1. The first end portion E1 is positioned between the first center C1 and the first point Dt1 and is an end portion of the first display region R1. The first image region Ir1 is the portion of the first display region R1 where the image P1a is displayed.

For example, the second display region R2 includes a second center C2, a second end portion E2, and a second image region Ir1. The second center C2 is the center of the second display region R2. The second end portion E2 is positioned between the second center C2 and the first point Dt1 and is an end portion of the second display region R2. The second image region Ir1 is the portion of the second display region R2 where the image P1b is displayed.

The ratio of a distance Lr1 between the first center C1 and the first image region Ir1 to a distance Lce1 between the first center C1 and the first end portion E1 is lower than the ratio of a distance Lr2 between the second center C2 and the second image region Ir1 to a distance Lce2 between the second center C2 and the second end portion E2. In other words, Lr1/Lce1<Lr2/Lce2. In other words, in the example, the character “T” in the second display region R2 is shifted further toward the first point Dt1 side than the character “T” in the first display region R1.

In the embodiment, such a display image I2 is displayed by the display unit 20. The viewer 80 can view the virtual image by viewing the display image I2 through the lens unit 30.

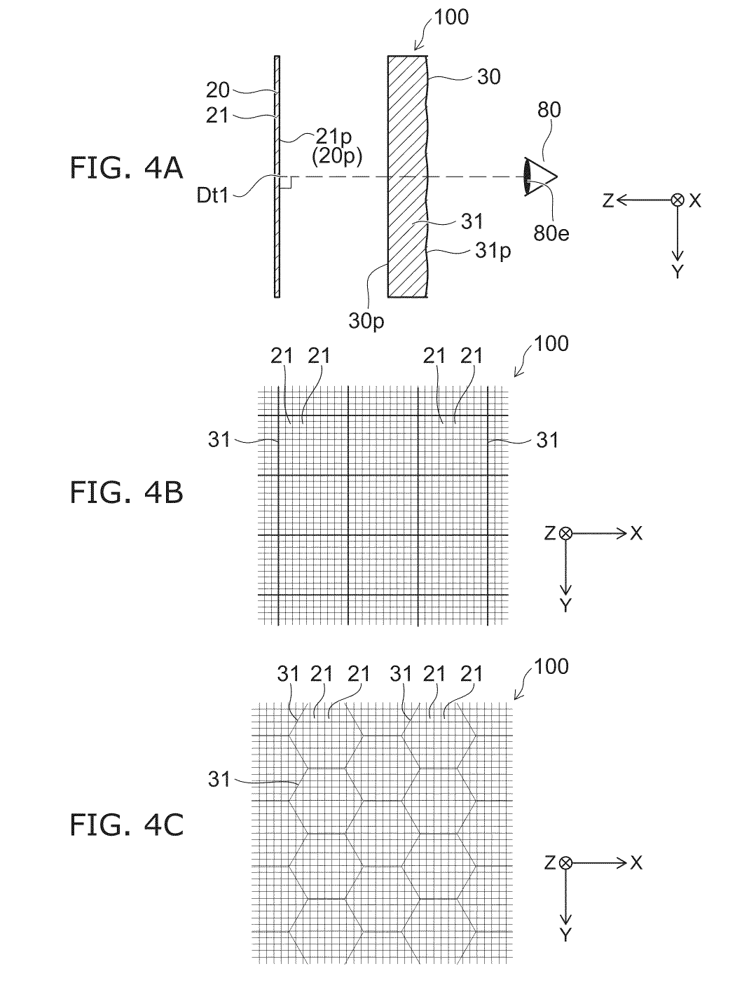

FIG. 4A to FIG. 4C are schematic views illustrating the image display device according to the first embodiment.

FIG. 4A to FIG. 4C show the display unit 20 and the lens unit 30.

FIG. 4B is a perspective plan view of a portion of the image display device 100.

As shown in FIG. 4B, for example, the multiple pixels 21 are disposed in a two-dimensional array configuration in the display unit 20 (the display panel). The display unit 20 includes, for example, a liquid crystal panel, an organic EL panel, an LED panel, etc. Each of the pixels of the display image I2 has a pixel value. Each of the pixels 21 disposed in the display unit 20 controls light emission or transmitted light to be stronger or weaker according to the magnitude of the pixel value corresponding to the pixel 21. Thus, the display unit 20 displays the display image I2 on the display surface 21p (the first surface 20p). For example, the display surface 21p opposes the lens unit 30 of the display unit 20. In other words, the display surface 21p is on the viewer 80 side.

For example, the multiple lenses 31 are disposed in a two-dimensional array configuration in the lens unit 30 (a lens array). The viewer 80 views the display unit 20 through the lens unit 30. The pixels 21 and the lenses 31 are disposed so that (a virtual image of) the multiple pixels 21 is viewed by the viewer 80 through the lenses 31.

For example, one lens 31 overlaps multiple pixels 21 when projected onto the X-Y plane. In the example shown in FIG. 4B, the lens 31 has four sides when projected onto the X-Y plane. The planar configuration of the lens 31 is, for example, a rectangle. In the embodiment, the planar configuration of the lens 31 is not limited to a rectangle. For example, as shown in FIG. 4C, the planar configuration of the lens 31 may have six sides. For example, the planar configuration of the lens 31 is a regular hexagon. In the embodiment, the planar configuration of the lens 31 is arbitrary.

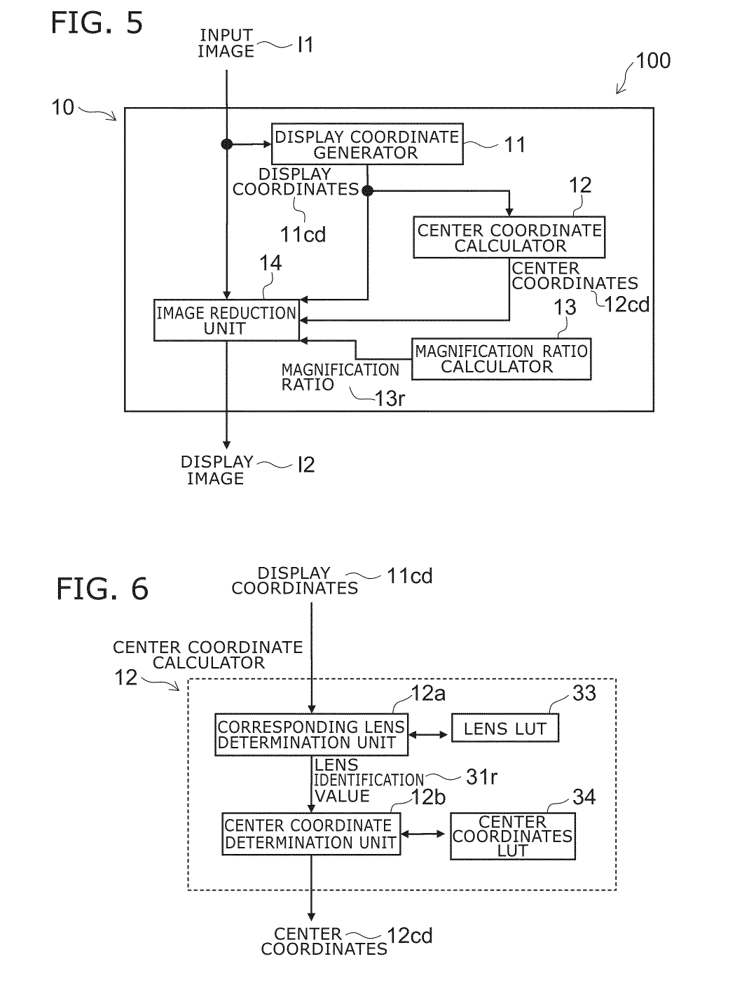

FIG. 5 is a schematic view illustrating the image display device according to the first embodiment.

As shown in FIG. 5, the image converter 10 converts the input image I1 input by the image input unit 41 into the display image I2 to be displayed by the display unit 20.

The image converter 10 includes, for example, a display coordinate generator 11, a center coordinate calculator 12, an magnification ratio calculator 13, and an image reduction unit 14.

The display coordinate generator 11 generates display coordinates 11cd for each of the multiple pixels 21 on the display unit 20. The display coordinates 11cd are the coordinates on the display unit 20 for each of the multiple pixels 21. The center coordinate calculator 12 calculates center coordinates 12cd of the lens 31 corresponding to each of the pixels 21 from the display coordinates 11cd of each of the pixels 21 generated by the display coordinate generator 11. The center coordinates 12cd are determined from the positional relationship between the nodal point of the lens 31 corresponding to each of the pixels 21, the eyeball position 80e (the point corresponding to the eyeball position of the viewer 80), and the display unit 20.

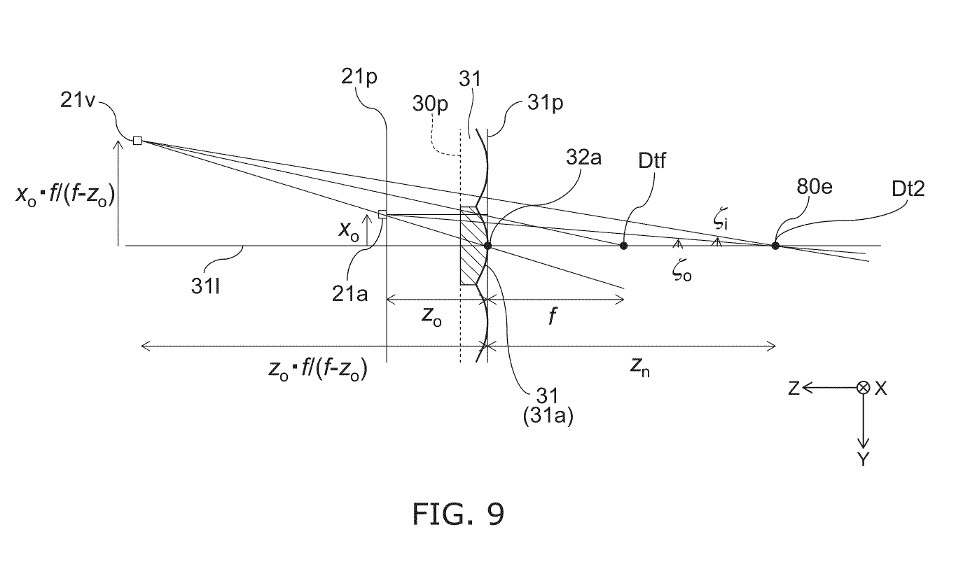

For example, the lens unit 30 has the second surface 30p and a third surface 31p (the principal plane, i.e., the rear principal plane, of the lens 31). For example, the second surface 30p opposes the display unit 20. The third surface 31p is separated from the second surface 30p in the Z-axis direction. The third surface 31p is disposed between the second surface 30p and the viewer 80. The third surface 31p (the principal plane) is the principal plane of the lens 31 on the viewer 80 side (referring to FIG. 9).

The magnification ratio calculator 13 calculates an magnification ratio 13r of the lens 31 corresponding to each of the pixels 21. The magnification ratio 13r is determined from the distance between the eyeball position 80e and the principal plane (the third surface 31p) of the lens 31, the distance between the display unit 20 and a principal point 32a of the lens 31 corresponding to each of the pixels 21, and a focal length f1 of the lens 31 corresponding to each of the pixels 21. The principal point 32a is the principal point (the front principal point) on the display unit 20 side of the lens 31 corresponding to each of the pixels 21. For example, the third surface 31p (the principal plane) passes through the principal point 32a and is substantially parallel to the second surface 30p (referring to FIG. 9).

For example, the image reduction unit 14 reduces the input image I1 using the display coordinates 11cd, the center coordinates 12cd, and the magnification ratio 13r of the lens corresponding to each of the pixels 21. Thereby, the display image I2 to be displayed by the display unit 20 is calculated. The display coordinates 11cd of each of the pixels 21 are generated by the display coordinate generator 11. The center coordinates 12cd that correspond to the lens 31 corresponding to each of the pixels 21 are calculated by the center coordinate calculator 12. The magnification ratio 13r of the lens 31 corresponding to each of the pixels 21 is calculated by the magnification ratio calculator 13. The image reduction unit 14 reduces the input image I1 by the proportion of the reciprocal of the magnification ratio 13r corresponding to each of the lenses 31 using the center coordinates 12cd corresponding to each of the lenses 31 as a center.

The display coordinate generator 11 generates the display coordinates 11cd, which are the coordinates on the display unit 20 of each of the pixels 21, for each of the pixels 21 on the display unit 20.

For example, the display coordinate generator 11 according to the embodiment generates the coordinates of each of the pixels 21 of the first surface 20p as the display coordinates 11cd of each of the pixels 21. For example, the position of the center when the display unit 20 is projected onto the X-Y plane is used as the origin.

For example, in the display unit 20, W pixels are arranged at uniform spacing in the horizontal direction (the X-axis direction); and H pixels are arranged at uniform spacing in the vertical direction (the Y-axis direction).

The coordinates of the pixels 21 of the uppermost row on the first surface 20p (on the display unit 20) are generated in order from the pixel of the leftmost column to be (x, y)=(−(W−1)/2+0, −(H−1)/2+0), (−(W−1)/2+1, −(H−1)/2+0), . . . , (−(W−1)/2+W−1, −(H−1)/2+0).

For example, the coordinates of the pixels 21 of the second row from the top on the first surface 20p are generated in order from the pixel 21 of the leftmost column to be (x, y)=(−(W−1)/2+0, −(H−1)/2+1), (−(W−1)/2+1, −(H−1)/2+1), . . . , ((W−1)/2+W−1, −(H−1)/2+1).

For example, the coordinates of the pixels of the lowermost row on the second surface 30p are, in order from the pixel of the leftmost column, (x, y)=(−(W−1)/2+0, −(H−1)/2+H−1), (−(W−1)/2+1, −(H−1)/2+H−1), . . . , (−(W−1)/2+W−1, −(H−1)/2+H−1).

The center coordinate calculator 12 calculates the center coordinates 12cd corresponding to the lens 31 corresponding to each of the pixels 21 from the display coordinates 11cd of each of the pixels 21. For example, the center coordinates 12cd are determined from the positional relationship between the nodal point of the lens 31 corresponding to each of the pixels 21, the eyeball position 80e, and the display unit 20.

The lens 31 that corresponds to each of the pixels 21 is, for example, the lens 31 intersected by the straight lines connecting the eyeball position 80e and each of the pixels 21.

The center coordinates 12cd that correspond to each of the lenses 31 are, for example, the coordinates on the display unit 20 of the intersection where the light ray from the eyeball position 80e toward the nodal point of the lens 31 intersects the display surface 21p of the display unit 20. In such a case, a nodal point 32b of the lens 31 is the nodal point 32b (the rear nodal point) of the lens 31 on the viewer 80 side.

FIG. 6 is a schematic view illustrating the image display device according to the first embodiment.

FIG. 6 shows the center coordinate calculator 12.

As shown in FIG. 6, the center coordinate calculator 12 includes a corresponding lens determination unit 12a and a center coordinate determination unit 12b.

The corresponding lens determination unit 12a determines the lens 31 corresponding to each of the pixels 21 from the display coordinates 11cd of each of the pixels 21 and calculates lens identification value 31r of the lens 31. Each of the lenses 31 on the lens array (on the second surface 30p) can be identified using the lens identification value 31r.

For example, in the lens array, N lenses in the horizontal direction and M lenses in the vertical direction are disposed in a lattice configuration.

In such a case, for example, the lens identification values 31r of the lenses 31 of the uppermost row on the lens array in order from the lens of the leftmost column are (j, i)=(−(N−1)/2+0, −(M−1)/2+0), (−(N−1)/2+1, −(M−1)/2+0) (−(N−1)/2+N−1, −(M−1)/2+0).

For example, the lens identification values 31r of the lenses 31 of the second row from the top on the lens array in order from the pixel of the leftmost column are (j, i)=(−(N−1)/2+0, −(M−1)/2+1), (−(N−1)/2+1, −(M−1)/2+1), . . . , (−(N−1)/2+N−1, −(M−1)/2+1).

For example, the lens identification values 31r of the lenses 31 of the lowermost row on the lens array in order from the lens of the leftmost column are (j, i)=(−(N−1)/2+0, −(M−1)/2+M−1), (−(N−1)/2+1, −(M−1)/2+M−1), . . . , (−(N−1)/2+N−1, −(M−1)/2+M−1).

For example, the corresponding lens determination unit 12a refers to a lens LUT (lookup table) 33. Thereby, the corresponding lens determination unit 12a calculates the lens identification value 31r of the lens 31 corresponding to each of the pixels 21. For example, the lens identification values 31r of the lenses 31 corresponding to the pixels 21 are pre-recorded in the lens LUT 33 (the lens lookup table).

The lens identification value 31r of the lens 31 corresponding to each of the pixels 21 is recorded in the lens LUT 33. For example, the lens 31 corresponding to each of the pixels 21 is determined based on the display coordinates 11cd of each of the pixels 21.

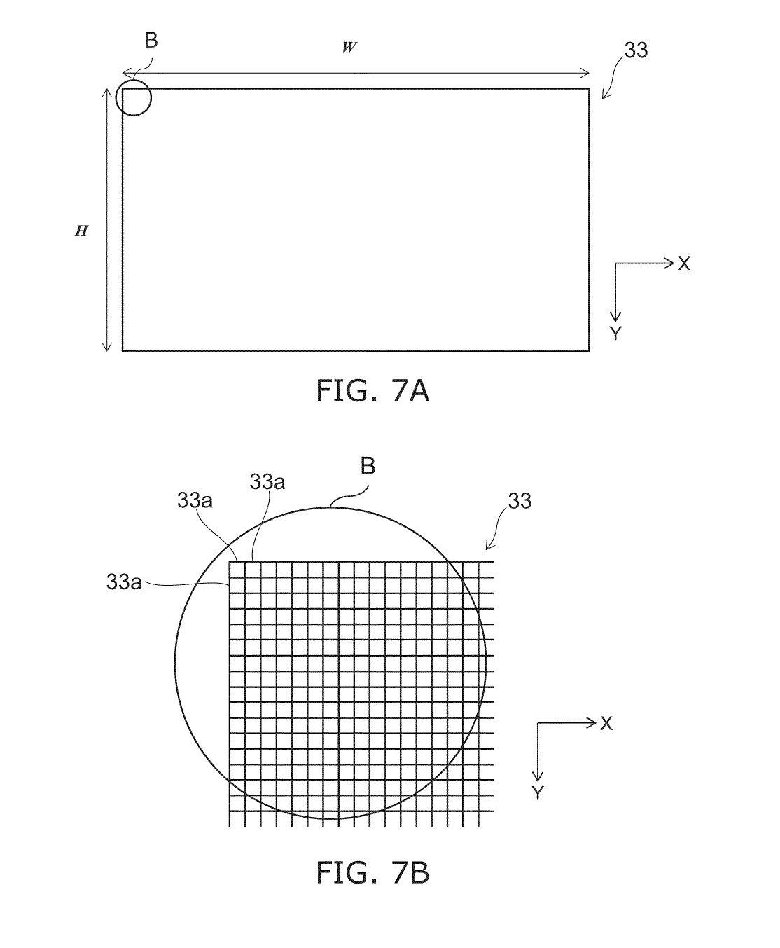

FIG. 7A and FIG. 7B are schematic views illustrating the image display device according to the first embodiment.

FIG. 7A and FIG. 7B show the lens LUT 33. FIG. 7B is a drawing in which portion B of FIG. 7A is magnified.

Storage regions 33a that correspond to the pixels 21 are multiply disposed in the lens LUT 33.

For example, in the display unit 20, W pixels are arranged in the horizontal direction; and H pixels are arranged in the vertical direction. In such a case as shown in FIG. 7A, W storage regions 33a are arranged in the horizontal direction; and H storage regions 33a are arranged in the vertical direction. Thereby, the arrangement of the pixels 21 on the display unit 20 corresponds respectively to the arrangement of the storage regions 33a in the lens LUT 33.

The lens identification values 31r of the lenses 31 corresponding to the pixels 21 are recorded in the storage regions 33a. For example, the lens identification value 31r that is recorded in each of the storage regions 33a is determined from the display coordinates of the pixel 21 corresponding to the lens 31.

For example, the lens 31 corresponding to each of the pixels 21 is the lens 31 intersected by the straight lines connecting the eyeball position 80e and each of the pixels 21. The lens 31 corresponding to each of the pixels 21 is based on the positional relationship between the pixels 21, the lenses 31, and the eyeball position 80e.

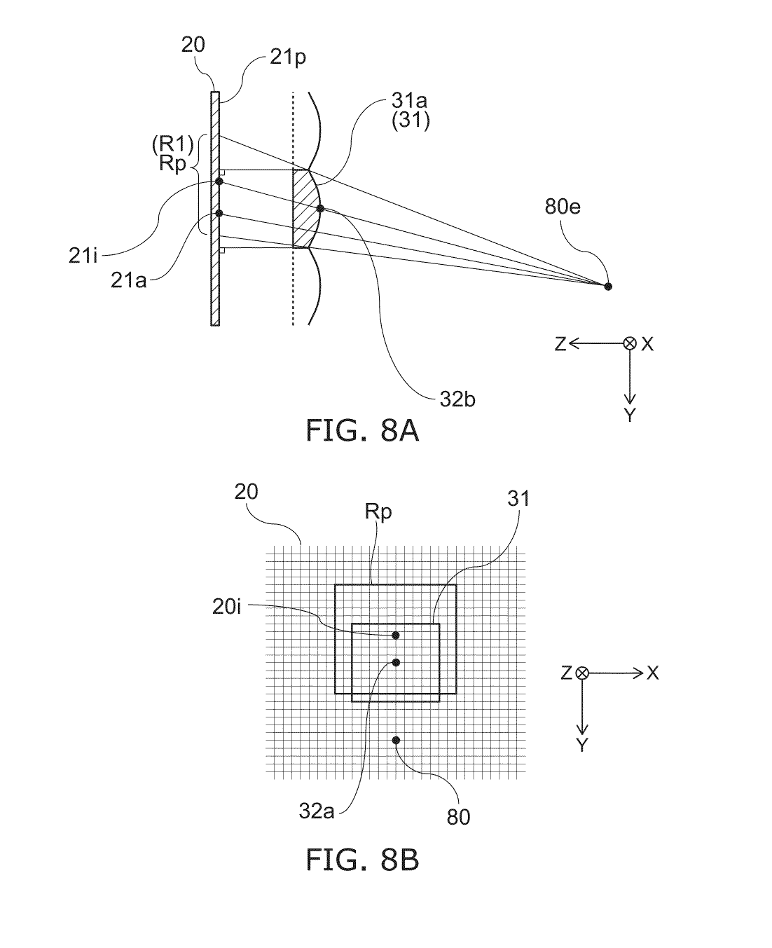

FIG. 8A and FIG. 8B are schematic views illustrating the image display device according to the first embodiment. FIG. 8A is a cross-sectional view of a portion of the display unit 20 and a portion of the lens unit 30. FIG. 8B is a perspective plan view of the portion of the display unit 20 and the portion of the lens unit 30.

As shown in FIG. 8A, for example, the straight line that connects the first pixel 21a and the eyeball position 80e intersects the first lens 31a. In such a case, the lens 31 that corresponds to the first pixel 21a is the first lens 31a. The lens identification value 31r that corresponds to the first lens 31a is recorded in the storage region 33a of the lens LUT 33 corresponding to the first pixel 21a.

Thus, the lens 31 corresponding to each of the pixels 21 is determined. Thereby, the display region Rp on the display unit 20 that corresponds to one lens 31 is determined. The pixels that are associated with the one lens 31 are disposed in one display region Rp.

For example, the straight lines passing through the eyeball position 80e and each of the multiple pixels 21 disposed in the display region Rp (the first display region R1) corresponding to the first lens 31a intersect the first lens 31a. The corresponding lens determination unit 12a according to the embodiment refers to the lens identification value 31r of the storage region 33a corresponding to each of the pixels 21 from the lens LUT 33 and the display coordinates 11cd of each of the pixels 21. Thus, the corresponding lens determination unit 12a according to the embodiment calculates the lens identification value 31r of the lens 31 corresponding to each of the pixels 21 from the lens LUT 33 and the display coordinates 11cd of each of the pixels 21.

For example, the image converter (the corresponding lens determination unit 12a) calculates the display region Rp (the first display region R1) corresponding to the first lens 31a from the lens LUT 33 and the display coordinates 11cd of each of the pixels. The positional relationship between the multiple lenses 31 and the multiple pixels 21 is pre-recorded in the lens LUT.

The center coordinate determination unit 12b according to the embodiment calculates the center coordinates 12cd corresponding to the lens 31 corresponding to the lens identification value 31r based on the lens identification value 31r calculated by the corresponding lens determination unit 12a.

For example, the center coordinate determination unit 12b according to the embodiment refers to a center coordinate LUT (lookup table) 34. Thereby, the center coordinate determination unit 12b calculates the center coordinates 12cd corresponding to each of the lenses 31. For example, the center coordinates 12cd corresponding to each of the lenses 31 are pre-recorded in the center coordinate LUT 34.

Storage regions 34a that correspond to the lens identification values 31r are multiply disposed in the center coordinate LUT 34 according to the embodiment.

For example, in the lens unit 30, N lenses are arranged in the horizontal direction; and M lenses are arranged in the vertical direction. In such a case, N storage regions 34a corresponding to the lens identification values 31r are arranged in the horizontal direction; and M storage regions 34a corresponding to the lens identification values 31r are arranged in the vertical direction. The center coordinates 12cd that correspond to the corresponding lens 31 are recorded in each of the storage regions 34a of the center coordinate LUT 34.

The center coordinates 12cd that correspond to the lens 31 are coordinates on the display unit 20 (on the first surface 20p). The center coordinates 12cd are determined from the positional relationship between the nodal point 32b of the lens 31, the eyeball position 80e, and the display unit 20.

The center coordinates 12cd are coordinates on the display unit 20 (on the first surface 20p) of the intersection where the light ray from the eyeball position 80e toward the nodal point 32b of the lens 31 intersects the display surface 21p of the display unit 20. The nodal point 32b is the nodal point (the rear nodal point) of the lens 31 on the viewer 80 side. The second surface 30p is disposed between the nodal point 32b and the display surface 21p.

For example, the lenses 31, the eyeball position 80e, and the display unit 20 are disposed as shown in FIG. 8A. In such a case, for example, a virtual light ray from the eyeball position 80e toward the nodal point 32b of the first lens 31a intersects the display surface 21p at a first intersection 21i. The coordinates of the first intersection 21i on the display unit 20 (on the first surface 20p) are the center coordinates 12cd corresponding to the first lens 31a.

Accordingly, the coordinates of the first intersection 21i on the display unit 20 are recorded in the storage region 34a corresponding to the lens identification value 31r of the first lens 31a in the center coordinate LUT 34 according to the embodiment.

In the example, the nodal point 32b (the rear nodal point) of the lens 31 on the viewer 80 side is extremely proximal to the nodal point (the front nodal point) of the lens 31 on the display unit 20 side. In FIG. 8A and FIG. 8B, the nodal points are shown together as one nodal point. In the case where the nodal point 32b (the rear nodal point) of the lens 31 on the viewer 80 side is extremely proximal to the nodal point (the front nodal point) of the lens 31 on the display unit 20 side, the nodal points may be treated as one nodal point without differentiation. In such a case, the center coordinates 12cd that correspond to the lens 31 are the coordinates on the display unit 20 of the intersection where the virtual light ray from the eyeball position 80e of the viewer 80 toward the nodal point of the lens 31 intersects the display surface 21p.

The center coordinate determination unit 12b according to the embodiment refers to the center coordinates 12cd of the storage regions 34a corresponding to each of the lens identification values 31r from the center coordinate LUT 34 and the lens identification value 31r calculated by the corresponding lens determination unit 12a.

Thus, the center coordinate determination unit 12b according to the embodiment calculates the center coordinates 12cd of the lens 31 corresponding to the lens identification value 31r from the center coordinate LUT 34 and the lens identification value 31r calculated by the corresponding lens determination unit 12a.

Thus, the center coordinate calculator 12 according to the embodiment calculates the center coordinates 12cd corresponding to the lens 31 corresponding to each of the pixels 21 from the display coordinates 11cd of each of the pixels 21. The center coordinates 12cd that correspond to the lens 31 corresponding to each of the pixels 21 are determined from the positional relationship between the nodal point 32b of the lens 31 corresponding to each of the pixels 21, the eyeball position 80e, and the display unit 20.

For example, the center coordinates 12cd (the first center point) that correspond to the first lens 31a are calculated based on the position of the nodal point of the first lens 31a, the position of the eyeball position 80e, and the position of the first surface 20p (the position of the display unit 20).

The first center point is determined from the intersection between the first surface 20p and the virtual light ray from the eyeball position 80e toward the nodal point (the rear nodal point) of the first lens 31a. For example, the image converter (the center coordinate determination unit 12b) calculates the coordinates (the center coordinates 12cd) of the first center point using the center coordinate LUT 34. As described above, the center coordinate LUT 34 is information relating to the intersections between the first surface 20p and the virtual light rays from the eyeball position 80e toward the nodal points (the rear nodal points) of the multiple lenses 31.

The magnification ratio calculator 13 calculates the magnification ratio 13r of the lens 31 corresponding to each of the pixels 21. The magnification ratio 13r is determined from the distance between the eyeball position 80e and the principal plane (the third surface 31p) of the lens 31 corresponding to each of the pixels 21, the distance between the display unit 20 and the principal point 32a of the lens 31 corresponding to each of the pixels 21, and the focal length f1 of the lens 31 corresponding to each of the pixels 21.

In the embodiment, for example, the focal lengths f1 of the lenses 31 on the lens array are substantially the same.

For example, the magnification ratio calculator 13 refers to an magnification ratio storage region. The magnification ratios that correspond to the lenses 31 on the lens array are pre-recorded in the magnification ratio storage region. Thereby, the magnification ratio calculator 13 can calculate the magnification ratio 13r of the lens 31 corresponding to each of the pixels 21.

FIG. 9 is a schematic view illustrating the image display device according to the first embodiment.

FIG. 9 shows the magnification ratio 13r of the lens 31.

In the example, the principal plane (the rear principal plane) of the lens 31 on the viewer 80 side is extremely proximal to the principal plane (the front principal plane) of the lens 31 on the display unit 20 side. Therefore, in FIG. 9, the principal planes are shown together as one principal plane (the third surface 31p).

Similarly, in the example, the principal point (the rear principal point) of the lens 31 on the viewer 80 side is extremely proximal to the principal point (the front principal point) of the lens 31 on the display unit 20 side. Therefore, in FIG. 9, the principal points are shown as one principal point (the principal point 32a).

For example, the magnification ratio 13r of the lens 31 is determined from the distance between the eyeball position 80e and the third surface 31p (the principal plane of the lens 31), the distance between the principal point 32a and the display unit 20, and the focal length f1 of the lenses 31.

For example, the magnification ratio 13r of the lens is determined from the ratio of the tangent of a second angle ζᵢ to the tangent of a first angle ζₒ.

For example, the distance between the third surface 31p and the eyeball position 80e is a distance zₙ.

The first angle ζₒ is the angle between an optical axis 311 of the lens 31 and the straight line connecting the pixel 21 on the display unit 20 and a point (a second point Dt2) on the optical axis 311 away from the third surface 31p toward the eyeball position 80e by the distance zₙ.

The second angle ζᵢ is the angle between the optical axis 311 of the lens 31 and the straight line connecting the point (the second point Dt2) on the optical axis 311 away from the third surface 31p toward the eyeball position 80e by the distance zₙ and a virtual image 21v of the pixel 21 viewed by the viewer 80 through the lens 31.

As shown in FIG. 9, for example, the distance zₙ is the distance between the eyeball position 80e of the viewer 80 and the principal plane (the third surface 31p) of the lens 31 on the viewer 80 side. For example, the distance zₒ is the distance between the display unit 20 and the principal point (the front principal point, i.e., the principal point 32a) on the display unit 20 side. The focal length f is the focal length f1 of the lens 31.

The second point Dt2 is the point on the optical axis 311 of the lens away from the principal plane (the rear principal plane, i.e., the third surface 31p) of the lens 31 on the viewer 80 side toward the eyeball position 80e by the distance zₙ. In FIG. 9, the eyeball position 80e and the second point Dt2 are the same point.

For example, the first pixel 21a is disposed on the display unit 20. A distance xₒ is the distance between the first pixel 21a and the optical axis 311. The viewer 80 views the virtual image 21v of the first pixel 21a through the lens 31. The virtual image 21v is viewed as if it were at a position zₒ·f/(f−zₒ) from the principal plane (the front principal plane) of the lens on the display unit 20 side. The virtual image 21v is viewed as if it were at a position xₒ·f/(f−zₒ) from the optical axis 311.

In such a case, the tangent of the angle (the first angle between the optical axis 311 of the lens and the straight line connecting the second point Dt2 and the pixel 21 is tan(ζₒ)=xₒ/(zₙ+zₒ). The tangent of the angle (the second angle ζᵢ) between the optical axis 311 of the lens and the straight line connecting the second point Dt2 and the virtual image 21v is tan(ζᵢ)=(xₒ·f/(f−zₒ))/(zₙ+zₒ·f/(f−zₒ)).

The magnification ratio 13r of the lens 31 is, for example, M. In such a case, the magnification ratio (M) is calculated as the ratio of tan(ζᵢ) to tan(ζₒ), i.e., tan(ζᵢ)/tan(ζₒ).

Accordingly, the magnification ratio (M) of the lens 31 is calculated by the following formula.

M=Tan(ζᵢ)/Tan(ζₒ)=(zₙ+zₒ)/(zₙ+zₒ·f/(f−zₒ))

For example, it can be seen from this formula that the magnification ratio (M) of the lens 31 is not dependent on the position xₒ of the pixel on the display unit 20. For example, the magnification ratio (M) of the lens 31 is a value determined from the distance zₙ between the eyeball position 80e of the viewer 80 and the principal plane (the rear principal plane) of the lens 31 on the viewer 80 side, the distance zₒ between the display unit 20 and the principal point (the front principal point) of the lens 31 on the display unit 20 side, and the focal length f of the lens.

The magnification ratio (M) is the ratio of the size, normalized by the distance from the eyeball position 80e of the viewer 80, of the virtual image of one image viewed by the viewer 80 through the lens to the size, normalized by the distance from the eyeball position 80e of the viewer 80, of the one image displayed by the display unit 20.

The magnification ratio (M) is the ratio of the size of the virtual image of one image viewed by the viewer 80 through the lens 31 when projected by perspective projection having the eyeball position 80e as the viewpoint onto one plane parallel to the principal plane (the third surface 31p) of the lens 31 to the size of the one image displayed by the display unit 20 when projected by perspective projection onto the plane.

The magnification ratio (M) is the ratio of the apparent size from the eyeball position 80e of the viewer 80 of the virtual image of one image viewed through the lens to the apparent size from the eyeball position 80e of the viewer 80 of the one image displayed by the display unit 20.

The one image displayed by the display unit 20 appears to be magnified by the magnification ratio (M) from the viewer 80.

Thus, the determined magnification ratio 13r (M) of each of the lenses 31 is recorded in the magnification ratio storage region according to the embodiment. The magnification ratio 13r (M) is determined based on the distance between the eyeball position 80e of the viewer and the principal plane (the rear principal plane, i.e., the third surface 31p) of the lens 31 on the viewer 80 side, the distance between the display unit 20 and the principal point (the front principal point) of the lens 31 on the display unit 20 side, and the focal length f of the lens 31.

For example, the magnification ratio of the first lens 31a is calculated based on the distance between the eyeball position 80e and the third surface 31p passing through the principal point of the first lens to be parallel to the second surface 30p, the distance between the first surface 20p and the principal point of the first lens 31a, and the focal length of the first lens.

In the case where the principal plane (the rear principal plane) of the lens 31 on the viewer 80 side is extremely proximal to the principal plane (the front principal plane) of the lens 31 on the display unit 20 side, the principal planes may be treated together as one principal plane.

In such a case, the magnification ratio 13r (M) of the lens 31 is determined from the distance between the principal plane of the lens 31 and the eyeball position 80e of the viewer 80, the distance between the display unit 20 and the principal point 32a of the lens 31, and the focal length f of the lens 31.

In such a case, the first angle ζₒ is the angle between the optical axis 311 of the lens 31 and the straight line connecting the pixel 21 on the display unit 20 and the point on the optical axis 311 of the lens away from the principal plane of the lens 31 toward the eyeball position 80e by a distance, the distance being the distance between the eyeball position 80e and the principal plane of the lens 31.

In such a case, the second angle ζᵢ is the angle between the optical axis 311 of the lens 31 and the straight line connecting the virtual image 21v of the pixel 21 viewed by the viewer 80 through the lens 31 and the point on the optical axis 311 of the lens 31 away from the principal plane of the lens 31 toward the eyeball position 80e by a distance, the distance being the distance between the principal plane of the lens and the eyeball position 80e of the viewer 80. The magnification ratio (M) is the ratio of the tangent of the second angle ζᵢ to the tangent of the first angle ζₒ.

Thus, the magnification ratio calculator 13 according to the embodiment calculates the magnification ratio 13r of the lens 31 corresponding to each of the pixels 21 by referring to the magnification ratio storage region. In the example, the magnification ratios 13r corresponding to the lenses 31 are pre-recorded in the magnification ratio storage region.

For example, the magnification ratio that corresponds to the first lens 31a is determined from the ratio of the tangent of the second angle ζᵢ to the tangent of the first angle ζₒ.

The first angle ζₒ is the angle between the optical axis of the first lens 31a and the straight line connecting the second point Dt2 on the optical axis of the first lens 31a and the first pixel disposed in the first display region R1. The second angle ζᵢ is the angle between the optical axis of the first lens 31a and the straight line connecting the second point Dt2 and the virtual image viewed from the eyeball position 80e through the first lens 31a.

The distance between the second point Dt2 and the third surface 31p is substantially the same as the distance between the eyeball position 80e and the third surface 31p. The same one pixel of the multiple first pixels 21a provided on the display unit 20 can be used to calculate the first angle and the second angle ζᵢ.

The image reduction unit 14 reduces the input image I1 using the display coordinates 11cd of each of the pixels 21 generated by the display coordinate generator 11, the center coordinates 12cd corresponding to the lens 31 corresponding to each of the pixels 21 calculated by the center coordinate calculator 12, and the magnification ratio 13r of the lens 31 corresponding to each of the pixels 21 calculated by the magnification ratio calculator 13.

The image reduction unit 14 reduces the input image I1 by the proportion of the reciprocal of the magnification ratio 13r corresponding to each of the lenses 31 using the center coordinates 12cd corresponding to each of the lenses 31 as the center. For example, the image reduction unit 14 reduces the input image I1 (1/M) times using the center coordinates 12cd corresponding to each of the lenses 31 as the center. Thereby, the image reduction unit 14 calculates the display image I2 to be displayed by the display unit 20.

For example, the image reduction unit 14 reduces the input image based on the magnification ratio of the first lens 31a using the center coordinates (the first center point) corresponding to the first lens 31a as the center. Thereby, the first regional image Rg1 that is displayed in the first display region R1 is calculated.

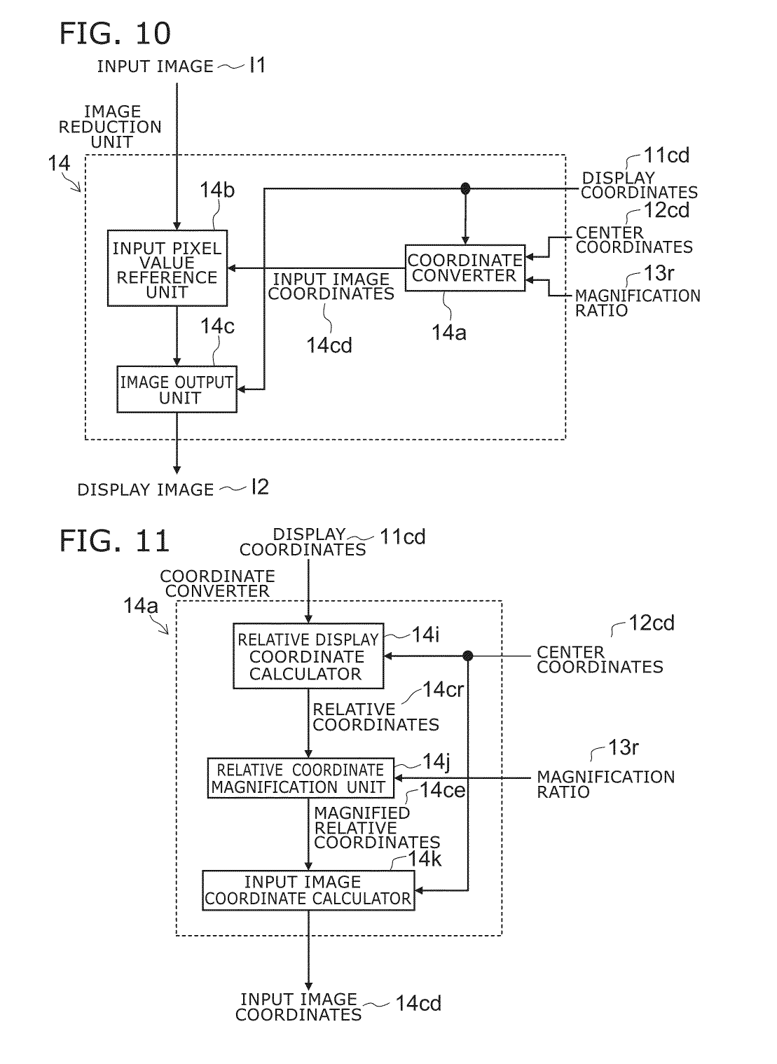

FIG. 10 is a schematic view illustrating the image display device according to the first embodiment.

FIG. 10 shows the image reduction unit 14.

As shown in FIG. 10, the image reduction unit 14 includes a coordinate converter 14a, an input pixel value reference unit 14b, and an image output unit 14c. The coordinate converter 14a calculates input image coordinates 14cd from the display coordinates 11cd of each of the pixels 21 on the display unit 20, the center coordinates 12cd corresponding to each of the pixels 21, and the magnification ratio 13r of the lens 31 corresponding to each of the pixels 21. The input image coordinates 14cd are the coordinates when the display coordinates 11cd of each of the pixels 21 are magnified by the magnification ratio 13r of the lens 31 corresponding to each of the pixels 21 using the center coordinates 12cd corresponding to each of the pixels 21 as the center.

The input pixel value reference unit 14b refers to the pixel values of the pixels of the input images I1 corresponding to the input image coordinates 14cd for the input image coordinates 14cd calculated for each of the pixels 21.

The image output unit 14c outputs the pixel values referred to by the input pixel value reference unit 14b as the pixel values of the pixels 21 corresponding to the display coordinates 11cd on the display unit 20.

FIG. 11 is a schematic view illustrating the image display device according to the first embodiment.

FIG. 11 shows the coordinate converter 14a.

The coordinate converter 14a calculates the input image coordinates 14cd from the display coordinates 11cd of each of the pixels 21 on the display unit 20, the center coordinates 12cd corresponding to each of the pixels 21, and the magnification ratio 13r of the lens 31 corresponding to each of the pixels 21. The input image coordinates 14cd are the coordinates when the display coordinates 11cd of each of the pixels 21 are magnified by the magnification ratio 13r of the lens 31 corresponding to each of the pixels 21 using the center coordinates 12cd corresponding to each of the pixels 21 as the center.

The coordinate converter 14a includes a relative display coordinate calculator 14i, a relative coordinate magnification unit 14j, and an input image coordinate calculator 14k.

The relative display coordinate calculator 14i calculates relative coordinates 14cr from the center coordinates 12cd of each of the pixels 21 by calculating using the display coordinates 11cd of each of the pixels 21 on the display unit 20 and the center coordinates 12cd corresponding to each of the pixels 21.

The relative coordinate magnification unit 14j calculates magnified relative coordinates 14ce from the relative coordinates 14cr from the center coordinates 12cd of each of the pixels 21 and the magnification ratio 13r of the lens 31 corresponding to each of the pixels 21. The magnified relative coordinates 14ce are the coordinates when the relative coordinates 14cr from the center coordinates 12cd of each of the pixels 21 are magnified by the magnification ratio 13r of the lens 31 corresponding to each of the pixels 21.

The input image coordinate calculator 14k calculates the input image coordinates 14cd from the magnified relative coordinates 14ce and the center coordinates 12cd corresponding to each of the pixels 21. The input image coordinates 14cd are the coordinates when the display coordinates 11cd of each of the pixels 21 are magnified by the magnification ratio 13r of the lens 31 corresponding to each of the pixels 21 using the center coordinates 12cd corresponding to each of the pixels 21 as the center.

The relative display coordinate calculator 14i calculates the relative coordinates 14cr from the center coordinates 12cd of each of the pixels 21 by calculating using the display coordinates 11cd of each of the pixels 21 on the display unit 20 and the center coordinates 12cd corresponding to each of the pixels 21.

The relative display coordinate calculator 14i subtracts the center coordinates 12cd corresponding to each of the pixels 21 from the display coordinates 11cd of each of the pixels 21 on the display unit 20. Thereby, the relative coordinates 14cr are calculated from the center coordinates 12cd of each of the pixels 21.

For example, the display coordinates 11cd of the pixels 21 on the display unit 20 are (xₚ, yₚ); the corresponding center coordinates are (x_{c}, y_{c}); and the relative coordinates 14cr are (xᵢ, yᵢ). In such a case, the relative display coordinate calculator 14i calculates the relative coordinates 14cr by the following formula.

(xₗ,yₗ)=(xₚ−x_{c},yₚ−y_{c})

The relative coordinate magnification unit 14j multiplies the relative coordinates 14cr from the center coordinates 12cd of each of the pixels 21 by the magnification ratio 13r of the lens 31 corresponding to each of the pixels 21. Thereby, the magnified relative coordinates 14ce are calculated. The magnified relative coordinates 14ce are the coordinates when the relative coordinates 14cr are magnified by the magnification ratio of the lens 31 corresponding to each of the pixels 21.

For example, the relative coordinates 14cr from the center coordinates 12cd of each of the pixels 21 are (xᵢ, yᵢ); the magnification ratio M is the magnification ratio 13r of the lens 31 corresponding to each of the pixels 21; and the magnified relative coordinates 14ce corresponding to each of the pixels 21 are (xₗ′, yₗ′). In such a case, the relative coordinate magnification unit 14j calculates the magnified relative coordinates 14ce by the following formula.

(xₗ′,yₗ′)=(M·xₗ,M·yₗ)

The input image coordinate calculator 14k adds the magnified relative coordinates 14ce to the center coordinates 12cd. Thereby, the input image coordinates 14cd are calculated. The input image coordinates 14cd are the coordinates when the display coordinates 11cd of each of the pixels 21 are magnified by the magnification ratio 13r of the lens 31 corresponding to each of the pixels 21 using the center coordinates 12cd corresponding to each of the pixels 21 as the center.

For example, the center coordinates 12cd corresponding to each of the pixels 21 are (x_{c}, y_{c}); the magnified relative coordinates 14ce corresponding to each of the pixels 21 are (xₗ′, yₗ′); and the input image coordinates 14cd corresponding to each of the pixels 21 are (xᵢ, yᵢ). In such a case, the input image coordinate calculator 14k calculates the input image coordinates 14cd by the following formula.

(xᵢ,yᵢ)=(xₗ′+x_{c},yₗ′+y_{c})

Thus, the coordinate converter 14a uses the relative display coordinate calculator 14i, the relative coordinate magnification unit 14j, and the input image coordinate calculator 14k to calculate the input image coordinates 14cd, which are the coordinates when the display coordinates 11cd of each of the pixels 21 are magnified by the magnification ratio 13r of the lens 31 corresponding to each of the pixels 21 using the center coordinates 12cd corresponding to each of the pixels 21 as the center, from the display coordinates 11cd of each of the pixels 21 on the display unit 20, the center coordinates 12cd corresponding to each of the pixels 21, and the magnification ratio 13r of the lens 31 corresponding to each of the pixels 21.

For example, the display coordinates 11cd of each of the pixels 21 on the display unit 20 are (xₚ, yₚ); the center coordinates 12cd corresponding to each of the pixels 21 are (x_{c}, y_{c}); the magnification ratio M is the magnification ratio 13r of the lens 31 corresponding to each of the pixels 21; and the input image coordinates 14cd corresponding to each of the pixels 21 are (xᵢ, yᵢ). In such a case, the input image coordinates 14cd are calculated by the following formula in which the calculations of the relative display coordinate calculator 14i, the relative coordinate magnification unit 14j, and the input image coordinate calculator 14k are combined.

(xᵢ,yᵢ)=(M·(xₚ−x_{c}),M·(yₚ,−y_{c}))

The input pixel value reference unit 14b refers to the pixel values of the pixels on the input image I1 corresponding to the input image coordinates 14cd for the input image coordinates 14cd calculated for each of the pixels 21.

For example, in the case of the input image coordinates 14cd of (xᵢ, yᵢ)=(0, 0), the input pixel value reference unit 14b refers to the pixel value of the pixel 21 of the input image I1 corresponding to the coordinates on the input image I1 of (xᵢ, yᵢ)=(0, 0).

In the case where there are no pixels on the input image I1 that strictly correspond to the input image coordinates 14cd, the input pixel value reference unit 14b calculates the pixel value of the pixel on the input image I1 corresponding to the input image coordinates 14cd based on the pixel values of the multiple pixels 21 on the input image I1 spatially most proximal to the input image coordinates 14cd. The input pixel value reference unit 14b refers to the pixel value that is calculated as the pixel value of the pixel on the input image I1 corresponding to the input image coordinates 14cd.

For the calculation of the pixel value of the pixel corresponding to the input image coordinates 14cd on the input image I1 based on the pixel values of the multiple pixels on the input image I1 spatially most proximal to the input image coordinates 14cd when there are no pixels on the input image I1 strictly corresponding to the input image coordinates 14cd, a nearest neighbor method, a bilinear interpolation method, or a bicubic interpolation method may be used.

For example, the pixel values of the pixels on the input image I1 spatially most proximal to the input image coordinates 14cd may be used to calculate the pixel value of the coordinates corresponding to the input image coordinates 14cd on the input image I1 by the nearest neighbor method.

For example, the calculation may be performed using a first order equation from the pixel values and coordinates of the multiple pixels on the input image I1 spatially most proximal to the input image coordinates 14cd by the bilinear interpolation method.

For example, the calculation may be performed using a third order equation from the pixel values and coordinates of the multiple pixels on the input image I1 spatially most proximal to the input image coordinates 14cd by the bicubic interpolation method. The calculation may be performed by other known interpolation methods.

The image output unit 14c outputs the pixel values referred to by the input pixel value reference unit 14b as the pixel values of the pixels 21 corresponding to the display coordinates 11cd on the display unit 20. The input pixel value reference unit 14b refers to the pixel value of the pixel on the input image I1 corresponding to the input image coordinates 14cd for the input image coordinates 14cd calculated for each of the pixels 21.

Thus, the image reduction unit 14 reduces the input image I1 by the proportion of the reciprocal of the magnification ratio 13r corresponding to each of the lenses 31 using the center coordinates 12cd corresponding to each of the lenses 31 as the center. Thereby, the display image I2 to be displayed by the display unit 20 is calculated. The input image I1, the display coordinates 11cd generated by the display coordinate generator 11, the center coordinates 12cd calculated by the center coordinate calculator 12, and the magnification ratio 13r of the lens 31 corresponding to each of the pixels 21 are used to calculate the display image I2.

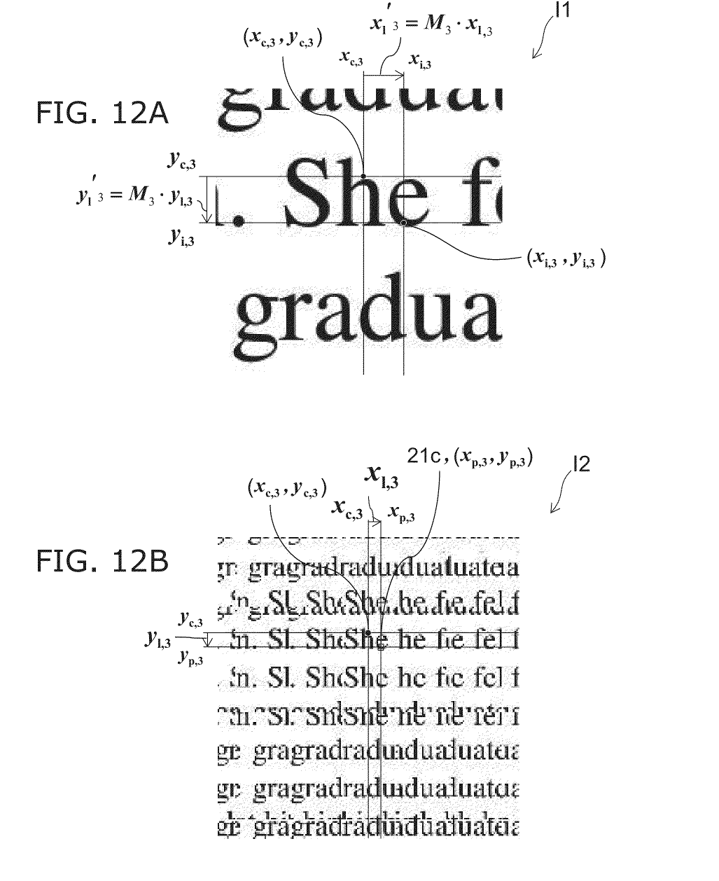

FIG. 12A and FIG. 12B are schematic views illustrating the operation of the image display device according to the first embodiment.

FIG. 12A shows the input image I1. FIG. 12B shows the display image I2.

The display coordinates 11cd on the display unit 20 generated by the display coordinate generator 11 for, for example, a pixel 21c on the display unit 20 are, for example, (x_{p,3}, y_{p,3}).

For example, the center coordinates 12cd corresponding to the lens 31 corresponding to the pixel 21c calculated by the center coordinate calculator 12 are (x_{c,3}, y_{c,3}).

An magnification ratio M₃ is the magnification ratio 13r of the lens 31 corresponding to the pixel 21c calculated by the magnification ratio calculator 13.

In such a case, (x_{c,3}, y_{c,3}) is subtracted from (x_{p,3}, y_{p,3}) by the relative display coordinate calculator 14i of the coordinate converter 14a. Thereby, the relative coordinates 14cr are calculated from the center coordinates 12cd of the pixel 21c. In other words, the relative coordinates of the pixel 21c are calculated so that (x_{l,3}, y_{l,3})=(x_{p,3}−x_{c,3}, y_{p,3}−y_{c,3}).

In the relative coordinate magnification unit 14j of the coordinate converter 14a, (x_{l,3}, y_{l,3}) is multiplied by M₃. Thereby, the magnified relative coordinates (x_{1′3}, y_{1′3}) of the pixel 21c are calculated. The magnified relative coordinates (x_{l′3}, y_{l′3}) are the coordinates when the relative coordinates (x_{l,3}, y_{l,3}) of the pixel 21c are magnified by the magnification ratio (M₃) of the lens 31 corresponding to the pixel 21c. In other words, the magnified relative coordinates that correspond to the pixel 21c are calculated so that (x_{l′3}, y_{l′3})=(M₃·x_{l,3}, M₃·y_{l,3}).

In the input image coordinate calculator 14k of the coordinate converter 14a, the magnified relative coordinates (x_{l′3}, y_{l′3}) are added to the center coordinates (x_{c,3}, y_{c,3}). Thereby, the input image coordinates (x_{i,3}, y_{i,3}) are calculated. In other words, the input image coordinates corresponding to the pixel 21c are calculated so that (x_{i,3}, y_{i,3})=(x_{c,3}+x_{l′3}, y_{c,3}+y_{l′3}).

The input image coordinates (x_{i,3}, y_{i,3}) are the coordinates when the display coordinates (x_{p,3}, y_{p,3}) are magnified M₃ times using the center coordinates (x_{c,3}, y_{c,3}) as the center.

Then, the pixel value of the pixel of the coordinates corresponding to the input image coordinates (x_{i,3}, y_{i,3}) on the input image I1 is referred to by the input pixel value reference unit 14b. In the image output unit 14c, the pixel value that is referred to by the input pixel value reference unit 14b is output as the pixel value of the pixel corresponding to the display coordinates on the display unit 20.

Such a calculation is performed for each of the pixels 21 on the display unit 20. Thereby, in the image reduction unit 14, the display image I2 is calculated by reducing the input image I1 by the proportion of the reciprocal of the magnification ratio 13r corresponding to each of the lenses 31 using the center coordinates 12cd corresponding to each of the lenses 31 as the center.

Thus, the image converter 10 calculates the display image I2 from the display coordinates 11cd of each of the pixels 21, the center coordinates 12cd corresponding to the lens 31 corresponding to each of the pixels 21, and the magnification ratio 13r of the lens 31 corresponding to each of the pixels 21. In other words, the input image I1 is reduced by the proportion of the reciprocal of the magnification ratio 13r corresponding to each of the lenses 31 using the center coordinates 12cd corresponding to each of the lenses 31 as the center. Thus, the image converter 10 converts the input image I1 into the display image I2 to be displayed by the display unit 20.

Here, the center coordinates 12cd corresponding to the lens 31 corresponding to each of the pixels 21 are determined from the positional relationship between the nodal point of the lens 31 corresponding to each of the pixels 21, the eyeball position 80e of the viewer 80, and the display unit 20.

The magnification ratio 13r of the lens 31 corresponding to each of the pixels 21 is determined from the distance between the eyeball position 80e and the principal plane (the rear principal plane) on the viewer 80 side of the lens 31 corresponding to each of the pixels 21, the distance between the display unit 20 and the principal point (the front principal point) on the display unit 20 side of the lens 31 corresponding to each of the pixels 21, and the focal length f1 of the lens 31 corresponding to each of the pixels 21.

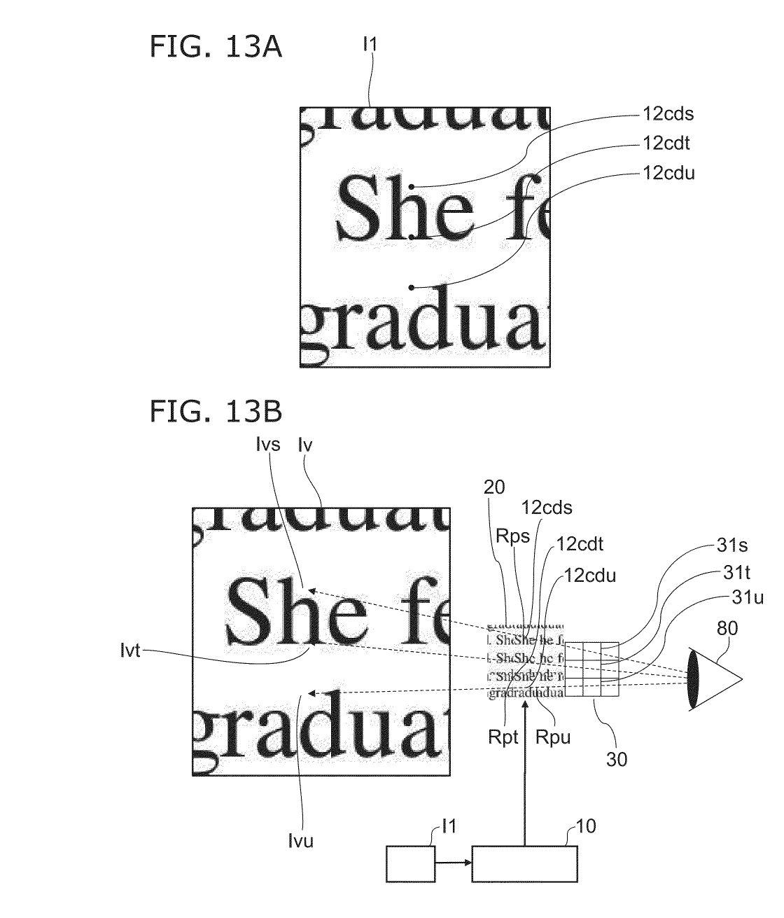

FIG. 13A and FIG. 13B are schematic views illustrating the operation of the image display device according to the first embodiment.

FIG. 13A shows the input image I1. FIG. 13B shows the operation of the image display device 100 in the case where the input image I1 shown in FIG. 13A is input.

In such a case, an image of the input image I1 reduced by the image converter 10 is displayed in a display region Rps (the display region including each of the pixels corresponding to a lens 31s) of the display unit 20. For example, the image of the input image I1 reduced by the proportion of the reciprocal of the magnification ratio of the lens 31s using center coordinates 12cds corresponding to the lens 31s as the center is displayed.

Similarly, an image of the input image I1 reduced by the image converter 10 is displayed in a display region Rpt (the display region Rp including each of the pixels corresponding to a lens 31t) of the display unit 20. For example, the image of the input image I1 reduced by the proportion of the reciprocal of the magnification ratio of the lens 31t using center coordinates 12cdt corresponding to the lens 31t as the center is displayed.

An image of the input image I1 reduced by the image converter is displayed in a display region Rpu (the display region Rp including each of the pixels corresponding to a lens 31u) of the display unit 20. For example, the image of the input image I1 reduced by the proportion of the reciprocal of the magnification ratio of the lens 31u using center coordinates 12cdu corresponding to the lens 31u as the center is displayed.

In such a case, from the viewer 80, the image displayed at each of the pixels corresponding to the lens 31s appears to be magnified by the magnification ratio of the lens 31s using the center coordinates 12cds as the center. The image that is viewed by the viewer 80 is a virtual image Ivs viewed through the lens 31s in the direction of the nodal point (on the viewer 80 side) of the lens 31s.

Similarly, from the viewer 80, the image that is displayed at each of the pixels corresponding to the lens 31t appears to be magnified by the magnification ratio of the lens 31t using the center coordinates 12cdt as the center. The image that is viewed by the viewer 80 is a virtual image Ivt viewed through the lens 31t in the direction of the nodal point (on the viewer 80 side) of the lens 31t.

Similarly, from the viewer 80, the image that is displayed at each of the pixels corresponding to the lens 31u appears to be magnified by the magnification ratio of the lens 31u using the center coordinates 12cdu as the center. The image that is viewed by the viewer 80 is a virtual image Ivu viewed through the lens 31u in the direction of the nodal point (on the viewer 80 side) of the lens 31u.

The multiple virtual images are viewed through the lenses 31 by the viewer 80. The viewer 80 views an image (a virtual image Iv) in which the multiple virtual images overlap. For example, the virtual image Iv in which the virtual image Ivs, the virtual image Ivt, and the virtual image Ivu overlap is viewed by the viewer 80. In the embodiment, the appearance of the virtual image Iv viewed by the viewer 80 matches the input image I1. Thus, the deviation between the virtual images viewed through the lenses 31 can be reduced. Thereby, a two-dimensional image display having a wide angle of view is possible. An image display device that provides a high-quality display is provided.

In the embodiment, the image input unit 41 and/or the image converter 10 may be, for example, a portable terminal, a PC, etc. For example, the image converter 10 includes a CPU (Central Processing Unit), ROM (Read Only Memory), and RAM (Random Access Memory). For example, the processing of the image converter 10 is performed by the CPU reading a program stored in memory such as ROM, etc., into RAM and executing the program. In such a case, for example, the image converter 10 may not be included in the image display device 100 and may be provided separately from the image display device 100. For example, communication between the image display device 100 and the image converter 10 is performed by a wired or wireless method. The communication between the image display device 100 and the image converter 10 may include, for example, a network such as cloud computing. The embodiment may be a display system including the image input unit 41, the image converter 10, the display unit 20, the lens unit 30, etc. A portion of the processing to be implemented by the image converter 10 may be realized by a circuit included in the image display device 100; and the remaining processing may be realized using a calculating device (a computer, etc.) in a cloud connected via a network.

### Second Embodiment

The image input unit 41, the image converter 10, the display unit 20, the lens unit 30, etc., are provided in an image display device 102 according to a second embodiment as well. The focal length f1 of the lens 31 is different between the multiple lens 31 provided in the lens unit 30 of the image display device 102. Accordingly, for example, the processing of the image converter 10 of the image display device 102 is different from the processing of the image converter 10 of the image display device 100.

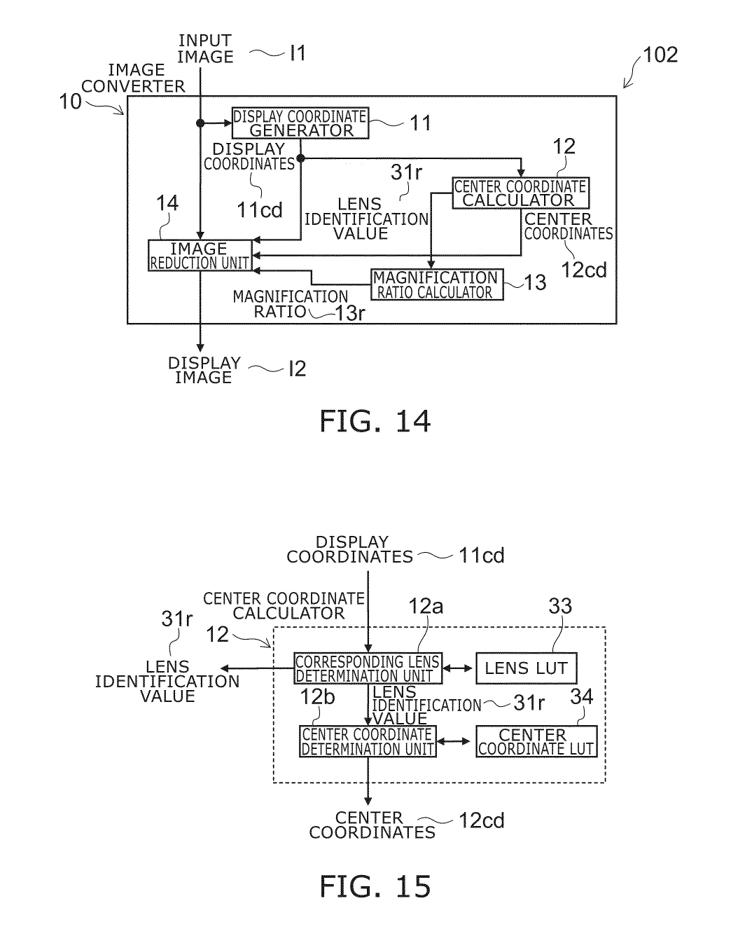

FIG. 14 is a schematic view illustrating the image display device according to the second embodiment.

FIG. 14 shows the image converter 10 of the image display device 102.

Similarly to the image converter 10 of the image display device 100, the image converter 10 of the image display device 102 converts the input image I1 input by the image input unit 41 into the display image I2 to be displayed by the display unit 20.

Similarly to the image converter 10 of the image display device 100, as shown in FIG. 14, the image converter 10 of the image display device 102 includes the display coordinate generator 11, the center coordinate calculator 12, the magnification ratio calculator 13, and the image reduction unit 14.

Similarly to the display coordinate generator 11 of the image display device 100, the display coordinate generator 11 of the image display device 102 generates the display coordinates 11cd for each of the pixels 21 on the display unit 20. The display coordinates 11cd are the coordinates on the display unit 20 of each of the pixels 21.

The center coordinate calculator 12 of the image display device 102 calculates the lens identification value 31r of the lens 31 corresponding to each of the pixels 21 and the center coordinates 12cd corresponding to the lens 31 corresponding to each of the pixels 21 from the display coordinates 11cd of each of the pixels 21 generated by the display coordinate generator 11.

The magnification ratio calculator 13 of the image display device 102 calculates the magnification ratio 13r of the lens 31 corresponding to each of the pixels 21 based on the lens identification value 31r of the lens 31 corresponding to each of the pixels 21 calculated by the center coordinate calculator 12.

Similarly to the image reduction unit 14 of the image display device 100, the image reduction unit 14 of the image display device 102 reduces the input image I1 using the display coordinates 11cd, the center coordinates 12cd, and the magnification ratio 13r. In other words, the image reduction unit 14 reduces the input image I1 by the proportion of the reciprocal of the magnification ratio 13r corresponding to each of the lenses 31 using the center coordinates 12cd corresponding to each of the lenses 31 as the center. Thereby, the image reduction unit 14 calculates the display image I2 to be displayed by the display unit 20.

The center coordinate calculator 12 and the magnification ratio calculator 13 of the image converter 10 of the image display device 102 are different from those of the image converter 10 of the image display device 100.

The center coordinate calculator 12 of the image display device 102 calculates the lens identification value 31r of the lens 31 corresponding to each of the pixels 21 and the center coordinates 12cd corresponding to the lens 31 corresponding to each of the pixels 21 from the display coordinates 11cd of each of the pixels 21.

FIG. 15 is a schematic view illustrating the image display device according to the second embodiment.

FIG. 15 shows the center coordinate calculator 12 of the image display device 102.

As shown in FIG. 15, in the image display device 102 as well, the center coordinate calculator 12 includes the corresponding lens determination unit 12a and the center coordinate determination unit 12b.

Similarly to the corresponding lens determination unit 12a of the image display device 100, the corresponding lens determination unit 12a of the image display device 102 calculates the lens identification value 31r corresponding to each of the pixels 21. The corresponding lens determination unit 12a of the image display device 102 refers to the lens identification value 31r corresponding to each of the pixels 21 using the lens LUT 33 and the display coordinates 11cd of each of the pixels 21.

The lens identification values 31r corresponding to the pixels 21 are stored in the storage regions of the lens LUT 33. The lens LUT 33 is a lookup table in which the lens identification values 31r of the lenses 31 corresponding to the pixels 21 are pre-recorded.

Thereby, the corresponding lens determination unit 12a calculates the lens identification value 31r of the lens corresponding to each of the pixels.

Similarly to the center coordinate determination unit 12b of the image display device 100, the center coordinate determination unit 12b of the image display device 102 calculates the center coordinates 12cd of the lens 31 corresponding to each of the lens identification values 31r. The center coordinate determination unit 12b of the image display device 102 refers to the center coordinates 12cd of the lenses 31 corresponding to the lens identification values 31r from the center coordinate LUT 34.

The center coordinates 12cd of the lenses 31 corresponding to the lens identification values 31r are stored in the storage regions corresponding to the lens identification values 31r of the center coordinate LUT 34. The center coordinate LUT 34 is a lookup table in which the center coordinates 12cd corresponding to each of the lenses 31 are pre-recorded.

Thereby, the center coordinate determination unit 12b calculates the center coordinates of the lenses corresponding to the lens identification values.

Thus, similarly to the center coordinate calculator 12 of the image display device 100, the center coordinate calculator 12 of the image display device 102 calculates the center coordinates 12cd corresponding to the lens 31 corresponding to each of the pixels 21 from the display coordinates 11cd of each of the pixels 21.

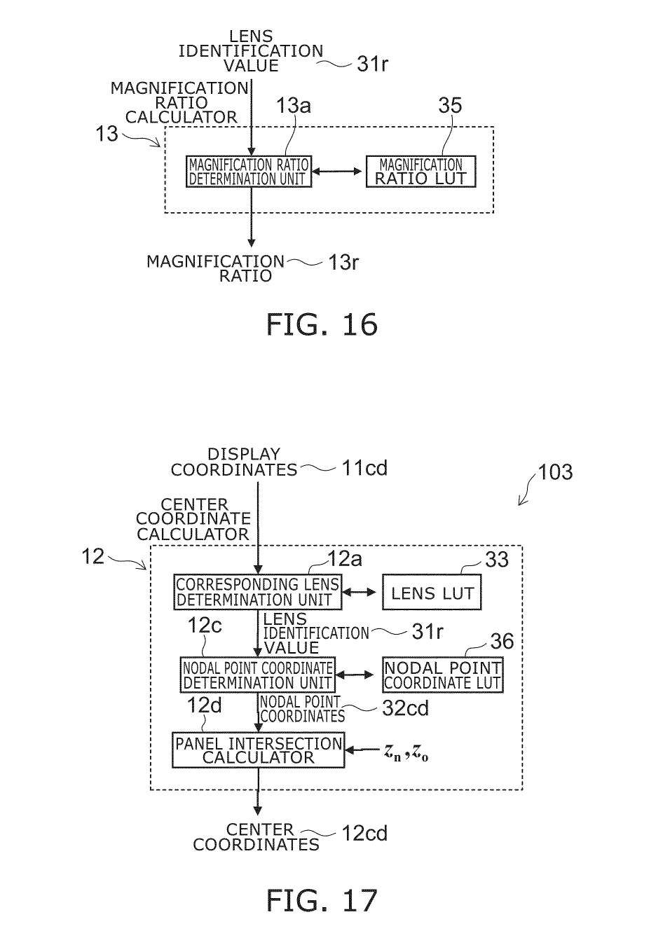

FIG. 16 is a schematic view illustrating the image display device according to the second embodiment.

FIG. 16 shows the magnification ratio calculator 13 of the image display device 102.

As shown in FIG. 16, the magnification ratio calculator 13 includes an magnification ratio determination unit 13a.

The magnification ratio determination unit 13a calculates the magnification ratio 13r of the lens 31 corresponding to each of the pixels 21 based on the lens identification value 31r of the lens 31 corresponding to each of the pixels 21 calculated by the center coordinate calculator 12.

An magnification ratio LUT 35 is a lookup table in which the magnification ratios 13r of the lenses 31 are pre-recorded. The magnification ratio determination unit 13a calculates the magnification ratio 13r of each of the lenses 31 (e.g., the first lens 31a) by referring to the magnification ratio LUT 35.

For example, storage regions 35a corresponding to the lens identification values 31r are multiply disposed in the magnification ratio LUT 35.

For example, N lenses 31 are arranged in the horizontal direction; and M lenses 31 are arranged in the vertical direction. In such a case, W storage regions 35a in the horizontal direction and H storage regions 35a in the vertical direction corresponding to the lenses 31 (the lens identification values 31r) are disposed in the magnification ratio LUT 35. The magnification ratios 13r of the lenses 31 corresponding to the storage regions 35a are recorded in the storage regions 35a of the magnification ratio LUT 35.

The magnification ratios 13r of the lenses 31 are recorded in the storage regions 35a of the magnification ratio LUT 35. The magnification ratio 13r of the lens 31 is determined similarly to that of the first embodiment. In other words, the magnification ratio 13r of each of the lenses 31 is determined based on the distance between the eyeball position 80e and the principal plane (the rear principal plane) of each of the lenses 31 on the viewer 80 side, the distance between the display unit 20 and the principal point (the front principal point) of each of the lenses 31 on the display unit 20 side, and the focal length f1 of each of the lenses 31.

The magnification ratio determination unit 13a refers to the magnification ratios 13r of the storage regions 35a corresponding to the lens identification values 31r from the magnification ratio LUT 35 and the lens identification values 31r corresponding to the pixels 21 calculated by the center coordinate calculator 12.

Thus, the magnification ratio calculator 13 calculates the magnification ratio 13r corresponding to the lens 31 corresponding to each of the pixels 21 from the lens identification value 31r corresponding to each of the pixels 21 calculated by the center coordinate calculator 12. The magnification ratio 13r that corresponds to each of the lenses 31 is determined from the distance between the eyeball position 80e and the principal plane (the rear principal plane) of each of the lenses 31 on the viewer 80 side, the distance between the display unit 20 and the principal point (the front principal point) of each of the lenses 31 on the display unit 20 side, and the focal length f1 of each of the lenses 31.

### Third Embodiment

The image input unit 41, the image converter 10, the display unit 20, the lens unit 30, etc., are provided in an image display device 103 according to a third embodiment as well.

The center coordinate calculator 12 of the image display device 103 is different from the center coordinate calculator 12 of the image display devices 100 and 102. The center coordinate calculator 12 of the image display device 103 calculates the center coordinates 12cd corresponding to each of the lenses 31 based on the coordinates of the nodal point of each of the lenses 31 on the lens unit 30, the distance between the eyeball position 80e and the principal plane (the rear principal plane) of the lens 31 on the viewer 80 side, and the distance between the display unit 20 and the principal point (the front principal point) of the lens 31 on the display unit 20 side.

FIG. 17 is a schematic view illustrating the image display device according to the third embodiment.

FIG. 17 shows the center coordinate calculator 12 of the image display device 103 according to the third embodiment.

As shown in FIG. 17, the center coordinate calculator 12 of the image display device 103 includes the corresponding lens determination unit 12a, a nodal point coordinate determination unit 12c, and a panel intersection calculator 12d.

The corresponding lens determination unit 12a determines the lens 31 corresponding to each of the pixels 21 from the display coordinates 11cd of each of the pixels 21. Further, the corresponding lens determination unit 12a calculates the lens identification value 31r of the lens 31. A description similar to the descriptions of the image display devices 100 and 102 is applicable to the corresponding lens determination unit 12a of the image display device 103.

The nodal point coordinate determination unit 12c refers to a nodal point coordinate LUT 36. The nodal point coordinate LUT 36 is a lookup table in which the coordinates of the nodal points 32b corresponding to the lenses 31 on the lens unit 30 are pre-recorded. Thereby, the nodal point coordinate determination unit 12c calculates the coordinates (nodal point coordinates 32cd) of the nodal points 32b corresponding to the lenses 31 on the lens unit 30.

Storage regions 36a corresponding to the lenses 31 (the lens identification values 31r) are multiply disposed in the nodal point coordinate LUT 36.

For example, N lenses 31 are arranged in the horizontal direction; and M lenses 31 are arranged in the vertical direction. In such a case, W storage regions 36a in the horizontal direction and H storage regions 36a in the vertical direction corresponding to the lenses 31 (the lens identification values 31r) are disposed in the nodal point coordinate LUT 36. The nodal point coordinates 32cd of the lenses 31 corresponding to the storage regions 36a are recorded in the storage regions 36a of the nodal point coordinate LUT 36.

The nodal point coordinate determination unit 12c refers to the nodal point coordinates 32cd of the nodal points 32b corresponding to the lenses 31 on the lens unit 30 recorded in the storage regions 36a corresponding to the lens identification values 31r from the nodal point coordinate LUT 36 and the lens identification values 31r calculated by the corresponding lens determination unit 12a.

The panel intersection calculator 12d calculates the center coordinates 12cd. The center coordinates 12cd are calculated from the distance between the eyeball position 80e and the principal plane (the rear principal plane) of the lens 31 on the viewer 80 side, the distance between the display unit 20 and the principal point 32a (the front principal point) of the lens 31 on the display unit 20 side, and the nodal point coordinates 32cd of the nodal points 32b corresponding to each of the lenses 31 on the lens unit 30 calculated by the nodal point coordinate determination unit 12c. The center coordinates 12cd are the coordinates on the display unit 20 of the intersection (the first intersection 21i) where the virtual light ray from the eyeball position 80e toward the nodal point 32b (the rear nodal point) intersects the display surface 21p of the display unit 20.

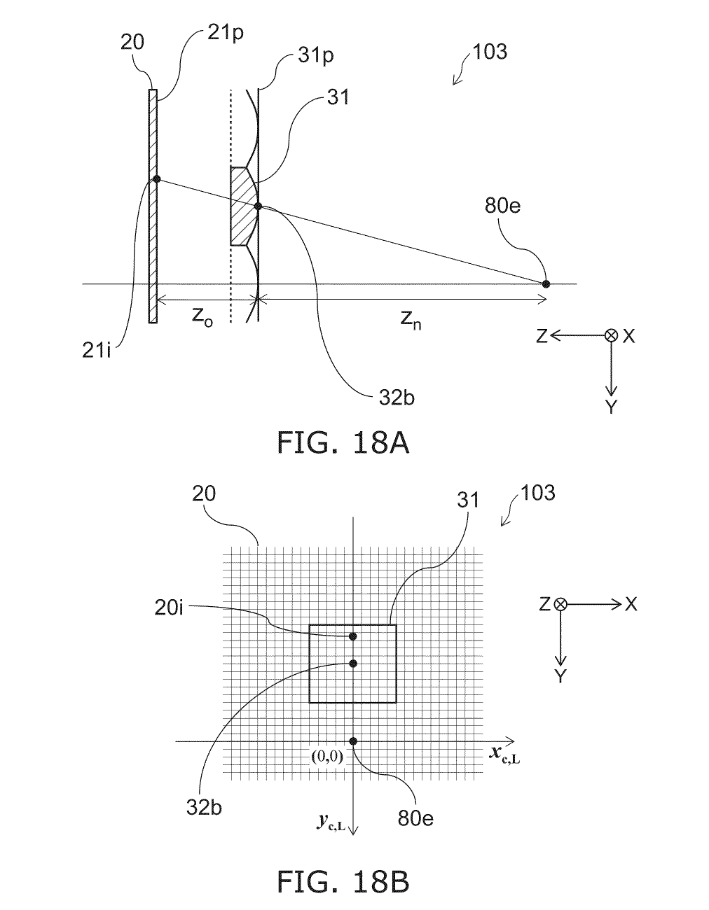

FIG. 18A and FIG. 18B are schematic cross-sectional views illustrating the image display device according to the third embodiment.

FIG. 18A is a cross-sectional view of a portion of the display unit 20 and a portion of the lens unit 30. FIG. 18B is a perspective plan view of the portion of the display unit 20 and the portion of the lens unit 30.

FIG. 18A and FIG. 18B show the correspondence between the lens 31, the nodal point 32b, and the center coordinates 12cd of the image display device 103.

For example, the distance zₙ is the distance between the eyeball position 80e and the principal plane (the rear principal plane, i.e., the third surface 31p) of the lens on the viewer 80 side. For example, the distance zₒ is the distance between the display unit 20 and the principal point 32a (the front principal point) of the lens 31 on the display unit 20 side. For example, the coordinates on the lens unit 30 of the nodal point 32b of each of the lenses 31 calculated by the nodal point coordinate determination unit 12c are (x_{c,L}, y_{c,L}). For example, the center coordinates 12cd are (x_{c}, y_{c}). In such a case, the panel intersection calculator 12d calculates the center coordinates (x_{c}, y_{c}) by the following formula.

(x_{c},y_{c})=(x_{c,L},y_{c,L})×(zₙ+zₒ)/zₙ

Thus, in the third embodiment, the center coordinate calculator 12 calculates the center coordinates 12cd corresponding to the lens 31 corresponding to each of the pixels 21 from the display coordinates 11cd of each of the pixels 21 generated by the display coordinate generator 11.

### Fourth Embodiment

The image input unit 41, the image converter 10, the display unit 20, the lens unit 30, etc., are provided in an image display device 104 according to a fourth embodiment as well.

The center coordinate calculator 12 of the image display device 104 is different from the center coordinate calculators 12 of the image display devices 100, 102, and 103.

The center coordinate calculator 12 of the image display device 104 refers to first lens arrangement information 37. The first lens arrangement information 37 is information of the positional relationship between the eyeball position 80e, the display unit 20, and each of the lenses 31 on the lens unit 30. Thereby, the center coordinate calculator 12 calculates the lens identification value 31r of the lens 31 corresponding to each of the pixels 21.

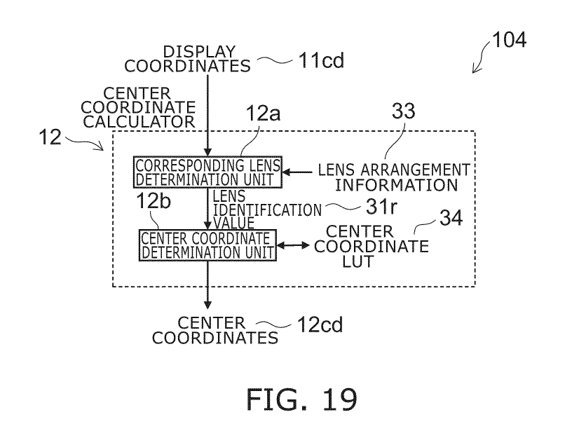

FIG. 19 is a schematic view illustrating the image display device according to the fourth embodiment.

FIG. 19 shows the center coordinate calculator 12 of the image display device 104.

As shown in FIG. 19, the center coordinate calculator 12 of the image display device 104 includes the corresponding lens determination unit 12a and the center coordinate determination unit 12b.

In the center coordinate calculator 12 of the embodiment, the corresponding lens determination unit 12a calculates the lens identification value 31r of the lens 31 corresponding to each of the pixels 21 by referring to the first lens arrangement information 37. For this point, the center coordinate calculator 12 of the image display device 104 is different from the center coordinate calculators 12 of the image display devices 100 to 103.

The corresponding lens determination unit 12a of the image display device 104 refers to the first lens arrangement information 37. Thereby, the corresponding lens determination unit 12a calculates the lens identification value 31r of the lens 31 corresponding to each of the pixels 21. The first lens arrangement information 37 is information including the positional relationship between the eyeball position 80e, the display unit 20, and each of the lenses 31 on the lens unit 30.

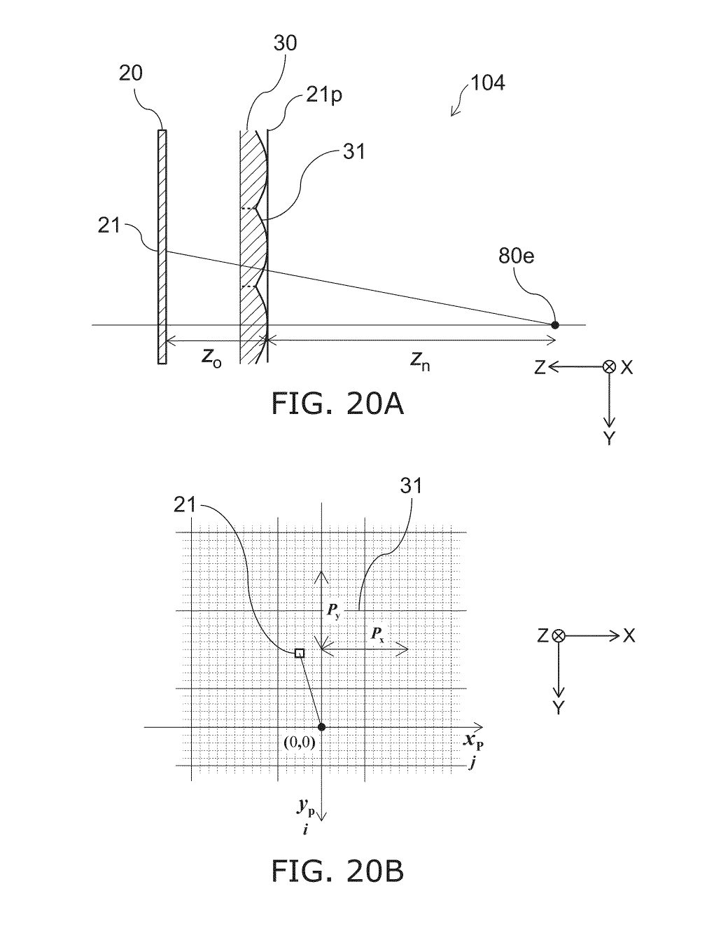

FIG. 20A and FIG. 20B are schematic cross-sectional views illustrating the image display device according to the fourth embodiment.

FIG. 20A is a cross-sectional view of a portion of the display unit 20 and a portion of the lens unit 30. FIG. 20B is a perspective plan view of the portion of the display unit 20 and the portion of the lens unit 30.

As shown in FIG. 20A and FIG. 20B, for example, the multiple lenses 31 of the image display device 104 are arranged in the horizontal direction and the vertical direction on the lens unit 30. In the example, the multiple lenses 31 are disposed so that the distance between the centers is substantially equal in the X-Y plane for the lenses 31 adjacent to each other in the horizontal direction. Also, the multiple lenses 31 are disposed so that the distance between the centers is substantially equal in the X-Y plane for the lenses 31 adjacent to each other in the vertical direction.

In such a case, for example, the first lens arrangement information 37 is a set of values including the distance between the centers in the X-Y plane for the lenses 31 adjacent to each other in the horizontal direction, the distance between the centers in the X-Y plane for the lenses 31 adjacent to each other in the vertical direction, the distance between the eyeball position 80e and the principal plane (the rear principal plane) of the lens 31 on the viewer 80 side, and the distance between the display unit 20 in the principal point (the front principal point) of the lens 31 on the display unit 20 side.

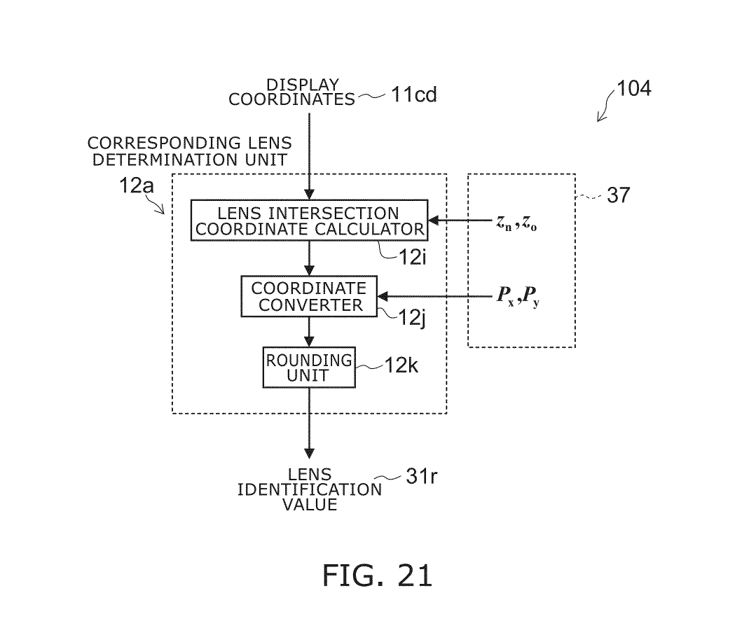

FIG. 21 is a schematic view illustrating the image display device according to the fourth embodiment.

FIG. 21 shows the corresponding lens determination unit 12a of the image display device 104.

As shown in FIG. 21, the corresponding lens determination unit 12a of the image display device 104 includes a lens intersection coordinate calculator 12i, a coordinate converter 12j, and a rounding unit 12k.

The lens intersection coordinate calculator 12i calculates the coordinates (the horizontal coordinate x_{L} and the vertical coordinate y_{L}) of the points where the straight lines connecting the eyeball position 80e and the pixels 21 intersect the lens 31. The horizontal coordinate is, for example, the coordinate of the position along the X-axis direction on the display unit 20. The vertical coordinate is, for example, the coordinate of the position along the Y-axis direction on the display unit 20.

For example, the display coordinates 11cd on the display unit 20 of each of the pixels 21 generated by the display coordinate generator 11 are (xₚ, yₚ). For example, the distance zₙ is the distance between the eyeball position 80e and the principal plane (the rear principal plane) of the lens 31 on the viewer 80 side. For example, the distance zₒ is the distance between the display unit 20 and the principal point (the front principal point) of the lens 31 on the display unit 20 side. The coordinates (the horizontal coordinate x_{L} and the vertical coordinate y_{L}) of the points where the straight lines connecting the eyeball position 80e and the pixels 21 intersect the lens 31 are calculated by the following formula.

(x_{L},y_{L})=(xₚ,yₚ)×zₙ/(zₒ+zₙ)

The coordinate converter 12j divides the horizontal coordinate x_{L} by the distance between the centers in the X-Y plane for the lenses 31 adjacent to each other in the horizontal direction. The coordinate converter 12j divides the vertical coordinate y_{L} by the distance between the centers in the X-Y plane for the lenses 31 adjacent to each other in the vertical direction. Thereby, the horizontal coordinate x_{L} and the vertical coordinate y_{L} are converted into coordinates of the lens corresponding to the disposition of the lens 31 on the lens unit 30.

For example, a distance Pₓ is the distance (the spacing) between the centers in the X-Y plane of the lenses 31 adjacent to each other in the horizontal direction. For example, a distance P_{y} is the distance (the spacing) between the centers in the X-Y plane of the lenses 31 adjacent to each other in the vertical direction. In such a case, the coordinates (j′, i′) of the lens corresponding to the disposition of the lens 31 on the lens unit 30 are calculated by the following formula.

(j′,i′)=*x_{L}/Pₓ,y_{L}/P_{y})

The rounding unit 12k rounds to the nearest whole number the calculated coordinates of the lenses 31. For example, due to the rounding to the nearest whole number, the coordinates of the lenses are integers. Thus, for example, the value of (j′, i′) rounded to the nearest whole number is calculated as the lens identification value 31r.

Thus, the corresponding lens determination unit 12a of the image display device 104 refers to the first lens arrangement information 37. The first lens arrangement information 37 is information of the positional relationship between the eyeball position 80e, the display unit 20, and each of the lenses 31 on the lens unit 30. The corresponding lens determination unit 12a calculates the lens identification value 31r of the lens 31 (i.e., the lens intersected by the straight lines connecting the eyeball position 80e and each of the pixels 21) corresponding to each of the pixels 21 based on the first lens arrangement information 37 and the display coordinates 11cd of each of the pixels 21.

In the example, the lenses 31 are arranged at uniform spacing in the horizontal direction and the vertical direction on the lens unit 30. However, in the embodiment, the arrangement of the lenses 31 on the lens unit 30 is not limited to the arrangement shown in the example.

For example, the arrangement of the lenses 31 on the lens unit 30 is set to be an arrangement in which a pattern that is smaller than the lens unit 30 is repeated. For example, the lens identification value 31r can be calculated similarly to the example described above by using the characteristic of the repetition.

As described above, in the embodiment, an eyeball rotation center 80s or a pupil position 80p of the eyeball of the viewer 80 may be used as the eyeball position 80e. The distance (zₙ) between the eyeball position 80e and the principal plane (the rear principal plane) of the lens 31 on the viewer 80 side is dependent on the position of the eyeball rotation center 80s or the position of the pupil position 80p.

For example, the position of the eyeball with respect to the image display device may be predetermined (for each viewer 80) by the holder 42. The distance (zₙ) between the eyeball position 80e and the principal plane (the rear principal plane) of the lens 31 on the viewer 80 side can be calculated according to the predetermined eyeball position 80e. Based on the distance that is calculated, the lens 31 corresponding to each of the pixels 21 is determined; and the display of the display unit 20 is performed.

In the embodiment, the eyeball position 80e may be modified in the operation of the image display device. For example, the imaging unit 43 images the eyeball of the viewer 80. Thereby, the pupil position 80p of the viewer 80 can be sensed. The distance (zₙ) between the pupil position 80p and the principal plane (the rear principal plane) of the lens 31 on the viewer 80 side can be calculated in the operation of the image display device. For example, in the operation of the image display device, the lens 31 corresponding to each of the pixels 21 is determined according to the pupil position 80p sensed by the imaging unit 43. Thereby, the quality of the image that is displayed can be improved.

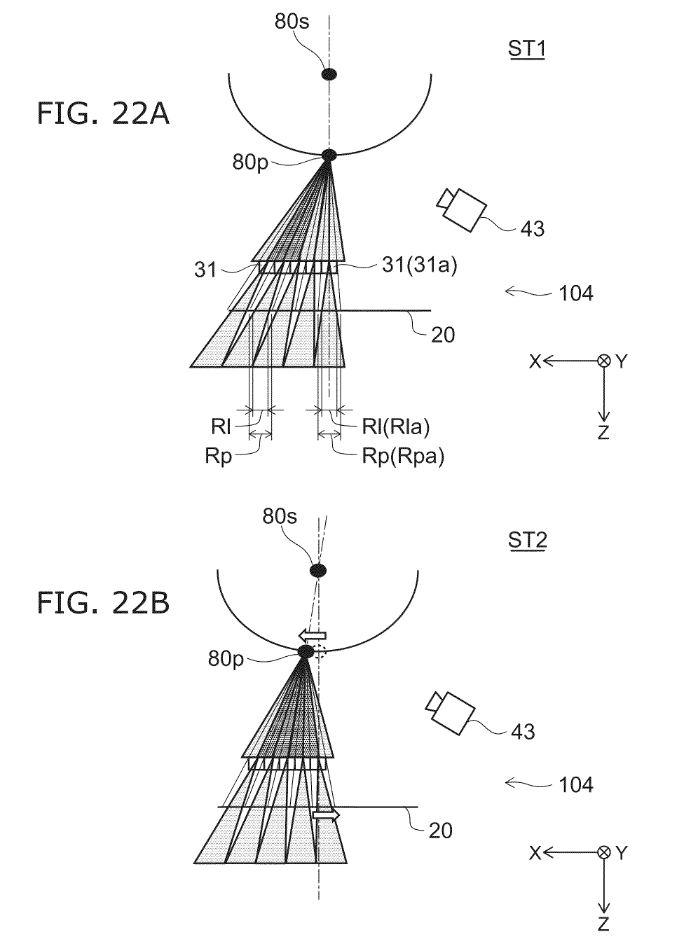

FIG. 22A and FIG. 22B are schematic views illustrating the image display device according to the fourth embodiment.

FIG. 22A and FIG. 22B shows an operation of the image display device 104. FIG. 22A shows a state (a first state ST1) in which the viewer 80 is viewing a direction (e.g., the front). FIG. 22B shows a state (a second state ST2) in which the viewer 80 views a direction different from the first state ST1.

As shown in FIG. 22A, for example, one display region Rp (a display region Rpa) on the display unit 20 corresponding to one lens 31 (e.g., the first lens 31a) is determined. The viewer 80 views the image displayed on the display unit 20 through the lens 31. At this time, a viewing region RI (RIa) that the viewer 80 views through the lens 31 (the first lens 31a) is different from the display region Rp (the display region Rpa). For example, the viewing region RI is smaller than the display region Rp.

As shown in FIG. 22B, for example, the pupil position 80p changes when the viewer 80 modifies the line of sight.

For example, when a predetermined pupil position 80p is used in the second state ST2, there are cases where the display region Rp that corresponds to an adjacent lens 31 is viewed by the viewer 80 due to the difference between the viewing region RI and the display region Rp. For example, there are cases where the display region Rp that is adjacent to the display region Rpa is undesirably viewed by the viewer 80 through the first lens 31a. There are cases where such crosstalk occurs and the quality of the image viewed by the viewer 80 undesirably degrades.

Conversely, for example, the lens 31 corresponding to each of the pixels 21 is determined based on the pupil position 80p sensed by the imaging unit 43. In other words, the display regions Rp that correspond to the lenses 31 are determined based on the pupil position 80p that is sensed. Thereby, the occurrence of the crosstalk can be suppressed.

Even when the line of sight of the viewer 80 changes and the positional relationship between the pupil position 80p and the principal plane (the rear principal plane) of the lens 31 on the viewer 80 side changes, the display region Rp can be changed according to the change of the positional relationship (pupil tracking).

Thus, in the operation of the image display device, a higher-quality image can be obtained by changing the display region Rp according to the change of the line of sight of the viewer 80.

In the embodiment, the display operation may be performed by calculating the center coordinates 12cd or the magnification ratio 13r based on the pupil position 80p sensed by the imaging unit 43.

Such pupil tracking may be used in the image display devices of the other embodiments as well. By using the pupil tracking using the imaging unit 43, the occurrence of the crosstalk can be suppressed.

### Fifth Embodiment

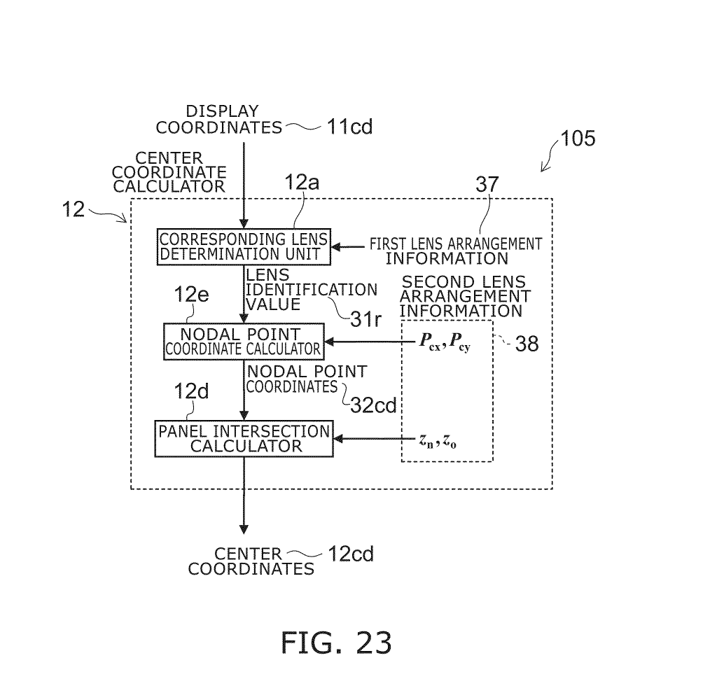

FIG. 23 is a schematic view illustrating an image display device according to a fifth embodiment.

FIG. 23 shows the center coordinate calculator 12 of the image display device 105 according to the fifth embodiment.

The image input unit 41, the image converter 10, the display unit 20, the lens unit 30, etc., are provided in the image display device 105 as well. The center coordinate calculator 12 of the image display device 105 is different from the center coordinate calculators of the image display devices 100 and 101 to 104.

The center coordinate calculator 12 of the image display device 105 refers to second lens arrangement information 38. The second lens arrangement information 38 is information including the positional relationship between the eyeball position 80e, the display unit 20, and the nodal point 32b of each of the lenses 31. Thereby, the center coordinate calculator 12 calculates the center coordinates 12cd corresponding to each of the lenses 31.

As shown in FIG. 23, the center coordinate calculator 12 of the image display device 105 includes the corresponding lens determination unit 12a, a nodal point coordinate calculator 12e, and the panel intersection calculator 12d.

The center coordinate calculator 12 of the image display device 105 refers to the second lens arrangement information 38. The second lens arrangement information 38 is information including the positional relationship between the eyeball position 80e, the display unit 20, and the nodal point 32b of each of the lenses 31 on the lens unit 30. Thereby, the center coordinate calculator 12 calculates the center coordinates 12cd corresponding to the lens 31 corresponding to each of the pixels 21.

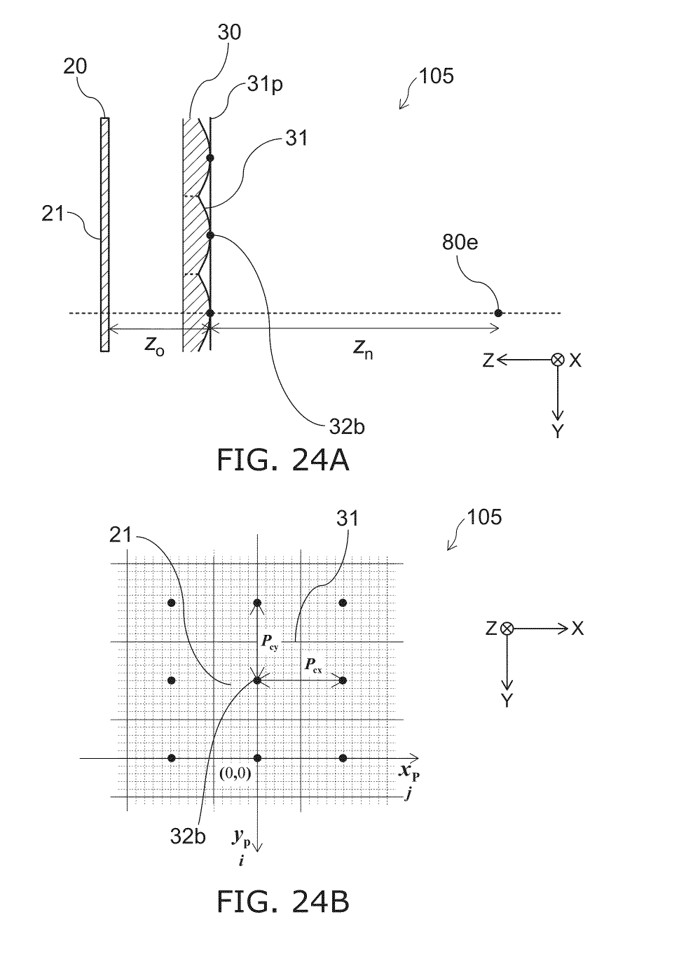

FIG. 24A and FIG. 24B are schematic cross-sectional views illustrating the image display device according to the fifth embodiment.

FIG. 24A is a cross-sectional view of a portion of the display unit 20 and a portion of the lens unit 30. FIG. 24B is a perspective plan view of the portion of the display unit 20 and the portion of the lens unit 30.

FIG. 24A and FIG. 24B show the positional relationship between the pixels 21, the nodal points 32b of the lenses 31, and the eyeball position 80e of the image display device 105.

For example, the multiple lenses 31 are arranged in the horizontal direction and the vertical direction on the lens unit 30. In the example, the multiple lenses 31 are disposed so that the distance between the centers is substantially equal in the X-Y plane for the lenses 31 adjacent to each other in the horizontal direction. Also, the multiple lenses 31 are disposed so that the distance between the centers is substantially equal in the X-Y plane for the lenses 31 adjacent to each other in the vertical direction.

In such a case, the second lens arrangement information 38 is a set of values including the distance between the nodal points of the lenses 31 adjacent to each other in the horizontal direction (the spacing in the horizontal direction between the nodal points of the lenses on the lens unit), the distance between the nodal points of the lenses 31 adjacent to each other in the vertical direction (the spacing in the vertical direction between the nodal points of the lenses on the lens unit), the distance between the eyeball position 80e and the principal plane (the rear principal plane) of the lens 31 on the viewer 80 side, and the distance between the display unit 20 and the principal point (the front principal point) of the lens 31 on the display unit 20 side.

Similarly to the corresponding lens determination unit 12a of the image display device 104, the corresponding lens determination unit 12a of the image display device 105 refers to the first lens arrangement information 37. The first lens arrangement information 37 is information of the positional relationship between the eyeball position 80e, the display unit 20, and each of the lenses 31 on the lens unit 30. Thereby, the corresponding lens determination unit 12a calculates the lens identification value 31r of the lens 31 corresponding to each of the pixels 21.

A configuration similar to that of the corresponding lens determination unit 12a of the image display device 104 is applicable to the corresponding lens determination unit 12a of the image display device 105. A configuration similar to that of the corresponding lens determination unit 12a of the image display device 100 is applicable to the corresponding lens determination unit 12a of the image display device 105.

The nodal point coordinate calculator 12e multiplies the horizontal component of the lens identification value 31r calculated by the corresponding lens determination unit 12a by the distance between the nodal points of the lenses 31 adjacent to each other in the horizontal direction. Also, the nodal point coordinate calculator 12e multiplies the vertical component of the lens identification value 31r calculated by the corresponding lens determination unit 12a by the distance between the nodal points of the lenses 31 adjacent to each other in the vertical direction. Thereby, the nodal point coordinate calculator 12e calculates the coordinates on the lens unit 30 of the nodal points 32b corresponding to the lenses 31.

For example, the lens identification value 31r that is calculated by the corresponding lens determination unit 12a is (j, i). For example, a distance P_{cx} is the distance between the nodal points of the lenses 31 adjacent to each other in the horizontal direction. For example, a distance P_{cy} is the distance between the nodal points of the lenses 31 adjacent to each other in the vertical direction. In such a case, the nodal point coordinate calculator 12e calculates the coordinates (x_{c,L}, y_{c,L}) on the lens unit 30 of the nodal points corresponding to the lenses by the following formula.

(x_{c,L},y_{c,L})=(P_{cx}×j,P_{cy}×i)

Similarly to the panel intersection calculator 12d of the image display device 103, the panel intersection calculator 12d of the image display device 105 calculates the center coordinates 12cd. The center coordinates 12cd are calculated from the distance between the eyeball position 80e and the principal plane (the rear principal plane) of the lens 31 on the viewer 80 side, the distance between the display unit 20 and the principal point 32a (the front principal point) of the lens 31 on the display unit 20 side, and the nodal point coordinates 32cd on the lens unit 30 of the nodal point 32b corresponding to each of the lenses 31.

The center coordinates 12cd are the coordinates on the display unit 20 of the intersection where the virtual light ray from the eyeball position 80e toward the nodal point 32b (the rear nodal point) intersects the display surface 21p of the display unit 20.

Thus, a configuration similar to that of the panel intersection calculator 12d of the image display device 103 is applicable to the panel intersection calculator 12d of the image display device 105.

Thus, the center coordinate calculator 12 of the image display device 105 calculates the center coordinates 12cd corresponding to the lens 31 corresponding to each of the pixels 21 from the display coordinates 11cd of each of the pixels 21 generated by the display coordinate generator 11.

In the example, the lenses 31 are arranged at uniform spacing in the horizontal direction and the vertical direction on the lens unit 30. However, in the embodiment, the arrangement of the lenses 31 on the lens unit 30 is not limited to the arrangement shown in the example.

For example, the arrangement of the lenses 31 on the lens unit 30 is set to be an arrangement in which a pattern that is smaller than the lens unit 30 is repeated. For example, the center coordinates 12cd can be calculated similarly to the example described above by using the characteristic of the repetition.

### Sixth Embodiment

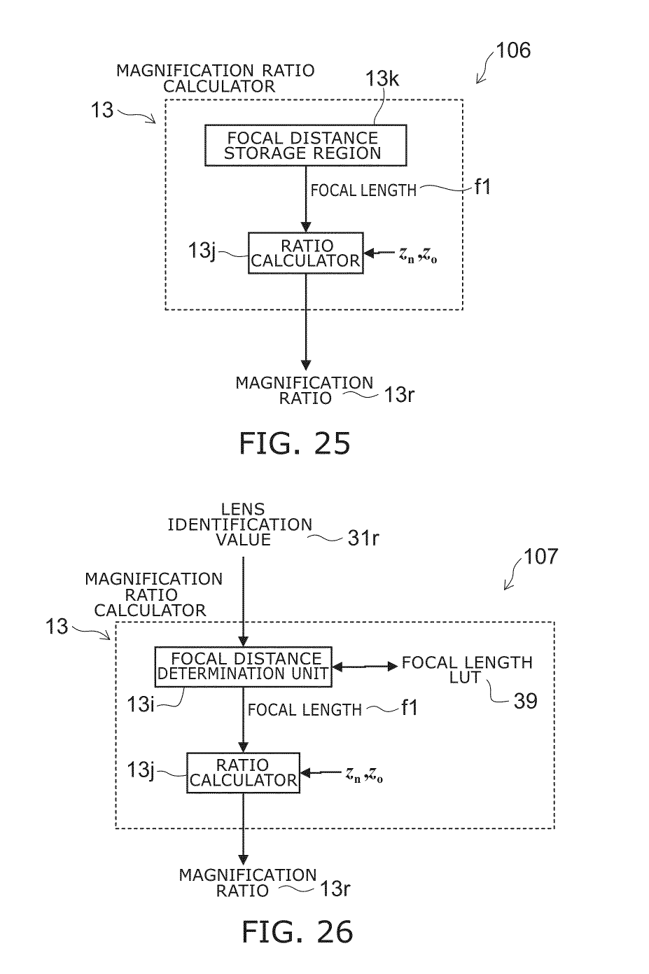

FIG. 25 is a schematic view illustrating an image display device according to a sixth embodiment.

FIG. 25 shows the magnification ratio calculator 13 of the image display device 106 according to the sixth embodiment.

The image input unit 41, the image converter 10, the display unit 20, the lens unit 30, etc., are provided in the image display device 106 as well. The magnification ratio calculator 13 of the image display device 106 is different from the magnification ratio calculators 13 of the image display devices 100 and 101 to 105.

The magnification ratio calculator 13 of the image display device 106 refers to the distance between the eyeball position 80e and the principal plane (the rear principal plane) on the viewer 80 side of the lens 31 corresponding to each of the pixels 21, the distance between the display unit 20 and the principal point (the front principal point) on the display unit 20 side of the lens 31 corresponding to each of the pixels 21, and the focal length f1 of the lens 31 corresponding to each of the pixels 21.

Thereby, the magnification ratio calculator 13 calculates the magnification ratio 13r of the lens 31 corresponding to each of the pixels 21.

The magnification ratio calculator 13 of the image display device 106 calculates the magnification ratio 13r of the lens 31 corresponding to each of the pixels 21 from the distance between the eyeball position 80e and the principal plane (the rear principal plane) on the viewer 80 side of the lens 31 corresponding to each of the pixels 21, the distance between the display unit 20 and the principal point (the front principal point) on the display unit 20 side of the lens 31 corresponding to each of the pixels 21, and the focal length f1 of the lens 31 corresponding to each of the pixels 21.

In the example, the focal length f1 is substantially the same between each of the lenses 31 on the lens unit 30.

As shown in FIG. 25, the magnification ratio calculator 13 of the image display device 106 includes a focal distance storage region 13k and a ratio calculator 13j.

The focal distance storage region 13k is a storage region where the focal lengths f1 corresponding to the lenses 31 on the lens unit 30 are pre-recorded.

The ratio calculator 13j calculates the magnification ratio 13r of the lens from the distance between the eyeball position 80e and the principal plane (the rear principal plane) of the lens 31 on the viewer 80 side, the distance between the display unit 20 and the principal point (the front principal point) of the lens 31 on the display unit 20 side, and the focal length f1 of the lens 31 recorded in the focal distance storage region 13k.

The magnification ratio 13r of the lens is determined from the ratio of the tangent of the second angle ζᵢ to the tangent of the first angle ηₒ.

The first angle ζₒ is the angle between the optical axis 311 of the lens 31 and the straight line connecting the pixel 21 on the display unit 20 and the point on the optical axis 311 away from the third surface 31p toward the eyeball position 80e by the distance zₙ.

The second angle ζᵢ is the angle between the optical axis 311 of the lens 31 and the straight line connecting the virtual image 21v of the pixels 21 viewed by the viewer 80 through the lens 31 and the point on the optical axis 311 away from the third surface 31p toward the eyeball position 80e by the distance zₙ.

For example, the distance zₙ is the distance between the eyeball position 80e and the principal plane (the rear principal plane) of the lens 31 on the viewer 80 side. The distance zₒ is the distance between the display unit 20 and the principal point (the front principal point) of the lens 31 on the display unit 20 side. The focal length f is the focal length f1 of the lens 31 recorded in the focal distance storage region 13k. The magnification ratio M is the magnification ratio 13r of the lens. In such a case, the magnification ratio of the lens is calculated by the ratio calculator 13j so that

M=(zₙ+zₒ)/(zₙ+zₒ−zₙ·zₒ/f).

### Seventh Embodiment

FIG. 26 is a schematic view illustrating an image display device according to a seventh embodiment.

FIG. 26 shows the magnification ratio calculator 13 of the image display device 107 according to the seventh embodiment.

The image input unit 41, the image converter 10, the display unit 20, the lens unit 30, etc., are provided in the image display device 107 as well. The magnification ratio calculator 13 of the image display device 107 is different from the magnification ratio calculators 13 of the image display devices 100 and 101 to 106.

In the example, the focal length f1 is different between each of the lenses 31 on the lens unit 30. The magnification ratio calculator 13 of the image display device 107 refers to the distance between the eyeball position 80e and the principal plane (the rear principal plane) on the viewer 80 side of the lens 31 corresponding to each of the pixels 21, the distance between the display unit 20 and the principal point (the front principal point) on the display unit 20 side of the lens 31 corresponding to each of the pixels 21, and the focal length f1 of the lens 31 corresponding to each of the pixels 21. Thereby, the magnification ratio 13r of the lens 31 corresponding to each of the pixels 21 is calculated.

As shown in FIG. 26, the magnification ratio calculator 13 of the image display device 107 includes a focal distance determination unit 13i and the ratio calculator 13j.

The focal distance determination unit 13i refers to a focal length LUT 39. The focal length LUT 39 is a lookup table in which the focal lengths f1 of the lenses 31 are pre-recorded. Thereby, the focal distance determination unit 13i calculates the focal length f1 of each of the lenses 31.

Storage regions 39a that correspond to the lens identification values 31r are multiply disposed in the focal length LUT 39.

For example, N lenses 31 are arranged in the horizontal direction; and M lenses 31 are arranged in the vertical direction. In such a case, W storage regions 39a in the horizontal direction and H storage regions 39a in the vertical direction corresponding to the lenses 31 (the lens identification values 31r) are disposed in the focal length LUT 39. The focal lengths f1 of the lenses 31 that correspond to the storage regions 39a are recorded in the storage regions 39a of the focal length LUT 39.

The focal distance determination unit 13i refers to the focal lengths f1 of the storage regions 39a corresponding to the lens identification values 31r from the focal length LUT 39 and the lens identification values 31r corresponding to the pixels 21 calculated by the center coordinate calculator 12.

The ratio calculator 13j of the image display device 107 calculates the magnification ratio 13r of the lens from the distance between the eyeball position 80e and the principal plane (the rear principal plane) of the lens 31 on the viewer 80 side, the distance between the display unit 20 and the principal point (the front principal point) of the lens 31 on the display unit 20 side, and the focal length f1 of the lens 31 recorded in the focal distance storage region 13k.

The magnification ratio 13r of the lens is determined from the ratio of the tangent of the second angle ζᵢ to the tangent of the first angle ζₒ.

The first angle ζₒ is the angle between the optical axis 311 of the lens 31 and the straight line connecting the pixel 21 on the display unit 20 and the point on the optical axis 311 away from the third surface 31p toward the eyeball position 80e by the distance zₙ.

The second angle ζᵢ is the angle between the optical axis 311 of the lens 31 and the straight line connecting the virtual image 21v of the pixel 21 viewed by the viewer 80 through the lens 31 and the point on the optical axis 311 away from the third surface 31p toward the eyeball position 80e by the distance zₙ.

A configuration similar to that of the ratio calculator 13j of the image display device 106 is applicable to the ratio calculator 13j of the image display device 107.

Thus, the magnification ratio calculator 13 of the image display device 107 calculates the magnification ratio 13r corresponding to the lens 31 corresponding to each of the pixels 21 from the lens identification value 31r corresponding to each of the pixels 21 calculated by the center coordinate calculator 12.

The magnification ratio 13r is determined from the distance between the eyeball position 80e and the principal plane (the rear principal plane) on the viewer 80 side of the lens 31 corresponding to each of the pixels 21, the distance between the display unit 20 and the principal point (the front principal point) on the display unit 20 side of the lens 31 corresponding to each of the pixels 21, and the focal length f1 of the lens 31 corresponding to each of the pixels 21.

### Eighth Embodiment

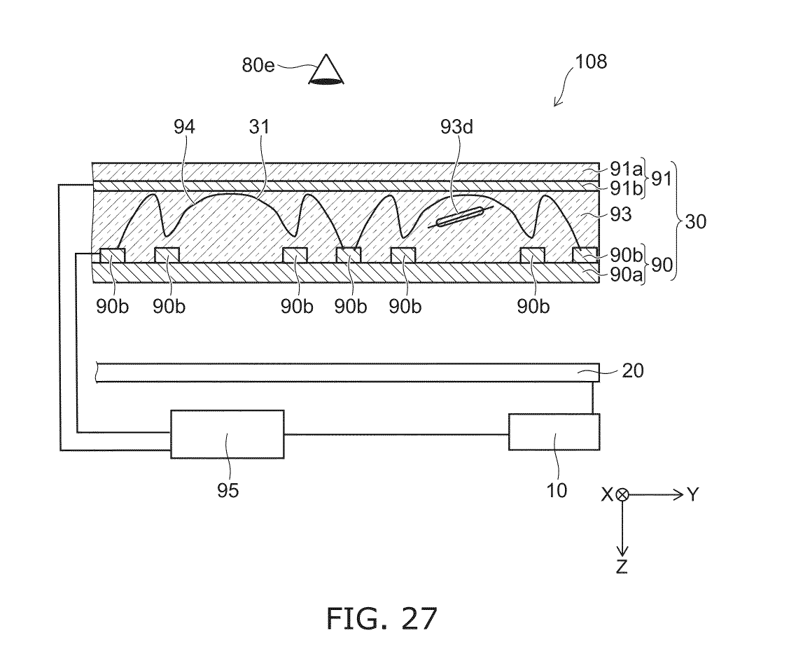

FIG. 27 is a schematic cross-sectional view illustrating an image display device according to an eighth embodiment.

FIG. 27 is a schematic cross-sectional view of a portion of the display unit 20 and a portion of the lens unit 30 of the image display device 108. Otherwise, a configuration similar to the configurations described in regard to the image display devices 100 and 101 to 107 is applicable to the image display device 108.

As shown in FIG. 27, the lens unit 30 of the image display device 108 includes a first substrate unit 90, a second substrate unit 91, and a liquid crystal layer 93. The image display device 108 further includes a drive unit 95.

The liquid crystal layer 93 is disposed between the first substrate unit 90 and the second substrate unit 91. The first substrate unit 90 includes a first substrate 90a and multiple electrodes 90b. The multiple electrodes 90b are provided between the liquid crystal layer 93 and the first substrate 90a. Each of the multiple electrodes 90b is provided on the first substrate 90a and extends, for example, in the X-axis direction. For example, the multiple electrodes 90b are separated from each other in the Y-axis direction.

The second substrate unit 91 includes a second substrate 91a and a counter electrode 91b. The counter electrode 91b is provided between the liquid crystal layer 93 and the second substrate 91a.

The first substrate 90a, the multiple electrodes 90b, the second substrate 91a, and the counter electrode 91b are light-transmissive. The first substrate 90a and the second substrate 91a include, for example, a transparent material such as glass, a resin, etc. The multiple electrodes 90b and the counter electrode 91b include, for example, an oxide including at least one (one type of) element selected from the group consisting of In, Sn, Zn, and Ti. For example, these electrodes include ITO.

The liquid crystal layer 93 includes a liquid crystal material. The liquid crystal molecules that are included in the liquid crystal material have a director 93d (the axis in the long-axis direction of the liquid crystal molecules).

For example, the drive unit 95 is electrically connected to the multiple electrodes 90b and the counter electrode 91b. For example, the drive unit 95 acquires the image information of the display image I2 from the image converter 10. The drive unit 95 appropriately applies voltages to the multiple electrodes 90b and the counter electrode 91b according to the image information that is acquired. Thereby, the liquid crystal alignment of the liquid crystal layer 93 is changed. According to the change, a distribution 94 of the refractive index is formed in the liquid crystal layer 93. The travel direction of the light emitted from the pixels 21 of the display unit 20 is changed by the refractive index distribution 94. At this time, for example, the refractive index distribution 94 performs the role of a lens. The lens unit 30 may include such a liquid crystal GRIN lens (Gradient Index Lens).

The focal length f1, size, configuration, etc., of the lens 31 can be appropriately adjusted by using the liquid crystal GRIN lens as the lens unit 30 and by appropriately applying the voltages to the multiple electrodes 90b and the counter electrode 91b. Thereby, the position where the image is displayed (the position of the virtual image), the size of the image (the size of the virtual image), etc., can be adjusted to match the input image I1 and the viewer 80. Thus, according to the embodiment, a high-quality display can be provided.

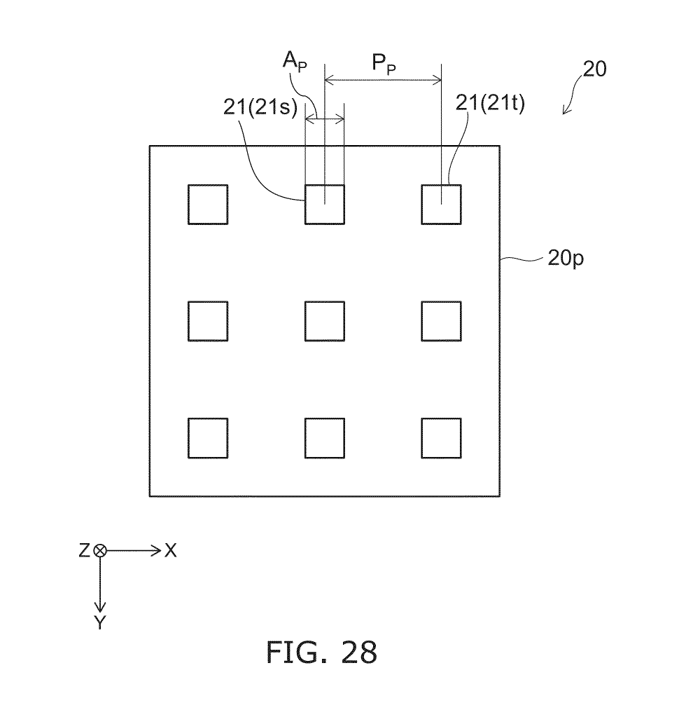

FIG. 28 is a schematic plan view illustrating a portion of the display unit according to the embodiment.

As described above, the multiple pixels 21 are provided in the display units 20 of the image display devices according to the first to eighth embodiments.

The multiple pixels 21 are arranged in one direction (e.g., the X-axis direction) along the first surface 20p. Further, the multiple pixels 21 are arranged in one other direction (e.g., the Y-axis direction) along the first surface 20p. When viewed along the Z-axis direction, the pixel 21 has an area. This area is called the aperture of the pixel 21. The pixel 21 emits light from this aperture. In the example, the multiple pixels 21 are arranged at a constant pitch (spacing) Pp. In the embodiment, the pitch of the pixels 21 may not be constant.

In one direction (hereinbelow, for example, the X-axis direction), a width Ap of the aperture of one pixel 21 is narrower than the pitch Pp of the pixels 21.

In the example shown in FIG. 28, the multiple pixels 21 include a pixel 21s, and a pixel 21t that is most proximal to the pixel 21s. In such a case, the pitch Pp in the X-axis direction is the distance between the center of the pixel 21s in the X-axis direction and the center of the pixel 21t in the X-axis direction. The width Ap in the X-axis direction is the length of the pixel 21 (the length of the aperture) along the X-axis direction.

The ratio of the width Ap to the pitch Pp is an aperture ratio Ap/Pp of the pixel. In the embodiment, it is desirable for the aperture ratio Ap/Pp to be less than 1.

For example, the number of virtual images of the display unit 20 viewed as overlapping in one direction along the first surface 20p is the overlap number of virtual images in the one direction. In the embodiment, it is desirable for the aperture ratio Ap/Pp in the X-axis direction to be less than 1 divided by the overlap number of virtual images in X-axis direction. Also, it is desirable for the aperture ratio of the pixel in the X-axis direction to be less than the pitch of the lenses 31 in the X-axis direction divided by the diameter of the pupil of the viewer 80.

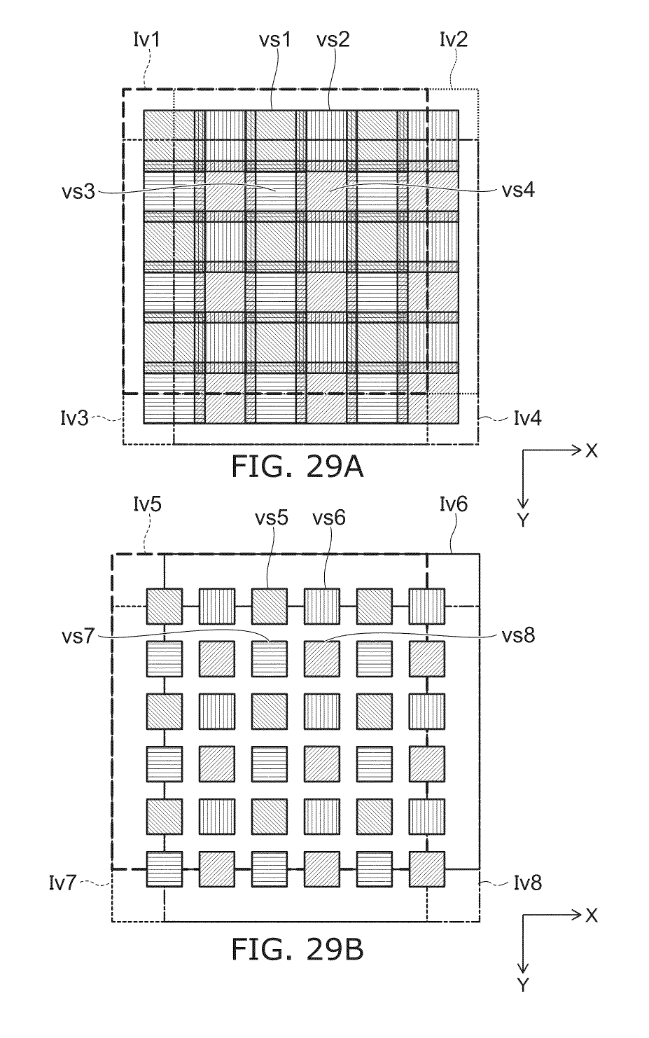

FIG. 29A and FIG. 29B are schematic views illustrating the operation of the image display device.

As apparent in the description described above in regard to FIGS. 13A and 13B, the virtual images of the display unit 20 are viewed by the viewer 80 as multiply overlapping images through the lens unit 30. FIG. 29A and FIG. 29B schematically show some of the virtual images viewed by the viewer 80. FIG. 29A shows the case where the aperture ratio of the pixel is relatively large; and FIG. 29B shows the case where the aperture ratio of the pixel is relatively small.

In FIG. 29A, an image in which virtual images Iv1 to Iv4 overlap is viewed by the viewer 80. In FIG. 29B, an image in which virtual images Iv5 to Iv8 overlap is viewed by the viewer 80.

Each of the virtual images Iv1 to Iv8 is a virtual image of the pixels 21 arranged as in the example of FIG. 28. In the example, each of the virtual images Iv1 to Iv8 includes a virtual image of nine pixels 21. The virtual images Iv1 to Iv8 respectively include virtual images vs1 to vs8 of the pixel 21s shown in FIG. 28.

In FIG. 29A, the virtual images Iv1 to Iv4 overlap while having the positions shifted from each other. The virtual image Iv1 and the virtual image Iv2 overlap while being shifted in the X-axis direction. The position of the virtual image Iv2 is shifted in the X-axis direction with respect to the position of the virtual image Iv1. Similarly, the virtual image Iv3 and the virtual image Iv4 overlap while being shifted in the X-axis direction.

The virtual image Iv1 and the virtual image Iv3 overlap while being shifted in the Y-axis direction. The position of the virtual image Iv3 is shifted in the Y-axis direction with respect to the position of the virtual image Iv1. Similarly, the virtual image Iv2 and the virtual image Iv4 overlap while being shifted in the Y-axis direction.

That is, two virtual images overlap in the X-axis direction; and two virtual images overlap in the Y-axis direction. Similarly, in FIG. 29B as well, two virtual images overlap while being shifted in the X-axis direction. Two virtual images overlap while being shifted in the Y-axis direction.

As shown in FIG. 29A, in the case where the aperture ratio of the pixel is relatively large, the size of the virtual images of the pixels 21 that are viewed is relatively large with respect to the density of the virtual images of the pixels 21 that are viewed. Therefore, the resolution of the virtual images that are viewed is low with respect to the density of the virtual images of the pixels 21 that are viewed.

Conversely, as shown in FIG. 29B, in the case where the aperture ratio of the pixel is relatively small, the decrease of the resolution of the virtual images that are viewed with respect to the density of the virtual images of the pixels 21 that are viewed is suppressed. Thereby, a high-quality image display is possible.

In the example of FIG. 29A and FIG. 29B, the number of virtual images (the overlap number of virtual images) of the display panel viewed as overlapping in the X-axis direction and the Y-axis direction is two in the X-axis direction and two in the Y-axis direction. In such a case, for example, it is desirable for the aperture ratio Ap/Pp of the pixel in the X-axis direction to be 1/2. That is, it is desirable for the aperture ratio of the pixel in one direction to be equal to 1 divided by the overlap number of virtual images in the one direction.

The overlap number of virtual images in one direction may be considered to be equal to the diameter of the pupil of the viewer 80 divided by the pitch of the lenses 31 in the one direction. In such a case, it is desirable for the aperture ratio of the pixel in the one direction to be equal to the pitch of the lenses 31 in the one direction divided by the diameter of the pupil of the viewer 80.

For example, the diameter of the pupil of the viewer 80 is taken to be 4 mm (millimeters) on average. In such a case, it is desirable for the aperture ratio of the pixel in one direction to be the pitch (mm) of the lenses 31 in the one direction divided by 4 (mm).

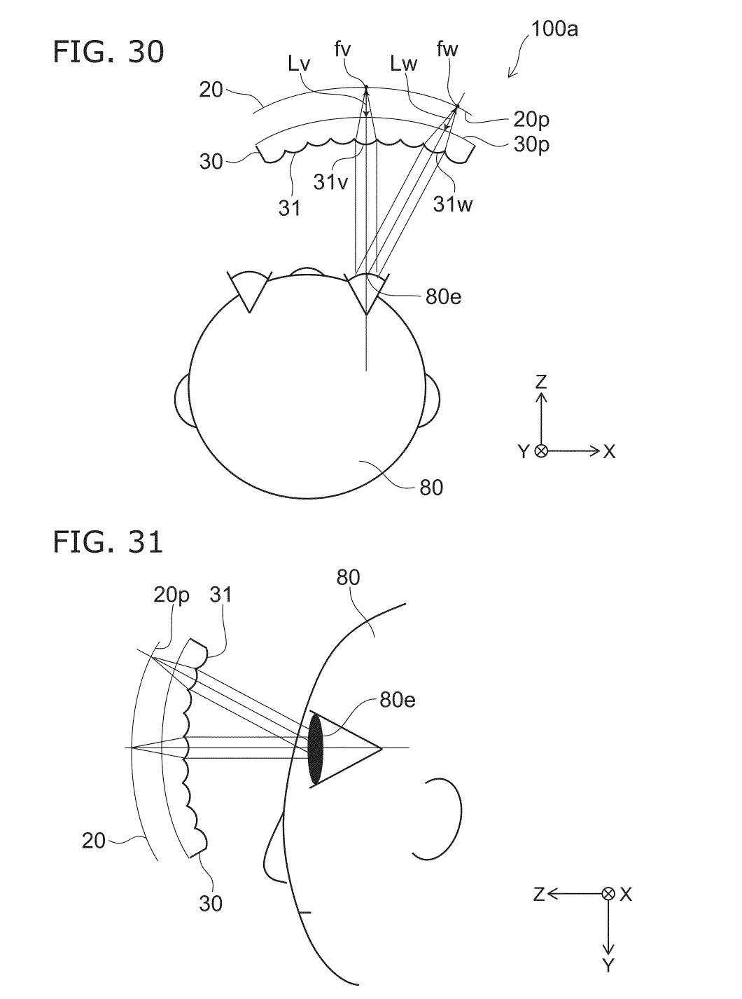

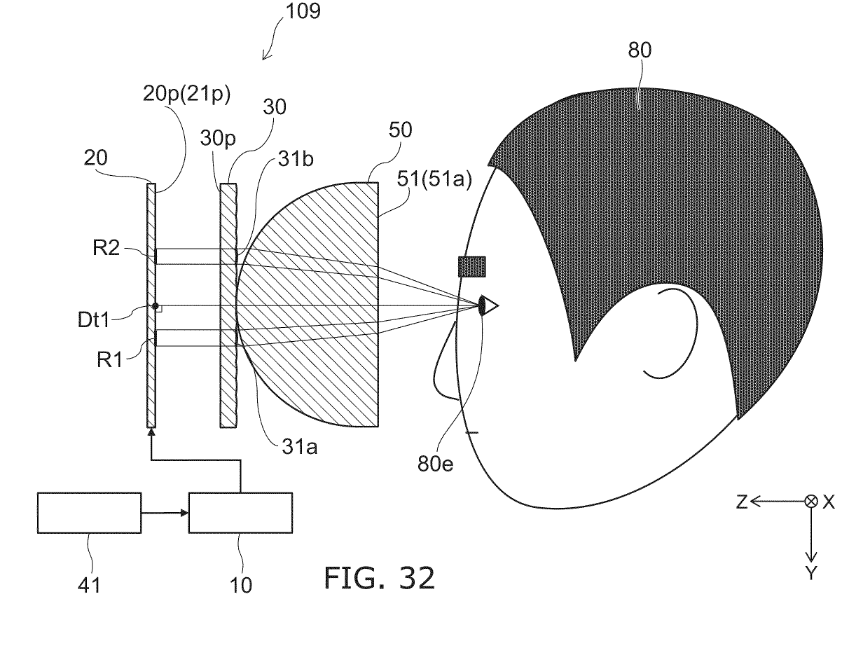

FIG. 30 and FIG. 31 are schematic views illustrating the image display device according to the embodiment.

FIG. 30 and FIG. 31 respectively show image display devices 100a and 100b which are modifications of the first embodiment.

In the image display device 100a shown in FIG. 30, the first surface 20p (the display surface) has a concave configuration as viewed by the viewer 80. The second surface 30p where the multiple lenses 31 are provided has a concave configuration as viewed by the viewer 80.

In the example, the cross sections (the X-Z cross sections) of the first surface 20p and the second surface 30p in the X-Z plane have curved configurations. The second surface 30p where the multiple lenses 31 are provided is provided along the first surface 20p. For example, the center of curvature of the second surface 30p is substantially the same as the center of curvature of the first surface 20p.

For example, the multiple lenses 31 include a lens 31v and a lens 31w. The lens 31v is provided at the central portion of the lens unit 30; and the lens 31w is provided at the outer portion of the lens unit 30.

The lens 31v and the lens 31w respectively have focal points fv and fw as viewed by the viewer 80. The distance between the focal point fv and the lens unit 30 is a distance Lv; and the distance between the focal point fw and the lens unit 30 is a distance Lw.

As described above, the first surface 20p and the second surface 30p have curvatures. Thereby, the difference between the distance Lv and the distance Lw can be reduced. For example, the distance Lv and the distance Lw are substantially equal.

The distance from the viewer 80 to the virtual image is dependent on the ratio of the distance between the lens unit 30 and the display unit 20 to the distance between the lens unit 30 and the focal point. By setting the difference between the distance Lv and the distance Lw to be small, the change in the distance from the viewer 80 to the virtual image viewed by the viewer 80 can be reduced within the display angle of view Accordingly, according to the image display device 100a, a high-quality display having a wide angle of view can be provided.

In the image display device 100b shown in FIG. 31 as well, the first surface 20p and the second surface 30p have concave configurations as viewed by the viewer 80. In the example, the cross sections (the Y-Z cross sections) of the first surface 20p and the second surface 30p in the Y-Z plane have curved configurations. Otherwise, a description similar to that of the image display device 100a is applicable to the image display device 100b. In the image display device 100b as well, the change in the distance from the viewer 80 to the virtual image viewed by the viewer 80 can be reduced within the display angle of view.

In the image display device 100a shown in FIG. 30, the first surface 20p is bent in the X-axis direction. Thereby, a high-quality display can be obtained in the X-axis direction.

In the image display device 100b shown in FIG. 31, the first surface 20p is bent in the Y-axis direction. Thereby, a high-quality display can be obtained in the Y-axis direction.

In the embodiment, the first surface 20p and the second surface 30p may have curved configurations in both the X-Z cross section and the Y-Z cross section. For example, the first surface 20p and the second surface 30p may have spherical configurations. Thereby, a high-quality display can be obtained even in the X-axis direction and even in the Y-axis direction.

For example, the first surface 20p of the image display device 100a has a curved configuration in the X-Z cross section and a straight line configuration in the Y-Z cross section. In such a case, as described above, a high-quality display can be obtained in the X-axis direction. However, in the Y-axis direction, the display may be difficult to view compared to the image display device 100b. In such a case, an easily-viewable display can be obtained even in the Y-axis direction by providing a second lens unit described below.

### Ninth Embodiment

FIG. 32 is a schematic view illustrating an image display device according to a ninth embodiment. The image input unit 41, the image converter 10, the display unit 20, the lens unit 30 (hereinbelow, the first lens unit 30), etc., are provided in the image display device 109 according to the embodiment as well. The image display device 109 according to the embodiment further includes a second lens unit 50.

The second lens unit 50 includes at least one lens (an optical lens 51). In the example, the second lens unit 50 includes a first optical lens 51a. The second surface 30p is provided between the first optical lens 51a and the first surface 20p. The optical lens 51 that is included in the second lens unit 50 is provided to overlap the multiple lenses 31 as viewed along the Z-axis direction or as viewed by the viewer 80.

It is desirable for the second lens unit 50 to have the characteristic of condensing the light that is emitted from the pixels 21 when the light passes through the second lens unit 50.

It is favorable for the optical axis of the second lens unit 50 to be provided to match the line-of-sight direction of the viewer 80 (the direction from the eyeball position 80e toward the first lens unit 30). The optical axis of the second lens unit 50 may not intersect the center of the display unit 20 on the first surface 20p.

In the example, the first surface 20p and the second surface 30p are planes. However, as described above, the first surface 20p and the second surface 30p may be curved surfaces.

Other than a spherical lens or an aspherical lens, the first optical lens 51a may be a decentered lens or a cylindrical lens. For example, in the case where the first surface 20p is bent in the X-axis direction but not bent in the Y-axis direction as in the image display device 100a of FIG. 30, a cylindrical lens having refractive power in the Y-axis direction may be used.

The second lens unit 50 (the first optical lens 51a) may be disposed on the first surface 20p side of the second surface 30p. In other words, the second lens unit 50 may be provided between the first surface 20p and the second surface 30p.

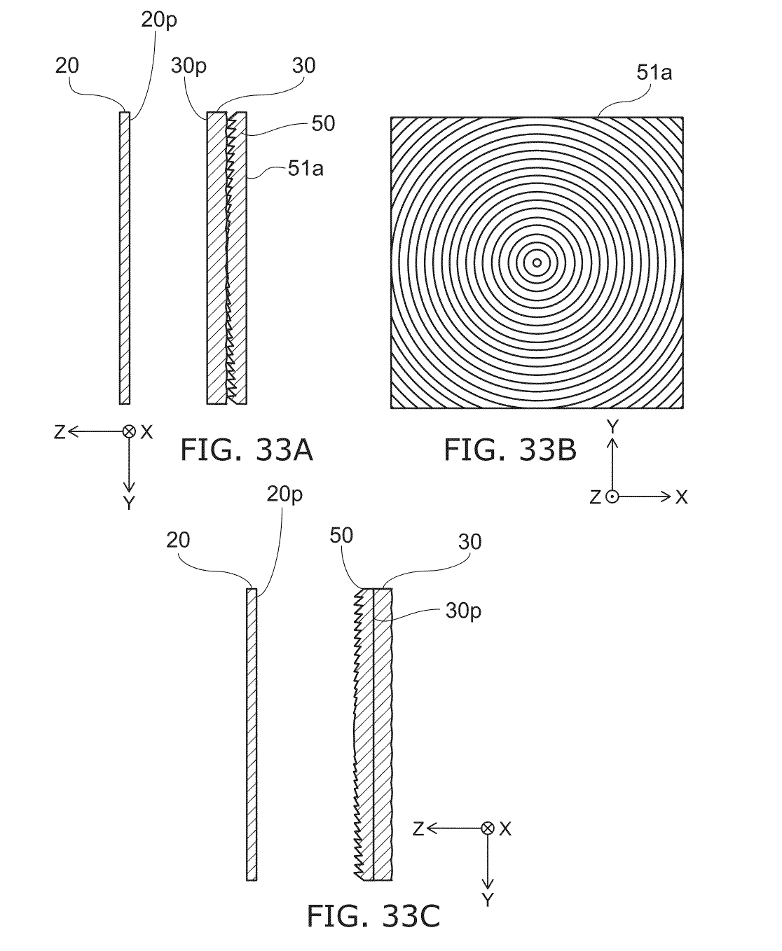

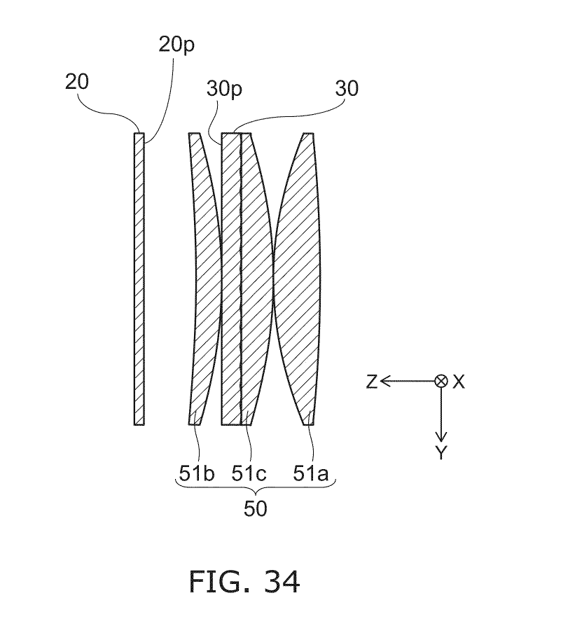

FIG. 33A to FIG. 33C and FIG. 34 are schematic views illustrating portions of other image display devices according to the ninth embodiment. These drawings show modifications of the second lens unit 50 shown in FIG. 32.

FIG. 33A is a schematic cross-section of the display unit 20, the first lens unit 30, and the second lens unit 50. As shown in FIG. 33A, the second lens unit 50 may include a Fresnel lens (a lens that is subdivided into multiple regions to have a cross section having a decreased thickness and a saw configuration). Thereby, the thickness of the second lens unit 50 can be reduced.

FIG. 33B is a schematic plan view of the Fresnel lens shown in FIG. 33A. In the example, the first optical lens 51a has an uneven shape having a concentric circular configuration. However, the Fresnel lens that is used in the embodiment may not have a concentric circular configuration. For example, a Fresnel lens of cylindrical lenses may be used.

FIG. 33C is a schematic cross-sectional view showing a portion of an image display device different from those of FIG. 33A and FIG. 33B. As shown in FIG. 33C, the second lens unit 50 may be one portion of one member in which the second lens unit 50 and the first lens unit 30 are formed as a single body. The first lens unit 30 is another portion of the member.

FIG. 34 is a schematic cross-sectional view illustrating a portion of another image display device. As shown in FIG. 34, the second lens unit 50 may include multiple optical lenses overlapping each other in the direction from the first surface 20p toward the second surface 30p.

The second lens unit 50 may include a lens (a second optical lens 51b) that is disposed on the first surface 20p side of the second surface 30p, and a lens (the first optical lens 51a) that is disposed on the side of the second surface 30p opposite to the first surface 20p. The second lens unit 50 includes at least one of the first optical lens 51a or the second optical lens 51b. The second surface 30p is provided between the first optical lens 51a and the first surface 20p. The second optical lens 51b is provided between the first surface 20p and the second surface 30p.

By providing such a second lens unit, the change in the distance from the viewer 80 to the virtual image viewed by the viewer 80 can be reduced within the display angle of view. Thereby, a high-quality display having a wide angle of view can be provided.

Similarly to the image converters 10 of the first embodiment to the eighth embodiment, the image converter 10 of the image display device 109 according to the embodiment converts the input image I1 input by the image input unit 41 into the display image I2 to be displayed by the display unit 20.

Similarly to the image converters 10 of the first embodiment to the eighth embodiment, the image converter 10 of the image display device 109 according to the embodiment includes the display coordinate generator 11, the center coordinate calculator 12, the magnification ratio calculator 13, and the image reduction unit 14.

Similarly to the display coordinate generators of the first embodiment to the eighth embodiment, the display coordinate generator 11 according to the embodiment generates the display coordinates 11cd for each of the multiple pixels 21 on the display unit 20.

The center coordinate calculator 12 according to the embodiment calculates the center coordinates 12cd of the lens 31 corresponding to each of the pixels 21 from the display coordinates 11cd of each of the pixels 21 generated by the display coordinate generator 11.

The center coordinates 12cd according to the embodiment are determined from the focal length of the second lens unit 50 and the positional relationship between the nodal point of the lens 31 corresponding to each of the pixels 21, the eyeball position (the point corresponding to the eyeball position of the viewer), the display unit 20, and the second lens unit 50.

The magnification ratio calculator 13 according to the embodiment calculates a first magnification ratio 13s corresponding to each of the pixels 21. Here, each of the first magnification ratios 13s is the ratio of the magnification ratio of a compound lens 55 of the second lens unit 50 and the lens 31 corresponding to each of the pixels 21 to the magnification ratio of the second lens unit 50 in the case where the optical effect of the first lens unit 30 is ignored.

The first magnification ratio 13s is determined from the distance between the eyeball position and the principal plane of one compound lens 55 (a fifth surface 50p (a second major surface) passing through the principal point of the compound lens 55), the distance between the display unit 20 and the principal point of the one compound lens 55, the focal length of the one compound lens 55, the distance between the eyeball position and the principal plane of the second lens unit 50 (a fourth surface 40p (a first major surface) passing through the principal point of the second lens unit 50), the distance between the display unit 20 and the principal point of the second lens unit 50, and the focal length of the second lens unit 50.

Similarly to the image reduction units 14 of the first embodiment to the eighth embodiment, the image reduction unit 14 according to the embodiment reduces the input image I1 by the proportion of the reciprocal of each of the first magnification ratios 13s using the center coordinates 12cd corresponding to each of the lenses 31 as the center. The display coordinates 11cd of each of the pixels 21 generated by the display coordinate generator 11, the center coordinates 12cd corresponding to the lens 31 corresponding to each of the pixels 21 calculated by the center coordinate calculator 12, and each of the first magnification ratios 13s calculated by the magnification ratio calculator 13 are used to reduce the input image I1.

In the case where the second lens unit 50 includes one optical lens, the optical axis, focal length, magnification ratio, principal plane, and principal point of the second lens unit 50 respectively are the optical axis, focal length, magnification ratio, principal plane, and principal point of the one optical lens.

In the case where the second lens unit 50 includes multiple optical lenses, the optical axis, focal length, magnification ratio, principal plane, and principal point of the second lens unit 50 respectively are the optical axis, focal length, magnification ratio, principal plane, and principal point of the compound lens of the multiple optical lenses included in the second lens unit 50.

The image converter 10 according to the embodiment will now be described in detail.

First, the display coordinate generator 11 according to the embodiment may be similar to the display coordinate generator 11 of the first embodiment.

The calculation of the center coordinates according to the embodiment will now be described in detail.

The center coordinate calculator 12 according to the embodiment calculates the center coordinates 12cd corresponding to the lens 31 corresponding to each of the pixels 21 from the display coordinates 11cd of each of the pixels 21. The center coordinates 12cd according to the embodiment are determined from the focal length of the second lens unit 50 and the positional relationship between the nodal point of the lens 31 corresponding to each of the pixels 21, the eyeball position 80e (the point corresponding to the eyeball position of the viewer 80), the display unit 20, and the second lens unit 50.

According to the embodiment, the lens 31 corresponding to each of the pixels 21 is the lens 31 intersected by the light rays connecting the eyeball position 80e and each of the pixels 21 in the case where the optical effect of the first lens unit 30 is ignored. According to the embodiment, the lens 31 corresponding to each of the pixels 21 is based on the focal length of the second lens unit 50 and the positional relationship between the pixels 21, the lenses 31, the eyeball position 80e, and the second lens unit 50.

According to the embodiment, the center coordinates 12cd corresponding to each of the lenses 31 are the coordinates on the display unit 20 of the intersections where the light rays from the eyeball position 80e toward the nodal points of the lenses 31 intersect the display surface 21p of the display unit 20 in the case where the optical effect of the first lens unit 30 is ignored. In such a case, the nodal point of each of the lenses 31 is the nodal point (the rear nodal point) on the viewer 80 side of each of the lenses 31.

Similarly to the center coordinate calculators of the first embodiment to the fifth embodiment, the center coordinate calculator 12 according to the embodiment includes the corresponding lens determination unit 12a.

Similarly to the center coordinate calculators of the first embodiment, the second embodiment, and the fourth embodiment, the center coordinate calculator 12 according to the embodiment includes the center coordinate determination unit 12b. Similarly to the center coordinate calculators of the third embodiment and the fifth embodiment, the center coordinate calculator 12 according to the embodiment may include the panel intersection calculator 12d and the nodal point coordinate determination unit 12c or the nodal point coordinate calculator 12e.

Similarly to the corresponding lens determination units of the first embodiment and the fourth embodiment, the corresponding lens determination unit 12a according to the embodiment calculates the lens identification value 31r of each of the lenses 31 by determining the lens 31 corresponding to each of the pixels 21 from the display coordinates 11cd of each of the pixels 21.

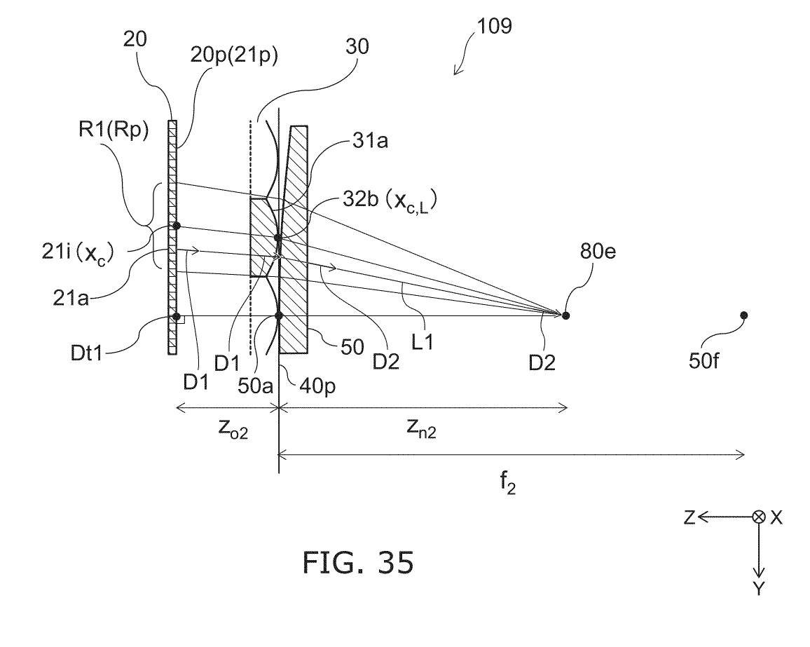

FIG. 35 is a schematic view illustrating the image display device according to the ninth embodiment.

FIG. 35 is a cross-sectional view of a portion of the display unit 20, a portion of the first lens unit 30, and a portion of the second lens unit 50.

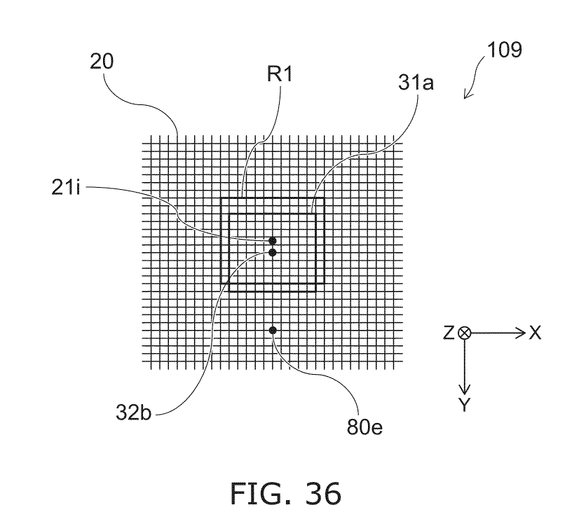

FIG. 36 is a perspective plan view illustrating the portion of the image display device according to the ninth embodiment.

FIG. 36 is a perspective plan view of the portion of the display unit 20, the portion of the first lens unit 30, and the portion of the second lens unit 50.

FIG. 35 and FIG. 36 show the relationship between the display region and the center point of the image display device 109.

As shown in FIG. 35, for example, the light ray that connects the first pixel 21a and the eyeball position 80e intersects the first lens 31a in the case where the optical effect of the first lens unit 30 is ignored. In such a case, the lens 31 that corresponds to the first pixel 21a is the first lens 31a. Thus, the lens 31 corresponding to each of the pixels 21 is determined. Thereby, the display region Rp on the display unit 20 corresponding to one lens 31 is determined. The pixels 21 that are associated with one lens 31 are disposed in one display region Rp. For example, in the case where the optical effect of the first lens unit 30 is ignored, the light rays that pass through the eyeball position 80e and each of the multiple pixels 21 disposed in the display region (the first display region R1) corresponding to the first lens 31a intersect the first lens 31a.

For example, a first light L1 shown in FIG. 35 is a virtual light ray ignoring the optical effect of the first lens unit 30. In other words, the first light L1 is refracted by the second lens unit 50 but not refracted by the first lens 31a. The travel direction of the first light L1 is changed by the second lens unit 50 from the travel direction at the first display region R1 to the travel direction at the eyeball position 80e. The first light L1 passes through the eyeball position 80e and the pixels of the multiple pixels 21 provided in the first display region R1.

For example, the travel direction of the first light L1 that is emitted from the one first pixel 21a and reaches the eyeball position 80e is a first direction D1 at the first display region R1 and is a second direction D2 at the eyeball position 80e. Then, the travel direction of the first light L1 is changed by the second lens unit 50 from the first direction D1 to the second direction D2. Such a first light L1 intersects the first lens 31a of the multiple lenses 31.

In the embodiment, the display region Rp corresponding to each of the lenses 31 may be determined by considering the optical effect of the first lens unit 30 and the optical effect of the second lens unit 50 without ignoring the optical effect of the first lens unit 30.

For example, similarly to the corresponding lens determination unit of the first embodiment, the corresponding lens determination unit 12a according to the embodiment calculates the lens identification value 31r of the lens 31 corresponding to each of the pixels 21 by referring to the lens LUT (lookup table) 33. The lens identification values 31r of the lenses 31 corresponding to the pixels 21 according to the embodiment are pre-recorded in the storage regions 33a corresponding to the pixels 21 of the lens LUT 33 according to the embodiment.

The corresponding lens determination unit 12a according to the embodiment refers to the lens identification value 31r of the storage region 33a corresponding to each of the pixels 21 from the lens LUT 33 and the display coordinates 11cd of each of the pixels 21. Thus, the corresponding lens determination unit 12a according to the embodiment calculates the lens identification value 31r of the lens 31 corresponding to each of the pixels 21 from the lens LUT 33 and the display coordinates 11cd of each of the pixels 21.

Or, similarly to the corresponding lens determination unit of the fourth embodiment, the corresponding lens determination unit 12a according to the embodiment may include the lens intersection coordinate calculator 12i, the coordinate converter 12j, and the rounding unit 12k. In such a case, the lens identification value 31r of the lens 31 corresponding to each of the pixels 21 is calculated by referring to the first lens arrangement information 37. The first lens arrangement information 37 according to the embodiment is information including the focal length of the second lens unit 50 and the positional relationship between each of the lenses 31 on the first lens unit 30, the eyeball position 80e, the display unit 20, and the second lens unit 50.

For example, the multiple lenses 31 on the first lens unit 30 are arranged at uniform spacing in the horizontal direction and the vertical direction. In such a case, the first lens arrangement information 37 according to the embodiment is a set of values including the distance (the spacing) between the centers in the X-Y plane of the lenses 31 adjacent to each other in the horizontal direction, the distance (the spacing) between the centers in the X-Y plane of the lenses 31 adjacent to each other in the vertical direction, the distance between the eyeball position 80e and the principal plane (the rear principal plane, i.e., the fourth surface 40p) of the second lens unit 50 on the viewer 80 side, the distance between the display unit 20 and a principal point 50a (a front principal point) of the second lens unit 50 on the display unit 20 side, and the focal length of the second lens unit 50.

The lens intersection coordinate calculator 12i according to the embodiment calculates the coordinates (the horizontal coordinate x_{L} and the vertical coordinate y_{L}) of the points where the light rays connecting the eyeball position 80e and each of the pixels 21 intersect the lens 31 in the case where the optical effect of the first lens unit 30 is ignored.

For example, the display coordinates 11cd on the display unit 20 of one pixel 21 generated by the display coordinate generator 11 is (xₚ, yₚ). A distance zₙ₂ is the distance between the eyeball position 80e and the principal plane (the rear principal plane, i.e., the fourth surface 40p) of the second lens unit 50 on the viewer side; a distance zₒ₂ is the distance between the display unit 20 and the principal point 50a (the front principal point) of the second lens unit 50 on the display unit 20 side; and a focal length f₂ is the focal length of the second lens unit 50. Here, the second lens unit 50 has a focal point 50f shown in FIG. 35. In such a case, the lens intersection coordinate calculator 12i according to the embodiment calculates the coordinates (the horizontal coordinate x_{L} and the vertical coordinate y_{L}) of the point where the light ray connecting the one pixel 21 and the eyeball position 80e intersects the lens 31 in the case where the optical effect of the first lens unit 30 is ignored by the following formula.

(x_{L},y_{L})=(xₚ,yₚ)×zₙ₂/(zₒ₂+zₙ₂−zₒ₂·zₙ₂/f₂)

The coordinate converter 12j divides the horizontal coordinate x_{L} by the distance between the centers in the X-Y plane of the lenses 31 adjacent to each other in the horizontal direction. The coordinate converter 12j divides the vertical coordinate y_{L} by the distance between the centers in the X-Y plane of the lenses 31 adjacent to each other in the vertical direction. Thereby, the horizontal coordinate x_{L} and the vertical coordinate y_{L} are converted into the coordinates of the lens 31 corresponding to the disposition of the lens 31 on the first lens unit 30.

The rounding unit 12k rounds to the nearest whole number the coordinates of the lens 31 calculated by the coordinate converter 12j as recited above to be integers. In the example, the integers are calculated as the lens identification value 31r.

Thus, the corresponding lens determination unit 12a according to the embodiment may calculate the lens identification value 31r of the lens 31 corresponding to each of the pixels 21.

Although the lenses 31 are arranged at uniform spacing in the horizontal direction and the vertical direction in the first lens unit 30 in the example, the arrangement of the lenses 31 on the first lens unit 30 is not limited to the arrangement shown in the example.

Similarly to the center coordinate determination unit of the first embodiment, the center coordinate determination unit 12b according to the embodiment calculates the center coordinates 12cd corresponding to the lens 31 corresponding to the lens identification value 31r based on the lens identification value 31r calculated by the corresponding lens determination unit 12a.

The center coordinates 12cd that correspond to the lens 31 are the coordinates on the display unit 20 (on the first surface 20p). The center coordinates 12cd are determined from the focal length of the second lens unit 50 and the positional relationship between the nodal point 32b of the lens 31, the eyeball position 80e, the display unit 20, and the second lens unit 50.

The center coordinates 12cd are the coordinates on the display unit 20 (on the first surface 20p) of the intersection where the light ray from the eyeball position 80e toward the nodal point 32b of the lens 31 intersects the display surface 21p of the display unit 20 in the case where the optical effect of the first lens unit 30 is ignored. The nodal point 32b is the nodal point (the rear nodal point) of the lens 31 on the viewer 80 side. The second surface 30p is disposed between the nodal point 32b and the display surface 21p.

For example, the lens 31 (the first lens 31a), the eyeball position 80e, the display unit 20, and the second lens unit 50 are disposed as shown in FIG. 35 and FIG. 36. In such a case, the light ray from the eyeball position 80e toward the nodal point 32b of the first lens 31a intersects the display surface 21p at the first intersection 21i in the case where the optical effect of the first lens unit 30 is ignored. The coordinates on the display unit 20 (on the first surface 20p) of the first intersection 21i are the center coordinates 12cd corresponding to the first lens 31a.

In the example, the nodal point (the rear nodal point) of the lens 31 on the viewer 80 side is extremely proximal to the nodal point (the front nodal point) of the lens 31 on the display unit side. In FIG. 35 and FIG. 36, the nodal points are shown together as the one nodal point 32b. In the case where the nodal point (the rear nodal point) of the lens 31 on the viewer 80 side is extremely proximal to the nodal point (the front nodal point) of the lens 31 on the display unit 20 side, the nodal points may be treated as one nodal point without differentiating. In such a case, the center coordinates 12cd that correspond to the lens 31 are the coordinates on the display unit 20 of the intersection where the virtual light ray from the eyeball position 80e of the viewer 80 toward the nodal point 32b of the lens 31 intersects the display surface 21p in the case where the optical effect of the first lens unit 30 is ignored.

For example, similarly to the center coordinate determination unit of the first embodiment, the center coordinate determination unit 12b according to the embodiment refers to the center coordinate LUT (lookup table) 34. Thereby, the center coordinate determination unit 12b calculates the center coordinates 12cd corresponding to each of the lenses 31. The center coordinates 12cd that correspond to the lenses 31 are pre-recorded in the center coordinate LUT 34.

Similarly to the center coordinate LUT of the first embodiment, the multiple storage regions 34a are disposed in the center coordinate LUT 34 according to the embodiment. The storage regions 34a respectively correspond to the lens identification values 31r. The center coordinates 12cd of the lenses 31 corresponding to the storage regions 34a are recorded in the storage regions 34a.

In such a case, similarly to the center coordinate determination unit of the first embodiment, the center coordinate determination unit 12b according to the embodiment refers to the storage region 34a corresponding to each of the lens identification values 31r from the center coordinate LUT 34 and each of the lens identification values 31r calculated by the corresponding lens determination unit 12a.

Thus, the center coordinate determination unit 12b according to the embodiment calculates the center coordinates 12cd of the lens 31 corresponding to each of the lens identification values 31r from the center coordinate LUT 34 and each of the lens identification values 31r calculated by the corresponding lens determination unit 12a.

Or, similarly to the center coordinate calculators of the third embodiment and the fifth embodiment, the center coordinate calculator 12 according to the embodiment may include the panel intersection calculator 12d and the nodal point coordinate determination unit 12c or the nodal point coordinate calculator 12e. In such a case, unlike the center coordinate calculators of the third embodiment and the fifth embodiment, the center coordinate calculator 12 according to the embodiment calculates the center coordinates 12cd corresponding to each of the lenses 31 based on the coordinates on the first lens unit 30 of the nodal point 32b of each of the lenses 31, the distance between the eyeball position 80e and the principal plane (the rear principal plane, i.e., the fourth surface 40p) of the second lens unit 50 on the viewer 80 side, the distance between the display unit 20 and the principal point 50a (the front principal point) of the second lens unit 50 on the display unit 20 side, and the focal length of the second lens unit 50.

Similarly to the nodal point coordinate determination unit of the third embodiment, the nodal point coordinate determination unit 12c according to the embodiment refers to the nodal point coordinate LUT 36. Similarly to the nodal point coordinate determination unit of the third embodiment, the nodal point coordinate LUT 36 is a lookup table in which the coordinates (the nodal point coordinates 32cd) on the first lens unit 30 of the nodal point 32b corresponding to each of the lenses 31 are pre-recorded.

The multiple storage regions 36a are disposed in the nodal point coordinate LUT 36. The storage regions 36a correspond to the lenses 31 (the lens identification values 31r). The nodal point coordinates 32cd of the lenses 31 corresponding to the storage regions 36a are recorded in the storage regions 36a of the nodal point coordinate LUT 36.

The nodal point coordinate determination unit 12c refers to the storage regions 36a corresponding to each of the lens identification values 31r from the nodal point coordinate LUT 36 and each of the lens identification values 31r calculated by the corresponding lens determination unit 12a.

Thus, the nodal point coordinate determination unit 12c refers to the nodal point coordinates 32cd recorded in each of the storage regions 36a. Thereby, the nodal point coordinate determination unit 12c calculates the coordinates (the nodal point coordinates 32cd) on the first lens unit 30 of the nodal point 32b corresponding to each of the lenses 31.

Similarly to the nodal point coordinate calculator of the fifth embodiment, the nodal point coordinate calculator 12e according to the embodiment multiplies the horizontal component of the lens identification value 31r calculated by the corresponding lens determination unit 12a by the distance between the nodal points of the lenses 31 adjacent to each other in the horizontal direction.

Similarly to the nodal point coordinate calculator 12e of the fifth embodiment, the nodal point coordinate calculator 12e according to the embodiment multiplies the vertical component of the lens identification value 31r calculated by the corresponding lens determination unit 12a by the distance between the nodal points of the lenses 31 adjacent to each other in the vertical direction.

Thereby, the nodal point coordinate calculator 12e calculates the coordinates on the first lens unit 30 of the nodal points 32b corresponding to the lenses 31.

For example, the lens identification value 31r that is calculated by the corresponding lens determination unit 12a is (j, i). For example, the distance P_{cx} is the distance between the nodal points 32b of the lenses 31 adjacent to each other in the horizontal direction. For example, the distance P_{cy} is the distance between the nodal points 32b of the lenses 31 adjacent to each other in the vertical direction. In such a case, the nodal point coordinate calculator 12e calculates the coordinates (x_{c,L}, y_{c,L}) on the first lens unit 30 of the nodal points 32b corresponding to the lenses 31 by the following formula.

(x_{c,L},y_{c,L})=(P_{cx}×j,P_{cy}×i)

Similarly to the panel intersection calculator of the third embodiment, the panel intersection calculator 12d according to the embodiment calculates the center coordinates 12cd. The center coordinates 12cd according to the embodiment are calculated from the nodal point coordinates 32cd calculated by the nodal point coordinate determination unit 12c or the nodal point coordinate calculator 12e, the distance between the eyeball position 80e and the principal plane (the rear principal plane, i.e., the fourth surface 40p) of the second lens unit 50 on the viewer 80 side, the distance between the display unit 20 and the principal point 50a (the front principal point) of the second lens unit 50 on the display unit 20 side, and the focal length of the second lens unit 50. The center coordinates 12cd are the coordinates on the display unit 20 of the intersection (the first intersection 21i) where the virtual light ray from the eyeball position 80e toward the nodal point 32b (the rear nodal point) of the lens 31 intersects the display surface 21p of the display unit 20 in the case where the optical effect of the first lens unit 30 is ignored.

FIG. 35 and FIG. 36 show the correspondence between the lens 31, the nodal point 32b, the second lens unit 50, and the first intersection 21i (the center coordinates 12cd) of the image display device 109 according to the embodiment.

The coordinates on the first lens unit 30 of the nodal point 32b of one lens 31 calculated by the nodal point coordinate determination unit 12c or the nodal point coordinate calculator 12e is (x_{c,L}, y_{c,L}). The distance zₙ₂ is the distance between the eyeball position 80e and the principal plane (the rear principal plane, i.e., the fourth surface 40p) of the second lens unit 50 on the viewer 80 side; the distance zₒ₂ is the distance between the display unit 20 and the principal point 50a (the front principal point) of the second lens unit 50 on the display unit 20 side; and the focal length f₂ is the focal length of the second lens unit 50. In such a case, the center coordinates (x_{c}, y_{c}) are calculated by the panel intersection calculator 12d by the following formula.

(x_{c},y_{c})=(x_{c,L},y_{c,L})×(zₒ₂+zₙ₂−zₒ₂·zₙ₂/f₂)/zₙ₂

Thus, the center coordinate calculator 12 according to the embodiment calculates the center coordinates 12cd corresponding to the lens 31 corresponding to each of the pixels 21 from the display coordinates 11cd of each of the pixels 21.

The calculation of the magnification ratio according to the embodiment will now be described in detail.

As described above, the magnification ratio calculator 13 according to the embodiment calculates the first magnification ratio 13s. Each of the first magnification ratios 13s is the ratio of the magnification ratio of the compound lens of the second lens unit 50 and the lens 31 corresponding to each of the pixels 21 to the magnification ratio of the second lens unit 50 in the case where the optical effect of the first lens unit 30 is ignored.

Each of the first magnification ratios 13s is determined from the distance between the eyeball position 80e and the principal plane (the fifth surface 50p) of the compound lens 55 of the second lens unit 50 and the lens 31 corresponding to each of the pixels 21, the distance between the display unit 20 and a principal point 56a of the compound lens 55 of the second lens unit 50 and the lens 31 corresponding to each of the pixels 21, the focal length of the compound lens 55 of the second lens unit 50 and the lens 31 corresponding to each of the pixels 21, the distance between the eyeball position 80e and the principal plane (the fourth surface 40p) of the second lens unit 50, the distance between the display unit 20 and the principal point 50a of the second lens unit 50, and the focal length of the second lens unit 50.

The compound lens 55 of the second lens unit 50 and the lens 31 corresponding to each of the pixels 21 is the virtual lens when the combination of the second lens unit 50 and the lens 31 corresponding to each of the pixels 21 is considered to be one lens.

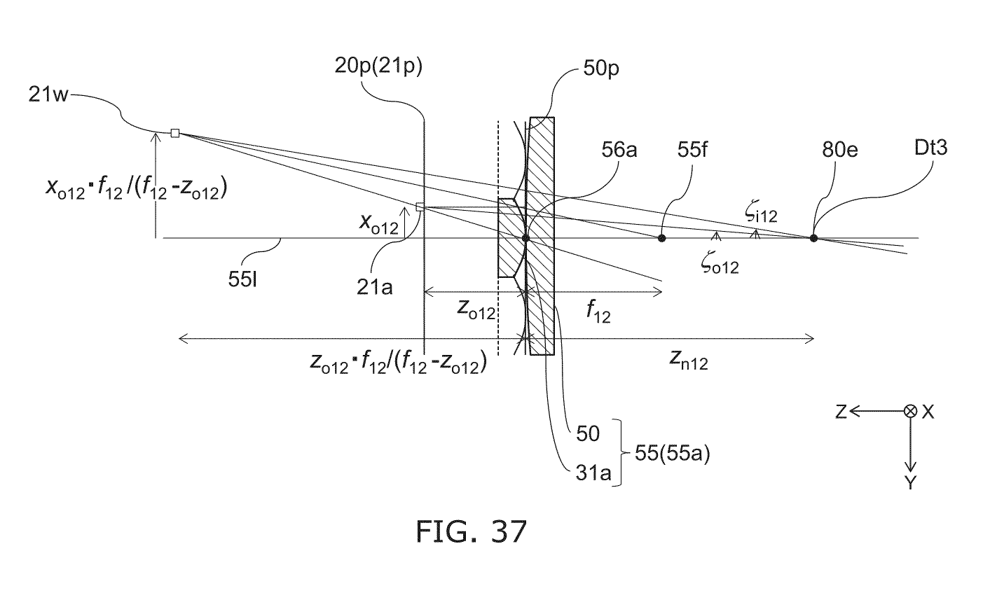

FIG. 37 is a schematic view illustrating the image display device according to the ninth embodiment.

The first lens 31a of the multiple lenses 31 is described as an example in the description of the magnification ratio calculator 13 according to the embodiment recited below. The magnification ratio can be calculated similarly for the other lenses 31.

FIG. 37 shows the magnification ratio of a compound lens 55a of the first lens 31a and the second lens unit 50. The compound lens 55a is an example of the compound lens 55 of the second lens unit 50 and each of the lenses 31.

In the example, the principal point (the rear principal point) on the viewer 80 side of the compound lens 55 of the lens 31 and the second lens unit 50 is extremely proximal to the principal point (the front principal point) of the compound lens 55 on the display unit 20 side. Therefore, in FIG. 37, the principal points are shown together as one principal point (principal point 56a).

Similarly, in the example, the principal plane (the rear principal plane) on the viewer 80 side of the compound lens 55 of the lens 31 and the second lens unit 50 is extremely proximal to the principal plane (the front principal plane) of the compound lens 55 on the display unit 20 side. Therefore, in FIG. 37, the principal planes are shown together as one principal plane (fifth surface 50p).

The magnification ratio of the compound lens 55a of the first lens 31a and the second lens unit 50 is determined from the distance between the eyeball position 80e and the fifth surface 50p (the second major surface, i.e., the principal plane of the compound lens 55a), the distance between the display unit 20 and the principal point 56a of the compound lens 55a of the first lens 31a and the second lens unit 50, and the focal length of the compound lens 55a of the first lens 31a and the second lens unit 50.

The magnification ratio of the compound lens 55a is determined from the ratio of the tangent of a fourth angle ζᵢ₁₂ (a second display angle) to the tangent of a third angle ζₒ₁₂ (a first display angle).

For example, a distance zₙ₁₂ is the distance between the fifth surface 50p and the eyeball position 80e.

The third angle ζₒ₁₂ is the angle between an optical axis 55l of the compound lens 55a and the straight line connecting a third point Dt3 (a first position) and the first pixel 21a on the display unit 20. Here, the third point Dt3 is the point on the optical axis 55l of the compound lens 55a away from the fifth surface 50p toward the eyeball position 80e by the distance zₙ₁₂.

The fourth angle ζᵢ₁₂ is the angle between the optical axis 55l of the compound lens 55a and the straight line connecting the third point Dt3 and a virtual image 21w of the first pixel 21a viewed by the viewer 80 through the compound lens 55a.

As shown in FIG. 37, the distance zₙ₁₂ is the distance between the eyeball position 80e of the viewer 80 and the principal plane (the fifth surface 50p) of the compound lens 55a on the viewer 80 side; and a distance zₒ₁₂ is the distance between the display unit 20 and the principal point 56a (the front principal point) of the compound lens 55a on the display unit 20 side. A focal length f₁₂ is the focal length of the compound lens 55a of the first lens 31a and the second lens unit 50. The compound lens 55a has a focal point 55f shown in FIG. 37.

The point on the optical axis 55l of the compound lens 55a away from the principal plane (the rear principal plane, i.e., the fifth surface 50p) of the compound lens 55a on the viewer 80 side toward the eyeball position 80e by the distance zₙ₁₂ is the third point Dt3. In FIG. 37, the eyeball position 80e and the third point Dt3 are the same point.

Any same one pixel of the multiple first pixels 21a provided on the display unit 20 is used to calculate the third angle ζₒ₁₂ and the fourth angle ζᵢ₁₂. The first pixel 21a is disposed at a position on the display unit 20 away from the optical axis 55l of the compound lens 55a by a distance xₒ₁₂. The viewer 80 views the virtual image 21w of the first pixel 21a through the compound lens 55a. The virtual image 21w of the first pixel 21a is formed of the light emitted from the first pixel 21a. The virtual image 21w of the first pixel 21a is viewed as being at a position zₒ₁₂·f₁₂/(f₁₂−zₒ₁₂) from the principal plane (the front principal plane) of the compound lens 55a on the display unit 20 side and xₒ₁₂·f₁₂/(f₁₂−zₒ₁₂) from the optical axis 55l of the compound lens.

In such a case, the tangent of the angle (the third angle ζₒ₁₂) between the optical axis 55l of the compound lens 55a and the straight line connecting the third point Dt3 and the first pixel 21a is tan(ζₒ₁₂)=xₒ₁₂/(zₙ₁₂+zₒ₁₂).

The tangent of the angle (the fourth angle ζᵢ₁₂) between the optical axis 55l of the compound lens 55 and the straight line connecting the third point Dt3 and the virtual image 21w of the first pixel 21a is tan(ζᵢ₁₂)=(xₒ₁₂·f₁₂/(f₁₂−zₒ₁₂))/(zₙ₁₂+zₒ₁₂·f₁₂/(f₁₂−zₒ₁₂)).

An magnification ratio M₁ is the magnification ratio of the compound lens 55a of the first lens 31a and the second lens unit 50; and M₁ is calculated as the ratio of tan(∂ᵢ₁₂) to tan(ζₒ₁₂), i.e., tan(ζᵢ₁₂)/tan(ζₒ₁₂).

Accordingly, the magnification ratio M₁ of the compound lens 55a of the first lens 31a and the second lens unit 50 is calculated by the following formula.

$$\begin{matrix}{M}_{1} = tan ( {ζ}_{i 12} ) / tan ( {ζ}_{o 12} ) \\ = ( {Z}_{n 12} + {Z}_{o 12} ) / ( {Z}_{n 12} + {Z}_{o 12} - {Z}_{n 12} \cdot {Z}_{o 12} / {f}_{12} )\end{matrix}$$

It can be seen from this formula that the magnification ratio of the compound lens 55a is not dependent on the position xₒ₁₂ on the display unit 20 of the pixels 21 and is a value determined from the distance zₙ₁₂ between the eyeball position 80e and the principal plane (the rear principal plane) of the compound lens 55a on the viewer 80 side, the distance zₒ₁₂ between the display unit 20 and the principal point (the front principal point) of the compound lens 55a on the display unit 20 side, and the focal length f₁₂ of the compound lens 55a.

The focal length f₁₂ of the compound lens 55 of the first lens 31a and the second lens unit 50 can be calculated by the following formula, where the focal length f₁ is the focal length of the first lens 31a, and the focal length f₂ is the focal length of the second lens unit 50.

f₁₂=1/(1/f₁+1/f₂)

One image that is displayed by the display unit 20 appears to be magnified by the magnification ratio M₁ of the compound lens 55a of the first lens 31a and the second lens unit 50 from the viewer 80.

In the case where the principal plane (the rear principal plane) on the viewer 80 side of the compound lens 55a of the first lens 31a and the second lens unit 50 is extremely proximal to the principal plane (the front principal plane) on the display unit 20 side of the compound lens 55a of the first lens 31a and the second lens unit 50, the principal planes may be treated together as one principal plane.

In such a case, the magnification ratio M₁ of the compound lens 55a is determined from the distance between the principal plane of the compound lens 55a and the eyeball position 80e of the viewer 80, the distance between the display unit 20 and the principal point 56a of the compound lens 55a, and the focal length of the compound lens 55a.

In such a case, the third angle ζₒ₁₂ is the angle between the optical axis 55l of the compound lens 55a and the straight line connecting the third point Dt3 and the first pixel 21a on the display unit 20.

The fourth angle ζᵢ₁₂ is the angle between the optical axis 55l of the compound lens 55 and the straight line connecting the third point Dt3 and the virtual image of the first pixel 21a viewed by the viewer 80 through the compound lens 55.

Here, the third point Dt3 is the point on the optical axis 55l of the compound lens 55a away from the principal plane of the compound lens 55a toward the eyeball position 80e by a distance, where the distance is the distance between the eyeball position 80e and the principal plane of the compound lens 55a.

The magnification ratio M₁ of the compound lens 55a of the first lens 31a and the second lens unit 50 is the ratio of the tangent of the fourth angle ζᵢ₁₂ to the tangent of the third angle ζₒ₁₂.

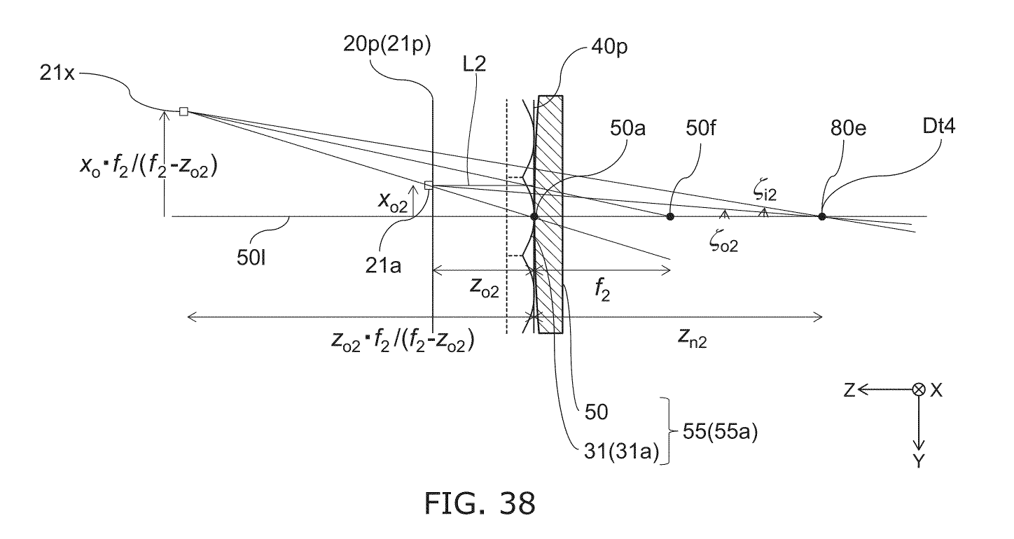

FIG. 38 is a schematic view illustrating the image display device according to the ninth embodiment.

FIG. 38 shows the magnification ratio of the second lens unit 50 in the case where the optical effect of the first lens unit 30 is ignored.

In the example, the principal point (the rear principal point) of the second lens unit 50 on the viewer 80 side is extremely proximal to the principal point (the front principal point) of the second lens unit 50 on the display unit side. Therefore, in FIG. 38, the principal points are shown together as one principal point (principal point 50a).

Similarly, in the example, the principal plane (the rear principal plane) of the second lens unit 50 on the viewer 80 side is extremely proximal to the principal plane (the front principal plane) of the second lens unit 50 on the display unit side. Therefore, in FIG. 38, the principal planes are shown together as one principal plane (fourth surface 40p).

As shown in FIG. 38, the distance zₙ₂ is the distance between the eyeball position 80e of the viewer 80 and the principal plane (the fourth surface 40p) of the second lens unit 50 on the viewer 80 side; and the distance zₒ₂ is the distance between the display unit 20 and the principal point 50a (the front principal point) of the second lens unit 50 on the display unit 20 side. The focal length f₂ is the focal length of the second lens unit 50.

The point on an optical axis 50l of the second lens unit 50 away from the principal plane (the rear principal plane, i.e., the fourth surface 40p) of the second lens unit 50 on the viewer 80 side toward the eyeball position 80e by the distance zₙ₂ is a fourth point Dt4 (a second position). In FIG. 38, the eyeball position 80e and the fourth point Dt4 are the same point.

The magnification ratio of the second lens unit 50 in the case where the optical effect of the first lens unit 30 is ignored is determined from the distance between the eyeball position 80e and the fourth surface 40p (the first major surface, i.e., the principal plane of the second lens unit), the distance between the display unit 20 and the principal point 50a of the second lens unit 50, and the focal length of the second lens unit 50. The magnification ratio of the second lens unit 50 in the case where the optical effect of the first lens unit 30 is ignored is determined from the ratio of the tangent of a sixth angle ζᵢ₂ (a fourth display angle) to the tangent of a fifth angle ζₒ₂ (a third display angle).

For example, the distance zₙ₂ is the distance between the fourth surface 40p and the eyeball position 80e.

The fifth angle ζₒ₂ is the angle between the optical axis 50l of the second lens unit 50 and the straight line connecting the fourth point Dt4 and the first pixel 21a on the display unit 20. Here, the fourth point Dt4 is the point on the optical axis 50l of the second lens unit 50 away from the fourth surface 40p toward the eyeball position 80e by the distance zₙ₂.

The sixth angle ζᵢ₂ is the angle between the optical axis 50l of the second lens unit 50 and the straight line connecting the fourth point Dt4 and a virtual image 21x of the first pixel 21a viewed by the viewer 80 through the second lens unit 50 in the case where the optical effect of the first lens unit 30 is ignored.

The virtual image 21x is formed of the virtual light emitted from the first pixel 21a in the case where the optical effect of the first lens unit 30 is ignored. For example, a second light L2 shown in FIG. 38 is an example of the virtual light in the case where the optical effect of the first lens unit 30 is ignored. In other words, the second light L2 is refracted by the second lens unit 50 but is not refracted by the first lens 31a. The travel direction of the second light L2 is changed by the second lens unit 50 from the travel direction (the emission direction) at the first pixel 21a to the travel direction at the focal point 50f. Such a second light L2 forms the virtual image 21x.

For example, the travel direction of the second light L2 emitted from one first pixel 21a is a third direction D3 at the first pixel 21a and is a fourth direction D4 at the focal point 50f. The travel direction of the second light L2 is changed by the second lens unit 50 from the third direction D3 to the fourth direction D4.

The same one pixel of the multiple first pixels 21a provided on the display unit 20 is used to calculate the fifth angle ζₒ₂ and the sixth angle ζᵢ₂. The first pixel 21a is disposed at a position on the display unit 20 away from the optical axis 50l of the second lens unit 50 by a distance xₒ₂. The viewer 80 views the virtual image 21x of the first pixel 21a through the second lens unit 50 in the case where the optical effect of the first lens unit 30 is ignored. The virtual image 21x of the first pixel 21a is viewed as being at a position zₒ₂·f₂/(f₂−zₒ₂) from the principal plane (the front principal plane) of the second lens unit 50 on the display unit 20 side and xₒ₂·f₂/(f₂−zₒ₂) from the optical axis 50l of the second lens unit 50.

In such a case, the tangent of the angle (the fifth angle ζₒ₂) between the optical axis 50l of the second lens unit 50 and the straight line connecting the fourth point Dt4 and the first pixel 21a is tan(ζₒ₂)=xₒ₂/(zₙ₂+zₒ₂). The tangent of the angle (the sixth angle between the optical axis 50l of the second lens unit 50 and the straight line connecting the fourth point Dt4 and the virtual image 21x of the first pixel 21a is tan(ζᵢ₂)=(xₒ₂·f₂/(f₂−zₒ₂))/(zₙ₂+zₒ₂·f₂/(f₂−zₒ₂)).

An magnification ratio M₂ is the magnification ratio of the second lens unit 50 in the case where the optical effect of the first lens unit 30 is ignored; and the magnification ratio M₂ is calculated as the ratio of tan(ζᵢ₂) to tan(ζₒ₂), i.e., tan(ζ₂)/tan(ζₒ₂).

Accordingly, the magnification ratio M₂ of the second lens unit 50 in the case where the optical effect of the first lens unit 30 is ignored is calculated by the following formula.

$$\begin{matrix}{M}_{2} = tan ( {ζ}_{i 2} ) / tan ( {ζ}_{o 2} ) \\ = ( {Z}_{n 2} + {Z}_{o 2} ) / ( {Z}_{n 2} + {Z}_{o 2} - {Z}_{n 2} \cdot {Z}_{o 2} / {f}_{2} )\end{matrix}$$

It can be seen from this formula that the magnification ratio M₂ of the second lens unit 50 in the case where the optical effect of the first lens unit 30 is ignored is not dependent on the position (the distance xₒ₂) of the pixels 21 on the display unit 20. The magnification ratio M₂ is a value determined from the distance zₙ₂ between the eyeball position 80e of the viewer 80 and the principal plane (the rear principal plane) of the second lens unit 50 on the viewer 80 side, the distance zₒ₂ between the display unit 20 and the principal point 50a (the front principal point) of the second lens unit 50 on the display unit 20 side, and the focal length f₂ of the second lens unit 50.

The entire display unit 20 appears from the viewer 80 to be magnified by the magnification ratio M₂ of the second lens unit 50 in the case where the optical effect of the first lens unit 30 is ignored.

In the case where the principal plane (the rear principal plane) of the second lens unit 50 on the viewer 80 side is extremely proximal to the principal plane (the front principal plane) of the second lens unit 50 on the display unit 20 side, the principal planes may be treated together as one principal plane.

In such a case, the magnification ratio M₂ of the second lens unit 50 in the case where the optical effect of the first lens unit 30 is ignored is determined from the distance between the eyeball position 80e and the principal plane of the second lens unit 50, the distance between the display unit 20 and the principal point 50a of the second lens unit 50, and the focal length of the second lens unit 50.

In such a case, the fifth angle ζₒ₂ is the angle between the optical axis 50l of the second lens unit 50 and the straight line connecting the fourth point Dt4 and the first pixel 21a on the display unit.

The sixth angle ζᵢ₂ is the angle between the optical axis 50l of the second lens unit 50 and the straight line connecting the fourth point Dt4 and the virtual image 21x of the first pixel 21a viewed by the viewer 80 through the second lens unit 50 in the case where the optical effect of the first lens unit 30 is ignored.

Here, the fourth point Dt4 is a point on the optical axis 50l of the second lens unit 50. The fourth point Dt4 is a point away from the principal plane of the second lens unit 50 toward the eyeball position 80e by a distance, where the distance is the distance between the eyeball position 80e and the principal plane of the second lens unit 50.

The magnification ratio M₂ of the second lens unit 50 in the case where the optical effect of the first lens unit 30 is ignored is the ratio of the tangent of the sixth angle to the tangent of the fifth angle ζₒ₂.

In the embodiment, the magnification ratio M is the first magnification ratio 13s corresponding to the first lens 31a. The magnification ratio M is calculated as the ratio of the magnification ratio M₁ of the compound lens 55a of the first lens 31a and the second lens unit 50 to the magnification ratio M₂ of the second lens unit 50 in the case where the optical effect of the first lens unit 30 is ignored, i.e., M₁/M₂.

Accordingly, the magnification ratio M (the ratio of the magnification ratio of the compound lens of the first lens 31a and the second lens unit 50 to the magnification ratio of the second lens unit 50 in the case where the optical effect of the first lens unit 30 is ignored) is calculated by the following formula.

$$\begin{matrix}M = {M}_{1} / {M}_{2} \\ = ( ( {Z}_{n 12} + {Z}_{o 12} ) / ( {Z}_{n 1 \; 2} + {Z}_{o 1 \; 2} - {Z}_{n 12} \cdot {Z}_{o 1 \; 2} / {f}_{12} ) ) / \\ ( ( {Z}_{n 2} + {Z}_{o 2} ) / ( {Z}_{n 2} + {Z}_{o 2} - {Z}_{n 2} \cdot {Z}_{o 2} / {f}_{2} ) )\end{matrix}$$

It can be seen from this formula that the first magnification ratio 13s is a value determined from the distance zₙ₁₂ between the eyeball position 80e and the principal plane (the rear principal plane) of the compound lens 55a on the viewer 80 side, the distance zₒ₁₂ between the display unit 20 and the principal point 56a (the front principal point) of the compound lens 55a on the display unit 20 side, the focal length fₙ₁₂ of the compound lens 55a, the distance zₙ₂ between the eyeball position 80e and the principal plane (the rear principal plane) of the second lens unit 50 on the viewer 80 side, the distance zₒ₂ between the display unit 20 and the principal point 50a (the front principal point) of the second lens unit 50 on the display unit 20 side, and the focal length f₂ of the second lens unit 50.

As described above, in the case where the rear principal plane of the compound lens 55a is extremely proximal to the front principal plane of the compound lens 55a, the rear principal planes may be treated together as one principal plane. In the case where the rear principal plane of the second lens unit 50 is extremely proximal to the front principal plane of the second lens unit, the front principal planes may be treated together as one principal plane.

In such a case, the first magnification ratio 13s is determined from the distance between the eyeball position 80e and the principal plane of the compound lens 55a, the distance between the display unit 20 and the principal point of the compound lens 55a, the focal length of the compound lens 55a, the distance between the eyeball position 80e and the principal plane of the second lens unit, the distance between the display unit 20 and the principal point of the second lens unit 50, and the focal length of the second lens unit 50.

In such a case, the third angle ζₒ₁₂ is the angle between the optical axis 55l of the compound lens 55a and the straight line connecting the third point Dt3 and the first pixel 21a on the display unit 20. The fourth angle ζᵢ₁₂ is the angle between the optical axis 55l of the compound lens 55a and the straight line connecting the third point Dt3 and the virtual image of the first pixel 21a viewed by the viewer 80 through the compound lens 55a.

In the description recited above, the third point Dt3 is the point on the optical axis of the compound lens 55a away from the principal plane of the compound lens 55a toward the eyeball position 80e by the distance zₙ₁₂. Here, the distance zₙ₁₂ is the distance between the eyeball position 80e and the principal plane of the compound lens 55a.

The magnification ratio M₁ of the compound lens 55a is the ratio of the tangent of the fourth angle ζᵢ₁₂ to the tangent of the third angle ζₒ₁₂.

In such a case, the fifth angle ζₒ₂ is the angle between the optical axis 50l of the second lens unit 50 and the straight line connecting the fourth point Dt4 and the first pixel 21a on the display unit 20. The sixth angle ζᵢ₂ is the angle between the optical axis 50l of the second lens unit 50 and the straight line connecting the fourth point Dt4 and the virtual image of the first pixel 21a viewed by the viewer 80 through the second lens unit 50 in the case where the optical effect of the first lens unit 30 is ignored.

In the description recited above, the fourth point Dt4 is the point on the optical axis of the second lens unit 50 away from the principal plane of the second lens unit 50 toward the eyeball position 80e by the distance zₙ₂. Here, the distance zₙ₂ is the distance between the eyeball position 80e and the principal plane of the second lens unit 50.

The magnification ratio M₂ of the second lens unit 50 in the case where the optical effect of the first lens unit 30 is ignored is the ratio of the tangent of the sixth angle ζᵢ₂ to the tangent of the fifth angle ζₒ₂.

As described above, the focal length of the compound lens 55a of the first lens 31a and the second lens unit 50 can be calculated from the focal length of the first lens 31a and the focal length of the second lens unit 50. Accordingly, the first magnification ratio 13s (M) is determined also from the distance between the principal plane of the compound lens 55a and the eyeball position 80e of the viewer 80, the distance between the display unit 20 and the principal point of the compound lens 55a, the distance between the principal plane of the second lens unit 50 and the eyeball position 80e of the viewer 80, the distance between the display unit 20 and the principal point of the second lens unit 50, the focal length of the first lens 31a, and the focal length of the second lens unit 50.

In the embodiment as well, for example, the focal length is substantially the same for each of the lenses 31 on the lens array.

In such a case, similarly to the magnification ratio calculator of the first embodiment, the magnification ratio calculator 13 according to the embodiment refers to the magnification ratio storage region. The first magnification ratios 13s that correspond to the lenses 31 on the lens array are pre-recorded in the magnification ratio storage region according to the embodiment. Thereby, the magnification ratio calculator 13 can calculate the first magnification ratio 13s. As described above, each of the first magnification ratios 13s is the ratio of the magnification ratio of the compound lens 55 of the second lens unit 50 and each of the lenses 31 to the magnification ratio of the second lens unit 50 in the case where the optical effect of the first lens unit 30 is ignored.

In such a case, similarly to the magnification ratio calculator of the sixth embodiment, the magnification ratio calculator 13 according to the embodiment may include the focal distance storage region 13k and the ratio calculator 13j.

For example, the magnification ratio calculator 13 refers to the distance between the eyeball position 80e and the principal plane (the rear principal plane) of the compound lens 55 of the second lens unit 50 and the lens 31 corresponding to each of the pixels 21, the distance between the display unit 20 and the principal point (the front principal point) of the compound lens 55, the distance between the eyeball position 80e and the principal plane (the rear principal plane) of the second lens unit 50, the distance between the display unit 20 and the principal point (the front principal point) of the second lens unit 50, the focal length of the lens 31 corresponding to each of the pixels 21, and the focal length of the second lens unit 50. Thereby, the first magnification ratio 13s may be calculated.

Similarly to the focal distance storage region of the sixth embodiment, the focal lengths that correspond to the lenses 31 of the first lens unit 30 are pre-recorded in the focal distance storage region 13k according to the embodiment.

The ratio calculator 13j according to the embodiment calculates the first magnification ratio 13s from the distance between the principal plane (the rear principal plane) of the compound lens 55 and the eyeball position 80e of the viewer 80, the distance between the display unit 20 and the principal point (the front principal point) of the compound lens 55, the distance between the eyeball position 80e and the principal plane (the rear principal plane) of the second lens unit 50, the distance between the display unit 20 and the principal point (the front principal point) of the second lens unit 50, the focal lengths of the lenses 31 recorded in the focal distance storage region 13k, and the focal length of the second lens unit 50.

For example, the distance zₙ₁₂ is the distance between the eyeball position 80e and the principal plane (the rear principal plane) of the compound lens 55a of the first lens 31a and the second lens unit 50; the distance zₒ₁₂ is the distance between the display unit 20 and the principal point (the front principal point) of the compound lens 55a; the distance zₙ₂ is the distance between the eyeball position 80e and the principal plane (the rear principal plane) of the second lens unit 50; the distance zₒ₂ is the distance between the display unit 20 and the principal point (the front principal point) of the second lens unit 50; the focal length f₁ is the focal length of the first lens 31a recorded in the focal distance storage region 13k; and the focal length f₂ is the focal length of the second lens unit 50. In such a case, the first magnification ratio (M) is calculated by the ratio calculator according to the embodiment by the following formula.

M=((zₙ₁₂+zₒ₁₂)/(zₙ₁₂+zₒ₁₂−zₙ₁₂·zₒ₁₂·(1/f₁+1/f₂)))/((zₙ₂+zₒ₂)/(zₙ₂+zₒ₂−zₙ₂·zₒ₂/f₂))

Similarly to the magnification ratio calculator of the third embodiment, the magnification ratio calculator 13 according to the embodiment may include the magnification ratio determination unit 13a. The magnification ratio determination unit 13a according to the embodiment may calculate the first magnification ratio 13s from the lens identification value 31r of the lens 31 corresponding to each of the pixels 21. As described above, the lens identification value 31r is calculated by the center coordinate calculator 12. The first magnification ratio 13s is the ratio of the magnification ratio of the compound lens 55 of the second lens unit 50 and the lens 31 corresponding to each of the pixels 21 to the magnification ratio of the second lens unit 50 in the case where the optical effect of the first lens unit 30 is ignored.

Similarly to the magnification ratio LUT of the third embodiment, the first magnification ratios 13s are pre-recorded in the magnification ratio LUT 35 according to the embodiment. Similarly to the magnification ratio determination unit of the third embodiment, the magnification ratio determination unit 13a according to the embodiment refers to the magnification ratio LUT 35. Thereby, each of the first magnification ratios 13s is calculated from the lens identification value 31r of the lens 31 corresponding to each of the pixels 21 calculated by the center coordinate calculator 12.

Or, similar to the magnification ratio calculator of the seventh embodiment, the magnification ratio calculator 13 according to the embodiment may include the focal distance determination unit 13i and the ratio calculator 13j. Similarly to the magnification ratio calculator of the seventh embodiment, the magnification ratio calculator 13 according to the embodiment may calculate the first magnification ratio 13s from the lens identification value 31r corresponding to each of the pixels 21.

Similarly to the focal distance determination unit of the seventh embodiment, the focal distance determination unit 13i according to the embodiment refers to the focal length LUT 39.

Similarly to the focal length LUT of the seventh embodiment, the focal length LUT 39 according to the embodiment is a lookup table in which the focal lengths of the lenses 31 are pre-recorded.

Similarly to the focal length LUT of the seventh embodiment, the multiple storage regions 39a are disposed in the focal length LUT 39 according to the embodiment. The storage regions 39a correspond to the lens identification values 31r. The focal lengths of the lenses 31 corresponding to the storage regions 39a are recorded in the storage regions 39a.

Similarly to the focal distance determination unit of the seventh embodiment, the focal distance determination unit 13i according to the embodiment refers to the focal length recorded in the storage regions 39a corresponding to the lens identification values 31r from the focal length LUT 39 and the lens identification values 31r corresponding to the pixels 21 calculated by the center coordinate calculator 12. Thus, similarly to the focal distance determination unit of the seventh embodiment, the focal distance determination unit 13i calculates the focal length of the lens 31 corresponding to each of the pixels 21.

In such a case, the ratio calculator 13j according to the embodiment calculates the first magnification ratio 13s from the distance between the eyeball position 80e and the principal plane (the rear principal plane) of the compound lens 55 of the lens 31 and the second lens unit 50, the distance between the display unit 20 and the principal point (the front principal point) of the compound lens 55, the distance between the eyeball position 80e and the principal plane (the rear principal plane) of the second lens unit 50, the distance between the display unit 20 and the principal point (the front principal point) of the second lens unit 50, the focal length of the lens 31 corresponding to each of the pixels 21 calculated by the focal distance determination unit, and the focal length of the second lens unit 50. In such a case, a configuration similar to that of the ratio calculator 13j according to the embodiment described above is applicable to the ratio calculator 13j.

The configuration of the image reduction unit 14 according to the embodiment may be a configuration similar to that of the image reduction unit of the first embodiment. Similarly to the image reduction unit of the first embodiment, the image reduction unit 14 according to the embodiment reduces the input image I1 and calculates the display image I2 to be displayed by the display unit 20. The display coordinates 11cd of each of the pixels 21 generated by the display coordinate generator 11, the center coordinates 12cd corresponding to the lens 31 corresponding to each of the pixels 21 calculated by the center coordinate calculator 12, and the first magnification ratio 13s corresponding to each of the pixels 21 calculated by the magnification ratio calculator 13 are used in the reduction. Similarly to the image reduction unit of the first embodiment, the image reduction unit 14 according to the embodiment reduces the input image I1 by the proportion of the reciprocal of the first magnification ratio 13s corresponding to each of the lenses 31 using the center coordinates 12cd corresponding to each of the lenses 31 as the center. For example, the image reduction unit changes the input image I1 to (1/M) times the input image I1 using the center coordinates 12cd corresponding to each of the lenses 31 as the center.

The operation of the image display device according to the embodiment will now be described.

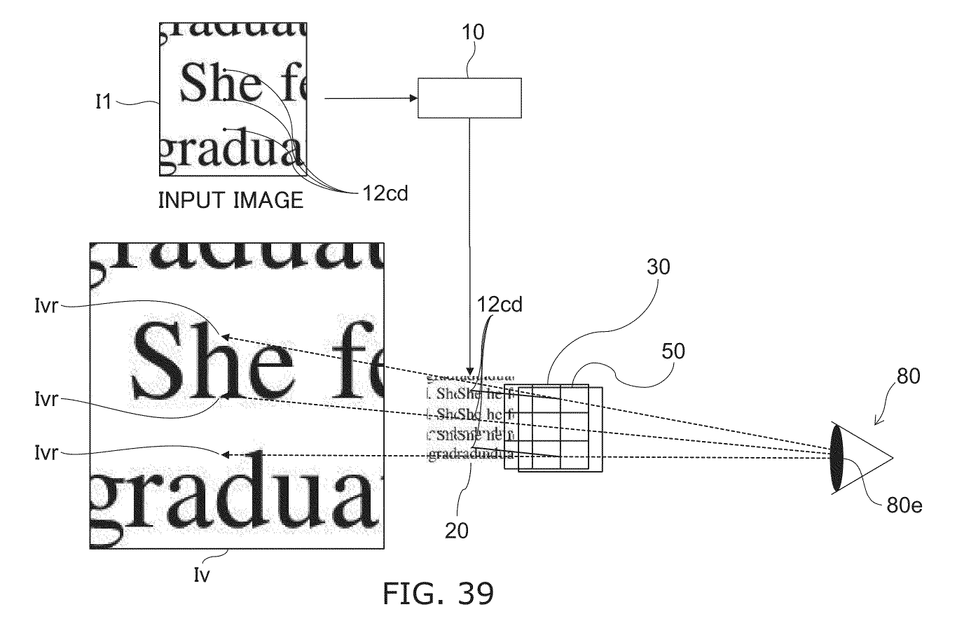

FIG. 39 is a schematic view illustrating the operation of the image display device according to the ninth embodiment.

Multiple virtual images Ivr are viewed by the viewer 80 through the lenses 31. The viewer 80 can view the image (the virtual image Iv) in which the multiple virtual images Ivr overlap. The image that is viewed by the viewer 80 is an image in which the images displayed by the display unit 20 are magnified by the magnification ratio (e.g., M₁ times) of the compound lens 55 of the lens 31 and the second lens unit 50 for each of the lenses 31.

On the other hand, in the case where the optical effect of the first lens unit 30 is ignored, the image that is viewed by the viewer 80 is an image in which the entire display unit 20 is magnified by the magnification ratio (e.g., M₂ times) of the second lens unit 50 in the case where the optical effect of the first lens unit 30 is ignored.

The magnification of the entire display unit 20 by the second lens unit 50 in the case where the optical effect of the first lens unit 30 is ignored does not easily affect the deviation between the virtual images Ivr viewed through the lenses 31.

Therefore, the image of the input image I1 reduced by the proportion of the reciprocal of each of the first magnification ratios 13s (the ratio of the magnification ratio of the compound lens 55 of the second lens unit 50 and each of the lenses 31 to the magnification ratio of the second lens unit 50 in the case where the optical effect of the first lens unit 30 is ignored) using the center coordinates 12cd corresponding to each of the lenses 31 as the center is displayed on the display panel. Thereby, in the embodiment as well, the appearance of the virtual image Iv viewed by the viewer 80 matches the input image I1.

Thus, in the embodiment as well, the deviation between the virtual images viewed through the lenses 31 can be reduced.

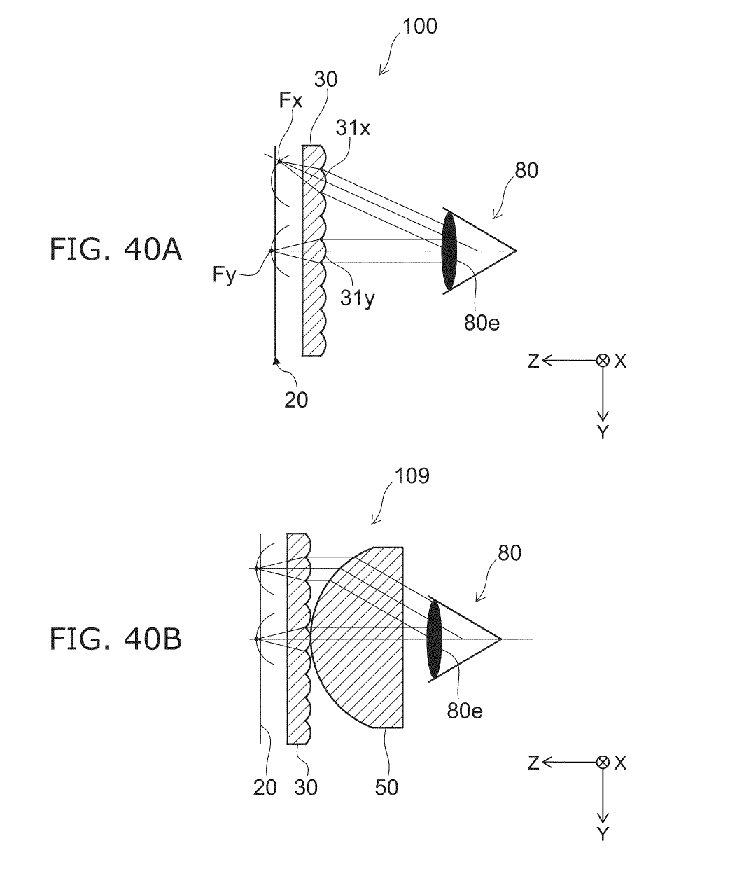

FIG. 40A and FIG. 40B are schematic views illustrating the operation of the image display device according to the embodiment.

FIG. 40A shows the image display device 100 according to the first embodiment. FIG. 40B shows the image display device 109 according to the embodiment. In these examples, for example, the first lens unit 30 includes a lens 31x and a lens 31y. The lens 31x has a focal point fx as viewed by the viewer 80; and the lens 31y has a focal point fy as viewed by the viewer 80.

In FIG. 40A, the distance between the first lens unit 30 and the focal point fx of the lens 31x is shorter than the distance between the first lens unit 30 and the focal point fy of the lens 31y. In other words, the focal point of the lens 31 as viewed by the viewer 80 approaches the first lens unit 30 toward the periphery of the display panel (the display unit 20).

Conversely, in the image display device 109 according to the embodiment as shown in FIG. 40B, the difference between the distance from the first lens unit 30 to the focal point fx of the lens 31x and the distance from the first lens unit 30 to the focal point fy of the lens 31y is small. In other words, the difference in the distance from the first lens unit 30 to the focal point of the lens 31 as viewed by the viewer 80 between the center and the periphery of the display panel is small.

The distance from the viewer 80 to the virtual image viewed by the viewer 80 is dependent on the ratio of the distance between the first lens unit 30 and the display unit 20 to the distance between the first lens unit 30 and the focal point. Therefore, according to the embodiment, the change in the distance from the viewer 80 to the virtual image viewed by the viewer 80 is small within the display angle of view; and a high-quality display can be provided.

In particular, there are cases where it is difficult for the viewer 80 to view a clear image when the distance between the viewer 80 and the virtual image viewed by the viewer 80 is too small or too large. Conversely, according to the embodiment, a high-quality image display having a wider angle of view is possible. Such a high-quality image display is obtained by the light emitted from the pixels 21 being condensed when passing through the second lens unit 50. It is desirable for the second lens unit 50 to have the characteristic of condensing the light that is emitted from the pixels 21 when the light passes through the second lens unit 50.

According to the embodiments, an image display device and an image display method that provide a high-quality display can be provided.

In the specification of the application, “perpendicular” and “parallel” include not only strictly perpendicular and strictly parallel but also, for example, the fluctuation due to manufacturing processes, etc.; and it is sufficient to be substantially perpendicular and substantially parallel.

Hereinabove, embodiments of the invention are described with reference to specific examples. However, the embodiments of the invention are not limited to these specific examples. For example, one skilled in the art may similarly practice the invention by appropriately selecting specific configurations of components such as the image converter, the display unit, the pixels, the lens unit, the first lens, the second lens, the imaging unit, the holder, etc., from known art; and such practice is within the scope of the invention to the extent that similar effects can be obtained.

Further, any two or more components of the specific examples may be combined within the extent of technical feasibility and are included in the scope of the invention to the extent that the purport of the invention is included.

Moreover, all image display devices and image display methods practicable by an appropriate design modification by one skilled in the art based on the image display devices and the image display methods described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An image display device, comprising:
an image converter acquiring first information and deriving second information by converting the first information, the first information relating to a first image, the second information relating to a second image;
a display unit including a first surface, the first surface including a plurality of pixels, the pixels emitting light corresponding to the second image based on the second information; and
a first lens unit including a plurality of lenses provided on a second surface, at least a portion of the light emitted from the pixels being incident on each of the lenses,
the first surface including a first display region, and a second display region different from the first display region,
the pixels including a plurality of first pixels and a plurality of second pixels, the first pixels being provided inside the first display region and emitting light corresponding to a first portion of the first image, the second pixels being provided inside the second display region and emitting light corresponding to the first portion,
a position of the first pixels inside the first display region being different from a position of the second pixels inside the second display region.

2. The device according to claim 1, wherein
a first distance between the first display region and a first point on the first surface is shorter than a second distance between the first point and the second display region,
the first display region includes:
a first center positioned at a center of the first display region;
a first end portion positioned between the first center and the first point; and
a first image region where an image corresponding to the first portion is displayed,
the second display region includes:
a second center positioned at a center of the second display region;
a second end portion positioned between the second center and the first point; and
a second image region where an image corresponding to the first portion is displayed, and
a ratio of a distance between the first center and the first image region to a distance between the first center and the first end portion is lower than a ratio of a distance between the second center and the second image region to a distance between the second center and the second end portion.

3. The device according to claim 2, wherein the first point corresponds to an intersection between the first surface and a line passing through a position of an eyeball of a viewer, the line being perpendicular to the first surface.

4. The device according to claim 3, wherein the position of the eyeball corresponds to an eyeball rotation center of the eyeball.

5. The device according to claim 3, wherein the position of the eyeball corresponds to a position of a pupil of the eyeball.

6. The device according to claim 3, wherein straight lines passing through the position of the eyeball and each of the plurality of pixels disposed in the first display region intersect a first lens of the lenses.

7. The device according to claim 6, wherein the image converter calculates the first display region based on information relating to a positional relationship between the lenses and the pixels.

8. The device according to claim 6, wherein
the image converter calculates a first center point on the first surface based on a position of a nodal point of the first lens, the position of the eyeball, and a position of the first surface,
the image converter calculates an magnification ratio based on a distance between the position of the eyeball and a third surface, a distance between the first surface and a principal point of the first lens, and a focal length of the first lens, the third surface being separated from the second surface and passing through the principal point of the first lens, and
the image converter calculates an image to be displayed in the first display region by reducing the first image based on the magnification ratio using the first center point as a center.

9. The device according to claim 8, wherein the first center point is determined from an intersection between the first surface and a light ray from the position of the eyeball toward the nodal point of the first lens.

10. The device according to claim 9, wherein the image converter calculates coordinates of the first center point based on information relating to coordinates of an intersection between the first surface and a light ray from the position of the eyeball toward the nodal point for each of the lenses.

11. The device according to claim 8, wherein
the magnification ratio is determined from a ratio of a tangent of a second angle to a tangent of a first angle,
the first angle is an angle between an optical axis of the first lens and a straight line connecting the first pixel and a second point on the optical axis,
the second angle is an angle between the optical axis and a straight line connecting the second point and a virtual image due to light emitted from the first pixel and viewed through the first lens from the eyeball position, and
a distance between the second point and the third surface is determined from the distance between the eyeball position and the third surface.

12. The device according to claim 11, wherein the image converter calculates the magnification ratio based on information relating to magnification ratios corresponding to the lenses.

13. The device according to claim 3, further comprising an imaging unit imaging the eyeball of the viewer.

14. The device according to claim 13, wherein
the imaging unit senses a position of a pupil of the viewer, and
the image converter determines at least one of the first center point, the magnification ratio, or the first display region based on the position of the pupil.

15. The device according to claim 1, further comprising a second lens unit including at least one of a first optical lens or a second optical lens,
the second surface being provided between the first optical lens and the first surface,
the second optical lens being provided between the first surface and the second surface.

16. The device according to claim 15, wherein
a first light passes through a position of an eyeball of a viewer and a pixel of the plurality of pixels to intersect a first lens of the plurality of lenses for each of the pixels provided in the first display region, and
a travel direction of the first light at the first display region is changed by the second lens unit to a travel direction of the first light at the position of the eyeball.

17. The device according to claim 16, wherein
the image converter calculates a first center point on the first surface based on a nodal point of the first lens, the position of the eyeball, a position of the first surface, a position of the second lens unit, and a focal length of the second lens unit,
the image converter calculates a first magnification ratio based on a distance between a first major surface and the position of the eyeball, a distance between the first surface and a principal point of the second lens unit, the focal length of the second lens unit, a distance between a second major surface and the position of the eyeball, a distance between the first surface and a principal point of a compound lens of the first lens and the second lens unit, and a focal length of the compound lens, the first major surface passing through the principal point of the second lens unit, the second major surface passing through the principal point of the compound lens, and
the image converter calculates an image to be displayed in the first display region by reducing the first image based on the first magnification ratio using the first center point as a center.

18. The device according to claim 17, wherein
the first magnification ratio is determined from a ratio of an magnification ratio of the compound lens to an magnification ratio of the second lens unit,
the magnification ratio of the compound lens is determined from a ratio of a tangent of a second display angle to a tangent of a first display angle,
the first display angle is an angle between an optical axis of the compound lens and a straight line connecting the first pixel and a first position on the optical axis of the compound lens,
the second display angle is an angle between the optical axis of the compound lens and a straight line connecting the first position and a virtual image formed of light emitted from the first pixel and viewed through the compound lens from the position of the eyeball,
a distance between the first position and the second major surface is determined from the distance between the second major surface and the position of the eyeball,
the magnification ratio of the second lens unit is determined from a ratio of a tangent of a fourth display angle to a tangent of a third display angle,
the third display angle is an angle between an optical axis of the second lens unit and a straight line connecting the first pixel and a second position on the optical axis of the second lens unit,
the fourth display angle is an angle between the optical axis of the second lens unit and a straight line connecting the second position and a virtual image formed of a second light emitted from the first pixel and viewed through the second lens unit from the position of the eyeball,
a travel direction of the second light is changed by the second lens unit from a travel direction at the first pixel to a travel direction at a focal point of the second lens unit, and
a distance between the second position and the first major surface is determined from the distance between the first major surface and the position of the eyeball.

19. An image display method, comprising:
acquiring first information relating to a first image;
deriving second information relating to a second image by converting the first information,
emitting light corresponding to the second image based on the second information from a plurality of pixels provided on a first surface; and
displaying the second image via a plurality of lenses provided on a second surface, at least a portion of the light emitted from the pixels being incident on the lenses,
the first surface including a first display region, and a second display region different from the first display region,
the pixels including a plurality of first pixels and a plurality of second pixels, the first pixels being provided inside the first display region and emitting light corresponding to a first portion of the first image, the second pixels being provided inside the second display region and emitting light corresponding to the first portion,
a position of the first pixels inside the first display region being different from a position of the second pixels inside the second display region.

20. The method according to claim 19, further comprising:
calculating a first center point on the first surface based on a position of a nodal point of a first lens of the lenses, a position of an eyeball of a viewer, and a position of the first surface;
calculating an magnification ratio based on a distance between a third surface and the position of the eyeball, a distance between the first surface and a principal point of the first lens, and a focal length of the first lens, the third surface being separated from the second surface and passing through the principal point of the first lens; and
calculating an image to be displayed in the first display region by reducing the first image based on the magnification ratio using the first center point as a center.
